(19) United States
(12) Patent Application Publication
(10) Pub. No.: US 2014/0335325 A1
(43) Pub. Date: Nov. 13, 2014

(54) Polymer Composite Articles

(71) Applicant: Weir Minerals Australia Ltd, Artarmon, New South Wales (AU)

(72) Inventors: Edward Humphries, Erskineville (AU); Geoff Germon, Artarmon (AU)

(21) Appl. No.: 14/128,460

(22) PCT Filed: Jan. 25, 2013
(86) PCT No.: PCT/AU2013/000067

§ 371 Date: Dec. 20, 2013

Related U.S. Application Data
(60) Provisional application No. 61/591,126, filed on Jan. 26, 2012.

(30) Foreign Application Priority Data
May 4, 2012 (AU) 2012901819

(51) Int. Cl. B29C 70/02; B29C 70/68; B32B 5/30; B32B 5/24; B32B 27/12

(52) U.S. Cl. CPC B29C 70/025; B32B 5/24; B32B 27/12; B32B 5/30; B29C 70/688; B32B 2262/106; B32B 2264/107; B32B 2305/30; B29K 2509/04
USPC 428/195.1; 428/446; 428/428; 428/331; 428/425.9; 428/413; 264/71

(57) ABSTRACT

The present disclosure pertains to resins/filler/matting composites that are formed via a resin infusion process. Certain embodiments are directed to methods and systems that may be used to produce a moulded composite article. For example, a unitary polymer composite article comprising: 50% to 90% by weight of particles; 10% to 50% by weight of resin; and at least one layer of matting integrally incorporated in the unitary polymer composite.

### CROSS REFERENCE TO RELATED APPLICATIONS

This application claims priority to U.S. Provisional Application No. 61/591,126, to Humphries et al., entitled “Polymer Composites” filed on Jan. 26, 2012, and to Australian Provisional Application No. 2012901819, to Humphries et al., entitled “Polymer Composites” filed on May 4, 2012, each of these applications is incorporated herein by reference in their entirety. This application is also related to an International PCT application to Humphries et al., entitled “Polymer Composites” to be filed on or before Jan. 26, 2012. This PCT application is also incorporated herein by reference in its entirety.

### FIELD

The present disclosure relates to unitary polymer composite articles and to methods and/or systems for producing polymer/resin composites made with matting and particles, for example, Silicon carbide particles and glass fiber matting via resin infusion. Certain embodiments are to articles for use in pumps, pump components and other mechanical parts. Certain embodiments are directed methods and/or systems for producing composites for use in pumps, pump components and other mechanical parts. These composites have uses in the mining industry, the chemical industry, flue gas desulphurization, for example in power generation, desalination and/or other fields of use.

### BACKGROUND

Methods for producing machine components for use in corrosion and/or wear-resistant environments from cast mineral compositions are known in the art. Machine components such as pumps and pump components have applications in several industrial areas. Typically, the methods used for producing such cast mineral components involve premixing of a resin composition with a wear resistant filler, and then adding the resultant slurry to a casting tool and thereafter curing the slurry with heat to produce a mineral cast component.

One known method for producing mineral cast components involves premixing a resin/filler system slurry in a heatable, evacuated positive mixer at a temperature of higher than 20° C. and at a pressure of under 80 mbar. The casting is then carried out in a preheated casting mould. In the first curing step, the cast piece is slightly cured at a temperature of over 60° C. in an annealing furnace. After the first step of curing, the piece is removed from the mould in a mould removal station, and, if needed, the cast piece may be mechanically reworked and cleaned. Thereafter, the cast piece is transferred back into the annealing furnace and completely cured at a temperature over 120° C.

Another manufacturing process involves casting mineral composite pieces that are made up of multi-shell structure layers and, if need be, pre-stressed reinforcements. However, these methods have high manufacturing costs due to the successive casting of the individual shells.

However, the existing methods for casting polymer/resin composite pieces have several disadvantages. For example, the amount of resin/filler mixed for traditional slurry casting requires mixing of excess materials in a batch process to ensure that the mould tool is completely filled. This often results in waste and additional cost to the manufacturer. Existing systems require the handling of potentially harmful resins and solvent and exposing these chemicals to the atmosphere. This impacts on worker safety and air quality controls issues. The equipment used for mixing and pumping the resin/filler slurry is subject to significant wear over time. This again increases cost to the manufacturer. Furthermore, slurry casting, due the higher viscosity of the slurry mixture, is less useful for producing composites with moulds that have complex shapes, acute angles, corners, and/or turns in the mould shape. Slurry casting also requires the use of an excess of resin in the mixing and filling step which is then removed either after curing or skimmed off in the liquid form as the solid filler settles in the tool. In the case of an ambient cure system, this excess resin cannot be recycled. In the case of a heat cured system, the resin can be reused but this is not an ideal solution since the slurry has to be continually mixed and may be negatively impacted if kept for too long. Slurry casting also tends to introduce excessive and unwanted air pockets into the final cured product. With slurry casting it is commercially not possible to substantially infuse the slurry into glass fiber mats or carbon fiber mats that are often used in the moulding process.

The present disclosure is directed to overcome and/or ameliorate at least one or more of the disadvantages of the prior art, as will become apparent from the discussion herein. The present disclosure also provides other advantages and/or improvements as discussed herein.

### SUMMARY

Certain embodiments are directed to methods and systems that may be used for producing matting/polymer/filler composites using resins that are infused into a particle matrix and into matting, and then cured to produce components. These unitary polymer composite articles may be used in highly corrosion and wear-resistant environments.

Certain embodiments are directed to a method for producing a moulded composite article including the steps of: a) providing at least one layer of matting to a mould tool; b) filling to a predetermined level the mould tool with particles; and c) infusing a resin composition into the mould tool filled with the particles and the at least one layer of matting in order to form a composite.

Certain embodiments are directed to a method for producing a moulded composite article including the steps of: a) providing at least one layer of matting to a mould tool; b) filling to a predetermined level the mould tool with particles; c) infusing a resin composition into the mould tool filled with the particles and the at least one layer of matting in order to form a composite, wherein the composite comprises between 20% to 80% by weight of the resin composition and between 80% to 20% by weight of the particles; and d) curing the composite to form the moulded composite article, wherein the article is substantially void of air pockets.

Certain embodiments are to a unitary polymer composite article comprising: 50% to 90% by weight of particles; 10% to 50% by weight of resin; and at least one layer of matting integrally incorporated in the unitary polymer composite.

Certain embodiments are to a unitary polymer composite article comprising: 20% to 80% by weight of particles; 20% to 80% by weight of resin; and at least one layer of matting integrally incorporated in the unitary polymer composite. Certain embodiments are to a unitary polymer composite article comprising: 50% to 90% by weight of particles; 10% to 50% by weight of resin; and at least one layer of substantially continuous matting integrally incorporated in the unitary polymer composite article.

Certain embodiments are to a unitary polymer composite article comprising: 20% to 80% by weight of particles, wherein at least 20% of the particles have a Mohs hardness of greater than 6.5, 6.8, or 7; 20% to 80% by weight of resin; and at least one layer of matting integrally incorporated in the unitary polymer composite article.

Certain embodiments are to a unitary polymer composite article comprising: 20% to 80% by weight of particles, wherein at least 20% of the particles have a have a Mohs hardness of greater than 6.5, 6.8, or 7; 20% to 80% by weight of resin; and at least one layer of substantially continuous matting integrally incorporated in the unitary polymer composite article.

Certain embodiments are directed to methods and/or systems that may be used for producing resin/filler/matting composites. For example, certain methods and/or systems are directed to infusing a resin composition into a mould tool that is already filled to a predetermined level with particles and already has matting placed in the mould tool, wherein a substantial portion of the particles have a suitable hardness. After infusing the resin composition and ensuring that the formed composite has been sufficiently mixed and has a suitable distribution of the resin composition and the particles, then the composite may be cured to form a moulded composite article. Vibration of the mould tool and/or other suitable techniques may be used to ensure an acceptable level of mixing and suitable distribution the resin composition and the particles. Uniform distribution, or substantial uniform distribution, of the resin composition and the particles is desired to the extent it can be achieved. The resins used herein may be thermal setting resins as well as non-thermal setting resins. One exemplary particle type that may be used is Silicon carbide. However, other types of particles, or combinations of particles, may also be used. These particles may be treated to increase their wetting and/or bonding characteristics. Other fillers, matting, liners or combinations thereof may also be used. In addition to resin infusion methods and/or systems other methods and/or systems are disclosed herein. These moulded composite articles may be used in pumps, pump components and other mechanical parts and have uses in the mining industry, the chemical industry, flue gas desulphurization, desalination and/or other fields of use.

Certain embodiments are directed to a method for producing a moulded composite article comprising: a) adding at least one layer of matting to a mould tool; b) filling to a predetermined level the mould tool with particles; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and e) curing the composite to form the moulded composite article.

Certain embodiments are directed to a method for producing a moulded composite article comprising: a) providing at least one layer of matting to a mould tool; b) filling to a predetermined level the mould tool with particles, wherein a substantial portion of the particles have a Mohs hardness of 7 or greater; c) infusing a resin composition into the at least one layer of matting and the particles that are in the mould tool in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and d) curing the composite to form the moulded composite article.

Certain embodiments are directed to a method for producing a moulded composite article comprising: a) providing at least one layer of matting to a mould tool; b) filling to a predetermined level the mould tool with particles; c) infusing a resin composition into the at least one layer of matting and the particles that are in the mould tool in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 80% by weight of the resin composition and between 20% to 90% by weight of the particles; and e) curing the composite to form the moulded composite article.

Certain embodiments are directed to a method for producing a moulded composite article comprising: a) providing at least one layer of matting to a mould tool; b) filling the mould tool with particles; c) infusing a resin composition into the at least one layer of matting and the particles that are in the mould tool in order to form a composite; d) vibrating the mould tool for a portion of time at one or more of the following stages: during the filling with the particles, after the filling with particles, during the infusing of the resin composition and after the infusions of the resin composition; and e) curing the composite to form the moulded composite article.

Certain embodiments are directed to a method for producing a moulded composite article comprising: a) providing at least one layer of matting to a mould tool; b) filling the mould tool with particles; c) infusing a resin composition into the at least one layer of matting and the particles that are in the mould tool in order to form a composite; d) vibrating the at least one layer of matting and the particles in the mould tool for a portion of time at one or more of the following stages: during the filling with the particles, after the filling with particles, during the infusing of the resin composition and after the infusions of the resin composition; and e) curing the composite to form the moulded composite article.

Certain embodiments are directed to a method for producing a moulded composite article comprising: a) providing at least one layer of matting to a mould tool; b) filling to a predetermined level the mould tool with particles; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusion of the resin composition; wherein the composite comprises between 10% to 50% by weight of the resin composition and between 50% to 90% by weight of the particles; and e) curing the composite to form the moulded composite article.

Certain embodiments are directed to a method for producing a moulded composite article comprising: a) providing at least one layer of matting to a mould tool; b) filling to a predetermined level the mould tool with particles, wherein at least 20%, 30%, 40%, 50%, 60%, 70%, or 85% by weight of the particles have a Mohs hardness of 7 or greater; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and e) curing the composite to form the moulded composite article.

Certain embodiments are directed to a method for producing a moulded composite article comprising: a) providing at least one layer of matting to a mould tool; b) filling to a predetermined level the mould tool with particles, wherein at least 20%, 30%, 40%, 50%, 60%, 70%, or 85% by weight of the particles have a Mohs hardness of 7 or greater; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 80% by weight of the resin composition and between 20% to 90% by weight of the particles; and e) curing the composite to form the moulded composite article.

Certain embodiments are directed to a method for producing a moulded polymer ceramic composite article comprising: a) providing at least one layer of matting to a mould tool interior; b) substantially filling the mould tool interior with treated silicon carbide particles, wherein the mould tool is vibrated during at least a portion of the filling process; c) placing the mould tool filled with the treated particles and the at least one layer of matting under a vacuum of less than 100 mbar; d) infusing a resin composition into the mould tool interior substantially filled with the treated particles and the at least one layer of matting under a vacuum of less than 100 mbar and forming a composite, wherein the composite comprises between 15% to 30% by weight of the resin composition and between 70% to 85% by weight of the treated particles; and e) curing the composite by heating until cured.

Certain embodiments are directed to a method for producing a moulded polymer ceramic composite article comprising: a) providing at least one layer of matting to a mould tool interior; b) substantially filling the mould tool interior with a blend of silane treated silicon carbide particles, wherein a substantial portion of the blended particles is between 50 μm to 1 mm in size and the mould tool is vibrated during at least a portion of the filling process; c) continuing to vibrate the mould tool after filling in order to facilitate a packing of the blended particles; d) placing the mould tool filled with the blended particles and the at least one layer of matting under a vacuum of less than 100 mbar; e) infusing a resin composition into the mould tool interior substantially filled with the blended particles and the at least one layer of matting under a vacuum of less than 100 mbar and forming a composite; f) vibrating the mould tool substantially filled with the composite in order to facilitate densification; g) curing the mould tool substantially filled with the composite by heating until cured, wherein a portion of the resin composition is bonded to a substantial portion of the blended particles via a silane coupling agent that is coated on a substantial portion of the blended particles; and h) removing the cured moulded polymer ceramic composite article from the mould tool, wherein the article comprises between 15% to 30% by weight of the resin composition and between 70% to 85% by weight of the blend particles.

Certain embodiments are directed to a method for producing a moulded polymer ceramic composite article comprising: a) providing at least one layer of matting to a mould tool interior; b) substantially filling the mould tool interior with a blend comprising two or more grades of silane treated silicon carbide particles, wherein a substantial portion of the blended particles is between 50 μm to 1 mm in size and the mould tool is vibrated during at least a portion of the filling process at one or more vibration rates between 100 to 10,000 Hz; c) continuing to vibrate the mould tool after filling at one or more vibration rates between 100 to 10,000 Hz in order to facilitate a packing of the blended particles and to facilitate a substantially even flow of the blended particles into interior geometries of the mould tool; d) placing the mould tool filled with the blended particles and the at least one layer of matting under a vacuum of less than 100 mbar; e) infusing a resin composition into the mould tool interior substantially filled with the blended particles and the at least one layer of matting under a vacuum of less than 100 mbar to form a composite; f) vibrating the mould tool substantially filled with the composite at one or more vibration rates of between 100 to 10,000 Hz for a time period of between 1 minute to 45 minutes in order to facilitate densification and to mitigate against resin wash; g) curing the mould tool substantially filled with the composite and the at least one layer of matting by heating until cured, wherein a portion of the resin composition is bonded to a substantial portion of the blended particles via a silane coupling agent coated on a substantial portion of the blended particles; and h) removing the cured moulded polymer ceramic composite article from the mould tool, wherein the article comprises between 15% to 30% by weight of the resin composition and between 70 to 85% by weight of the blended particles.

Certain embodiments are directed to a method for producing a moulded composite article comprising: a) providing at least one layer of matting to a mould tool interior; b) filling to a predetermined level the mould tool with particles, wherein a substantial portion of the particles have a Mohs hardness of greater than 7; c) infusing a resin composition into the mould tool filled with the particles and the at least one layer of matting in order to form a composite, wherein at least a portion of the mould tool is subjected to a vacuum and at least a portion of the mould tool is subject to a positive pressure during at least a portion of the infusing of the resin composition; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and e) curing the composite to form the moulded composite article.

This summary is not intended to be limiting as to the embodiments disclosed herein and other embodiments are disclosed in this specification. In addition, limitations of one embodiment may be combined with limitations of other embodiments to form additional embodiments.

### BRIEF DESCRIPTION OF THE FIGURES

For a better understanding of the disclosure, and to show more clearly how it may be carried into effect according to one or more embodiments thereof, reference will now be made, by way of example, to the accompanying figures.

FIGS. 1A to 1I are schematic illustrations of the method used to make a moulded composite article with vacuum infusion, according to certain embodiments.

FIGS. 2A to 2I are schematic illustrations of the process used to make a moulded composite article with pressure infusion, according to certain embodiments.

FIGS. 3A to 3I are schematic illustrations of the process used to make a moulded composite article at atmospheric pressure, according to certain embodiments.

FIGS. 4A to 4E are schematic illustrations of moulds with infusion ports in various locations for use in infusion, according to certain embodiments.

FIG. 5 is a schematic illustration of a mould with infusion ports for use in pressure infusion, according to certain embodiments.

FIG. 6 is a schematic illustration of a mould with infusion ports for use in atmospheric infusion, according to certain embodiments.

FIG. 7 is a schematic illustration of a mould with double vacuum seal that may be used according to certain embodiments.

FIG. 8 is a schematic illustration of a mould lined at least in part with mat fibre, according to certain embodiments.

FIG. 9 is a schematic illustration of a mould with internal fibre, according to certain embodiments.

FIGS. 10A to 10D are schematic illustrations of a mould that may be infused through several ports, according to certain embodiments.

FIGS. 11A to 11F are schematic illustrations of the process of filling a mould with resin and then filler, according to certain embodiments.

FIGS. 12A to 12F are schematic illustrations of the process of filling a mould with powder resin and solid filler, according to certain embodiments.

FIGS. 13A to 13I are schematic illustrations of the process used to make a moulded composite article using combined pressure infusion and vacuum infusion, according to certain embodiments.

FIGS. 14A to 14I are schematic illustrations of the process used to make a moulded composite article and shows the use of a fibre mat to assist in dispersing the resin from the injection port to the extremities of the mould, according to certain embodiments.

FIGS. 15A to 15I are schematic illustrations of the process used to make a moulded composite article and shows incorporation of a preform in the inside of the moulding and the composite formed, according to certain embodiments.

FIGS. 16A to 16I are schematic illustrations of the process used to make a moulded composite article and shows the use of matting on multiple outside surfaces of the moulding, according to certain embodiments.

FIGS. 17A to 17I are schematic illustrations of the process used to make a moulded composite article and shows the matting on an outside surface and an inside surface of the moulding, according to certain embodiments.

FIGS. 18A to 18K are schematic illustrations of the process used to make a moulded composite article with alternative laying of fiber and particulate filler, according to certain embodiments.

FIGS. 19A to 19C illustrate the use of shims to position a preform in the moulding tool and to hold the preform in the desired orientation and location.

FIGS. 20A and 20B are schematic illustrations of an article, according to certain embodiments.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

The present disclosure is directed, at least in part, to methods and systems that use resin infusion and/or other methods in order to produce composite articles that are useful in certain environments. An exemplary embodiment is directed to a method where sufficiently hard particles are added to a mould tool to a predetermined level and then a resin composition is infused into the mould tool either via vacuum infusion or pressure infusion. Typically the mould tool will be vibrated during the addition of the particles in order to assure an even filling of the mould tool. Vibration may also be used at other stages of the method. Once the mould tool has been filled to the desired level with the particles and the resin composition, the formed composite is then cured in the mould tool, in order to produce the composite article.

One or more of the following advantages is found in many of the disclosed methods and/or systems and the articles produced.

A. The amount of resin composition mixed and particles used can be close to exactly what is required to fill the mould. Comparatively, the known slurry casting methods require mixing of excess resin/particles, in a batch process, to ensure that the mould is filled. The known slurry casting methods thus can result in waste and additional cost.

B. By directly infusing a resin composition into a matting/particle-filled tool in a closed system, the need to handle harsh resins and/or solvent is reduced and exposure of such resins and/or solvents to the atmosphere is reduced. Such closed systems facilitate improved worker safety and/or air quality controls.

C. Wear and tear mixing and pumping equipment is known to be a problem when mixing and pouring abrasive slurries. Certain disclosed embodiments eliminate, or substantially reduce, the process of wet mixing a resin/particulate slurry. This saves on wear and tear on the equipment and reduces the cost of manufacturing and/or the cost of replacing equipment.

D. Known slurry casting processes require the use of an excess of resin in the mixing and filling step which is then removed either after curing or is skimmed off in the liquid form as the solid filler settles in the mould tool. In the case of an ambient cure system, this excess resin typically cannot be recycled. In the case of a heat-cured system the resin can often be reused, but this is an additional intervention that is not required by the many of the disclosed embodiments.

E. The disclosed processes tend to introduce less air pockets into the final cured articles.

F. A mould can be used in casting which has more complex shapes, sharp corners, acute angles or combinations thereof.

G. In many of the disclosed embodiments, glass fiber mats and/or carbon mats that are set into the mould can be infused with the resin composition, as compared with traditional slurry casting methods where this is commercially impossible/impractical.

### The Particles

The particles may be selected from a variety of types of materials. For example, one or more of the following types of materials may be used: Silicon carbide, Alumina carbide, Tungsten carbide, Titanium carbide, Corundum, Quartz, Silicon dioxide, Silica, Silica sand, sand and other suitable non-absorbent particles. Silicon carbide particles are used in certain embodiments. Blends of different size grade Silicon carbide particles are used in certain embodiments.

The aspect ratio of a substantial portion of the particles used may vary. In certain applications, a substantial portion of the particles have an aspect ratio of between 0.7 to 1.3. Other suitable ranges of aspect ratios may also be used, for example, an aspect ratio of between 0.5 to 2, 0.7 to 2, 0.5 to 1.8, 0.8 to 1.2, or 0.5 to 1. A certain percentage of the particles used may fall outside of these aspect ratios. For example, in certain applications the weight percentage of particles that fall outside of one or more of these aspect ratio ranges may be less than 1%, 3%, 5%, 7% or 10%.

Different size ranges of the particles may be used. In certain applications, a substantial portion of the particles are between 50 μm to 1 mm in size. Other suitable size ranges may also be used, for example, between 25 μm to 3 mm, 100 μm to 1.5 mm, 75 μm to 0.8 mm, 500 μm to 1.2 mm, 750 μm to 1.5 mm, 1 mm to 2 mm, or 750 μm to 1.2 mm. A certain weight percentage of the particles used may fall outside these size ranges. For example, in certain applications the weight percentage of particles that fall outside of one or more of these size ranges may be less than 1%, 3%, 5%, 7% or 10%.

Different size grades of particles may also be blended to form the particles used. In certain applications, the particles comprise a blend of two or more different size grades of particles. In certain embodiment, the particles comprise a blend of at least 1, 2, 3, 4, 5 or 6 different size grades of particles. In certain embodiments, 2 to 4, 1 to 5, 2 to 5 or 3 to 6 different size grades of particles may be used.

Different ratios of different size grades of particles may also be used. For example, the particles may comprise about a 70:30 weight ratio blend of about 750 μm graded silicon carbide particles and about 200 μm graded silicon carbide particles. Another example is wherein the particles comprises a 65 to 75:25 to 35 weight ratio blend of 725 to 775 μm graded silicon carbide particles and 175 to 225 μm graded silicon carbide particles. Another example is wherein the particles comprise a blend of at least 3 different grades of particles comprising about one part 1 mm particles, about one part 750 μm particles, and about one part 100 μm particles. Another example is wherein the particles comprise a blend of at least 5 different grades of particles comprising about one part 1 mm particles, about one part 750 μm particles, about one part 500 μm particles, about one part 250 μm particles and about one part 100 μm particles. Another example is wherein the particles comprise a blend of at least 5 different grades of particles comprising about 15 to 25 weight parts of 0.9 to 1.1 mm particles, 15 to 25 weight parts 730 to 770 μm particles, 15 to 25 weight parts 480 to 520 μm particles, 15 to 25 weight parts 230 to 270 μm particles and 15 to 25 weight parts 90 to 110 μm particles. Other suitable weight ratios may also be used. For example, for a two-blend of different size grades of particles, the weight ratio may be 75:25, 85:15; 90:10; 95:5, 65:35, 60:40, 50:50, 40:60, 35:65, 5:95, 10:90, 15:85, 25:75 or other suitable weight ratios. Similar ranges of weight ratios may be used with blends of 3, 4, 5, or 6 different size grades of particles. A certain percentage of the particles used may fall outside these different size grades. For example, in certain applications the weight percentage of particles that fall outside of these different size grades may be less than 1%, 3%, 5%, 7%, 10%, 15% or 20%.

Different types of particles may also be combined, for example, wherein the particles comprise a blend of at least two different types of particles. Another example is wherein the particles comprise a blend of at least two to four different types of particles. The number of different types of particles that are used may be related to the particular application. Silicon carbide particles in one or more sizes can be combined with, for example, tungsten carbide particles in one or more sizes, and in the ratios disclosed herein. Furthermore, hollow microspheres can be beneficially added to produce a lightweight and/or wear resistant component, in certain embodiments up to 50% of the silicon carbide by volume can be replaced with hollow microspheres with a density of 0.125, 0.15, 0.20, 0.35 or 0.38 g/cc to produce a finished part with substantially reduced weight and/or density. In certain embodiments up to 50% of the silicon carbide by volume can be replaced with hollow microspheres with a density range of between 0.125 to 0.38 g/cc, 0.15 to 0.35 g/cc, 0.15 to 0.20 g/cc, 0.25 to 0.38 g/cc or other suitable ranges to produce a finished part with substantially reduced weight and/or density. In certain embodiments, microspheres can be added to produce a moulded component wherein up to 60%, 50%, 40%, 30% or 20% of the other particles by volume can be replaced with microspheres. In certain embodiments, the microspheres may be made up of natural and/or synthetic materials, for example glass microspheres, polymer microspheres, ceramic microspheres or combinations thereof. Solid and/or hollow microspheres may be used in certain applications. In certain aspects, hollow microspheres may be used to lower the density of the final material.

Different levels of hardness in the particles may also be used. One example is wherein a substantial portion of the particles have a Mohs hardness of between 8.8 and 9.2. Another example is wherein a substantial portion of the particles have a Mohs hardness of greater than 9 and are substantially inert. Other suitable ranges of Mohs hardness may also be used, for example, between 8 to 9.5, 7.5 to 9.5, 8.5 to 9.5, 6 to 7.5, 7 to 8.5, 6 to 8 or 9 to 9.5. In certain embodiments, at least 20%, 30%, 40%, 50%, 60%, 70%, 80%, 90%, 95%, 98%, 99% or 99.5% by weight of the particles may have a Mohs hardness of between 6.8 to 7.5, 7 to 8, 8 to 9.5, 7.5 to 9.5, 8.5 to 9.5, 6 to 7.5, 7 to 8.5, 6 to 8 or 9 to 9.5. In certain embodiments, a substantial portion of the particles will have a Mohs hardness of at least 5, 5.5, 6, 6.5, 7, 7.5, 8, 8.2, 8.5, 8.8, 9, or 9.5. In certain embodiments, at least 20%, 30%, 40%, 50%, 60%, 70%, 80%, 90%, 95%, 98%, 99% or 99.5% by weight of the particles may have a Mohs hardness of at least 5, 5.5, 6, 6.5, 7, 7.5, 8, 8.2, 8.5, 8.8, 9, or 9.5. A certain percentage of the particles used may fall outside these Mohs hardness values. For example, in certain applications the weight percentage of particles that fall outside of these Mohr hardness values may be less than 1%, 3%, 5%, 7% or 10%. In certain embodiments, a substantial portion of the particles used will be inert or substantially inert.

The particles used may be treated to enhance their ability to mix and/or combine with the resin composition used, in order to form a composite and/or a cured article. The treatment applied to the particles may be related in part to the types of particles used and/or to the make-up of the resin composition used. Various wetting agents and/or coupling agents may be used to enhance the interaction of the particles with the resin composition. Coupling agents tend to enhance the adhesion between a solid surface (e.g., particles) and a curable resin composition. Useful examples of suitable coupling agents include organo-silanes, zircoaluminates, and/or titanates. With respect to the organo-silanes, in certain embodiments coating a portion of the surface of a substantial portion of the silicon carbide particles with one or more alkyl-silane agents before infusion of the resin composition have been found to work well for enhancing the wetting and/or bonding between the particles and the resin. The coupling agent may be selected from a variety of coupling agents. In certain embodiments, the coupling agent comprises a plurality of molecules, each having a first end adapted to bond to the particles and a second end adapted to bond to the resin when cured. Exemplary coupling agents are Alpha Silanes produced by Power Chemical Corporation of South Korea. Other exemplary silanes are Dow Z-6032, and Z-6075 (vinyl triacetoxy silane) and similar coupling agents available from DeGussa and Crompton, for example, Dynasylan. Other exemplary coupling agents are one or more of the following: OCTEO (Octyltriethoxysilane), DOW Z6341 (octyltriethoxysilane), Dynasylan GLYMO (3-glycidyloxypropyltrimethoxysilane), DOW Z6040 (glycidoxypropyltrimethoxysilane), Dynasylan IBTEO (isobutyltriethoxysilane), Dynasylan 9116 (hexadecyltrimethoxysilane), DOW Z2306 (i-butyltrimethoxysilane), Dynasylan AMEO (3-aminopropyltriethoxysilane), DOW Z6020 (aminoethylaminopropyltrimethoxysilane), Dynasylan MEMO (3-methacryloxypropyltrimethoxysilane), DOW Z6030, DOW Z6032 (vinylbenzylaminoethylaminopropyltrimethoxysilane), DOW Z6172 (vinyl-tris-(2-methoxyethoxy) silane), DOW Z6300 (vinyltrimethoxysilane), DOW Z6011 (aminopropyltriethoxysilane) and DOW Z6075 (vinyl triacetoxy silane). Other exemplary coupling agents are titanates and other organo-metal ligands. Other coupling agents are also contemplated. Typically the choice of the coupling agent will be based at least in part on compatibility with the resin reactive groups and surface chemical groups on the proposed filler. The amount of coupling agent used may vary. For example, in certain embodiments, the Silicon carbide particles are treated with an organo-silane coupling agent composition that is capable of bonding to a portion of the resin composition during curing of the composite. In certain embodiments, the Silicon carbide particles are treated with an alkyl silane that is capable of bonding to a portion of the resin composition during curing of the composite. In certain embodiments, the coupling agent composition is present between 0.5 to 5 wt. % of the weight of particles. In other embodiments, the coupling agent composition is present between 0.5 to 1.5 wt. %, 1 to 3 wt. %, and 0.5 to 2 wt. % or in other suitable weight percentage ranges of the weight of particles used. In certain applications, combinations of the various coupling agents may also be used.

Wetting agents, or surfactants may also be used and tend to impact the rheology of the composition during processing. In general, various types of wetting agents, i.e., anionic, cationic, nonionic, amphoteric, zwitterionic, organic, and so on, can be employed in certain embodiments disclosed herein. Useful examples of wetting agents include INTERWET 33 from Chemie America Interstab Chemicals, New Brunswick, N.J.; FLUORAD from 3M Co. St. Paul, Minn. or AEROSOL OT from Rohm Haas, Philadelphia, Pa. Other suitable surfactant additives include the BYK range of additives produced by BYK-Chemie of the ALTANA group such as BYK-500, BYK-501, BYK-515, BYK-550, BYK-506, BYK-535, BYK-555, BYK-560, BYK-920, BYK-966, BYK-980, BYK-909, BYK-969 & BYK-985. Certain of these agents may also assist with preventing foaming during resin infusion under vacuum conditions in addition to their wetting behavior. In certain embodiments, the wetting agent composition is present between 0.5 to 2.5 wt. % of the weight of particles. In other embodiments, the wetting agent composition is present between 0.5 to 1.5 wt. %, 1 to 3 wt. %, 0.5 to 2 wt. %, 3 to 5 wt. %, 1 to 5 wt. % or in other suitable weight percentage ranges of the weight of particles used. In certain applications, combinations of the various wetting agents may also be used.

Flow agents may also be used in certain applications in preparing the particles to be used herein. Flow agents tend to prevent or reduce “caking” of powders during processing. For example, a flow agent may be used in certain embodiments to prevent the particles from caking during the blending step. Useful examples of flowing agents include condensates of ethylene oxide and unsaturated fatty acids. In certain embodiments, the flow agent composition is present between 0.5 to 2.5 wt. % of the weight of particles. In other embodiments, the flow agent composition is present between 0.5 to 1.5 wt. %, 1 to 3 wt. %, and 0.5 to 2 wt. % or in other suitable weight percentage ranges of the weight of particles used.

In certain applications, one or more of the following may be used: coupling agents, wetting agents, flow agents or combinations thereof.

### The Resin Composition

Various infusion grade resins may be used with the present disclosure. Some examples are vinyl ester resins, vinyl ester urethane hybrid based resins, epoxy based resins, polyester resins or combinations thereof. Resins that may be utilized may include non-thermoset resins and thermoset resins, such as thermoset polyester resins and thermoset vinyl ester resins, or combinations thereof. Generally, resins may be in liquid form, and when mixed with a catalyst and/or subjected to heat, a chemical reaction occurs forming a solid. However, the present disclosure also contemplates the use of liquid, solid, semi-solid resin compositions or combinations thereof.

Thermoset molecules will crosslink with each other during curing. Advantageous features of thermoset resins may include: ease in use for processing, do not necessarily need pressure to form, are generally inexpensive, usually are stronger than thermoplastics, and can be better suited to higher temperatures then thermoplastics. Some types of thermoset resins include, but are not limited to, epoxy thermoset resins, polyester thermoset resins, vinylester thermoset resins, polyurethane thermoset resins, phenolic thermoset resins or combinations thereof. Resins that may be utilized may include polyester resins and vinyl ester resins, which can be chemically tailored to be flexible or rigid, and can be reinforced, pigmented, and filled. These resins may be cured at ambient temperature, or in an oven up to 400° F. In general, polyesters may be formed from combining dicarboxylic acids and polyols (such as diols and glycols), and may also include additional monomers/diluents. In general, vinyl ester polymers may be formed from combining diepoxides and monocarboxylic acids, such as unsaturated monocarboxylic acids, and may also include additional monomers/diluents. The prepared vinyl ester may then be dissolved in a reactive solvent, such as styrene. Generally, vinyl ester resins have lower resin viscosities (approx 200 cps), than polyester resins (approx 500 cps) and epoxy resins (approx 900 cps). To cross-link the polymer molecules, an initiator, such as a peroxide initiator (catalyst), may be added. A particular type of thermosetting resin is the so-called turane resin, which is a thermosetting urethane or vinyl ester urethane hybrid resin, such as Daron 45 supplied by DSM. The thermosetting urethane combines during curing the chemistry of radical polymerization with polyurethanes. This 2-component resin system delivers at least two useful properties: (1) the curing reaction can be controlled from very fast to slow reacting systems and (2) the cured turane products have desired physical and chemical properties for use in many of the applications disclosed herein. The Daron 45 turane resin system consists of 2 components, i.e., Daron 45 and Lupranate M20R. Lupranate M20R is a polymeric methylene phenylisocyanate resin supplied by Elastogran GmbH other polymeric methylene phenylisocyanates may be used for example PAPI-27 supplied by Dow Chemical. Mixing both components, in the presence of catalysts and radical initiators, results in two curing reactions. Fully cured turane resin system based on Daron 45 results in reinforced composite with suitable chemical and/or thermal resistance combined with suitable mechanical properties. Composite construction produced with turane resin system based on Daron 45 turane exhibit suitable long-term heat resistance and suitable resistance to long-term mechanical loading and/or wear. Turane resin systems based on Daron 45 are applicable for open and closed mould techniques. Properties of cast unfilled resin systems may include, but are not limited to: a density of 1,180 kg/m³ at 23° C., volume shrinkage of 6.0%, heat deflection temperature (HDT) of 210° C., glass transition temperature (Tg) of 200° C., tensile strength of 70 MPa, modulation of elasticity in tension of 3.2 GPa, elongation at break of 2.5%, flexural strength of 140 MPa, modulation of elasticity in bending of 3.4 GPa, impact resistance (unnotched) of 15 kJ/m², fracture toughness of 0.5 MPa, water absorption at 80° C. of 1.2 wt. %. Unsaturated polyester or vinyl ester resins, generally, are cured by use of initiation systems. For example, unsaturated polyester or vinyl ester resin systems may be cured under the influence of peroxides and may be accelerated by the presence of metal compounds, such as cobalt salts as accelerators, for example, cobalt naphthenate and/or cobalt octanoate. In addition to accelerators, the polyester resins may also contain inhibitors and/or stabilizers so that the resin system does not gel prematurely. Polymerization initiation of unsaturated polyester resins, for example, by redox reactions involving peroxides, may be accelerated or pre-accelerated by a cobalt compound in combination with another accelerator. The unsaturated polyester resin or vinyl ester resin may suitably be selected from: (1) Ortho-resins which are based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A. Commonly the ones derived from 1,2-propylene glycol are used in combination with a reactive diluent such as styrene. (2) Iso-resins: these are prepared from isophthalic acid, maleic anhydride or fumaric acid, and glycols. These resins may contain higher proportions of reactive diluent than the ortho resins. (3) Bisphenol-A-fumarates: these are based on ethoxylated bisphenol-A and fumaric acid. (4) Chlorendics: are resins prepared from chlorine/bromine containing anhydrides or phenols in the preparation of the UP resins. (5) Vinyl ester resins: these are resins, which are often used because of their hydrolytic resistance and suitable mechanical properties, as well as for their low styrene emission; these resins have unsaturated sites in the terminal position, introduced by reaction of epoxy resins (e.g. diglycidyl ether of bisphenol-A, epoxies of the phenol-novolac type, or epoxies based on tetrabromobisphenol-A) with (meth)acrylic acid. Instead of (meth)acrylic acid also (meth)acrylamide may be used. Examples of suitable vinyl ester resins may include Derakane 470-300, Derakane Momentum 470-300, Derakane 411-350 produced by Ashland. Reactive groups curable by reaction with peroxides may be present in the resins, for instance, reactive groups derived from itaconic acid, citraconic acid and/or allylic groups. The unsaturated polyester resins may contain solvents, such as solvents inert to the resin system or that may be reactive therewith during the curing step. Examples of suitable reactive solvents include styrene, α-methylstyrene, (meth)acrylates, N-vinylpyrrolidone and N-vinylcaprolactam. The unsaturated polyester resins may contain approximately 1 wt. %, 3 wt. %, 5 wt. %, 7 wt. %, or 10 wt. % of a reactive solvent. Vinyl esters are processable by a range of moulding methods including infusion techniques such as resin transfer moulding (RTM), vacuum-assisted RTM, and the Seemann Composites Resin Infusion Moulding Process (RTM, VARTM, SCRIMP). Reinforced vinyl esters offer high strength, toughness, tensile elongation, heat resistance, chemical resistance, wear resistance or combinations thereof. Vinyl esters have the advantages of both unsaturated polyester and epoxy chemistries. The polymer backbone is formed by reacting unsaturated monocarboxylic acids (such as methacrylic acid) with high molecular weight bisphenol A and novolac epoxides. Unsaturated ester functional groups or linkages at the end of each vinyl ester linear molecular chain serve as sites for chain growth and crosslinking. Styrene, for example, serves as a diluent or thinner and coreactant in vinyl ester curing, and induces hydrophobicity or resistance to water absorption during polymerization. Vinyl esters can also have suitable mechanical properties to epoxies, while also decreasing processing time, such as eliminating the need for post cure. For example, urethane-modified DION 9800 vinyl ester, much like high-performance resins such as epoxy, provides suitable toughness and wet out properties in carbon fibre composites processed through infusion and other processes. Another example includes Reichhold's DION 9500 rubber-modified vinyl ester, which promotes surface adhesion in composites, along with suitable strength, toughness and elongation, and high viscosity at the end of the cure cycle. EPOVIA vinyl esters, such as isocyanate-modified EPOVIA RF 5000 vinyl ester, may provide high heat resistance, or EPOVIA RF 2000 SEHA, which provides suitable mechanical properties. Applications that need high levels of toughness, elongation and fatigue properties may use EPOVIA KRF-3200. In addition, EPOVIA KAYAK KRF-1001 vinyl ester, may be employed with silicone carbide filler, such as silicon carbide particles, or alumina/silicon carbide particles.

In certain embodiments, the viscosity of the resin/filler composition may have a viscosity at the processing temperature of less than 1500 cps, less than 1000 cps, less than 500 cps, or less than 300 cps. In certain embodiments, the viscosity of the resin/filler composition may have a viscosity at the processing temperature of between 150 cps to 1500 cps, 150 cps to 300 cps, 200 cps to 1000 cps, or 200 cps to 500 cps.

In certain embodiments, the resin mixture may be formulated to allow at least 30 minutes at room temperature without significant viscosity increase (due to reaction). In certain embodiments, the resin mixture may be formulated to allow at least 20, 40, 60, 90 minutes at room temperature without significant viscosity increase (due to reaction).

In certain embodiments, the cured composite article may have one or more of the following properties: an elongation at break of between 0.5 to 8%, a density of between 1 to 1.3 kg/m3, a hardness of between 70 to 95 Shore D, a volume shrinkage of less than 8%, a flexural strength above 120 MPa, and a tensile strength above 25 MPa. In certain embodiments, the cured composite article may have a volume shrinkage of less than 0.5%, 1%, 2%, 3%, 4%, 5%, 6%, 7% or 8%. In certain embodiments, the cured composite article may have a volume shrinkage of between 0.5% to 2%, 0.25% to 1%, 1% to 4%, or 5% to 9%.

In certain embodiments, the resin composition is a thermosetting infusion grade resin. Non-thermal setting resins may also be used in certain applications.

In many of the disclosed applications, the viscosity of the resin and/or the resin composition is one factor in selected a suitable resin. In general, lower viscosities upon infusion are desirable to assist in the infusion process. In certain applications, the viscosity of the resin and/or resin composition is less than 1500 cPs at 25° C., 1000 cPs at 25° C., 800 cPs at 25° C., 500 cPs at 25° C., 400 cPs at 25° C., 200 cPs at 25° C., 100 cPs at 25° C., 80 cPs at 25° C., 60 cPs at 25° C., 30 cPs at 25° C., or 10 cPs at 25° C. In certain embodiments, the viscosity of the resin and/or the resin composition is in the range of between 10 cPs to 500 cPs at 25° C., 10 cPs to 250 cPs at 25° C., 20 cPs to 600 cPs at 25° C., 30 cPs to 400 cPs at 25° C. degrees C., 100 cPs to 800 cPs at 25° C., or 50 cPs to 500 cPs at 25° C. In certain embodiments, the viscosity of the resin and/or the resin composition is in the range of between 10 cPs to 500 cPs at 45° C., 10 cPs to 250 cPs at 45° C., 20 cPs to 600 cPs at 45° C., 30 cPs to 400 cPs at 45° C., 100 cPs to 800 cPs at 45° C., or 50 cPs to 500 cPs at 45° C. Other suitable viscosities are also contemplated. For example, where a portion of the resin composition is mixed with the particles before adding the resin/particles composition to the moulding tool. Here the viscosity may higher than those viscosities provide herein. Another example would be use of a resin and/or resin composition that is thixotropic.

### Matting and Other Components

Certain embodiments are directed to mould articles wherein matting or other liner materials are used as an outer lining and/or in building up the cured article. The matting may be made from a number of different materials, for example, glass, glass fibers, carbon, carbon fibers, polymers, polymers fibers, minerals (such as wollastonite, clay particles, micas), mineral fibres (such as wollastonite, clay particles, micas), or combinations thereof. In addition, the terms “fibre” and “fibres” are to be taken to also include platelet and platelets, respectively. Fibre should also be construed to incorporate spherical glassy components, such as cenospheres, zenospheres, plerospheres or combinations thereof. Other spherical additives are glass beads and/or micro-balloons (hollow microscopic glass beads), which may be sourced from commercial manufacturers or from fly ash and/or bottom ash may also be used. Fibres can also be treated sizing agents or other chemical treatment to improve compatibility with resin mixtures, wetting of the fibres or other desirable properties. Combination of the above types of fibres and/or materials may also be used. In certain applications, glass and/or carbon fibres may be particularly suitable fibres. Cellulose fibres may also be used but these fibres are heat labile. In certain applications where weight is a factor, then cellulose fibres may be useful. The terms “fibre” and “filament” may be used interchangeably herein and includes chopped bundles of fibres and individualized filaments. In certain applications, the type of fibre, or combinations of fibre, selected may depend, at least in part, on its ability to be woven into appropriate cloth like materials. For example, one or more of the following: ceramic fibres, glass fibres, carbon fibres, polymer fibres (eg aramid fibre), wool fibres, cotton fibres, nylon fibres etc. In certain applications, the fibres with very high strength to weight ratios such as carbon, glass, certain polymer fibres or combinations thereof may be used. For example, in certain applications, the carbon fibre density may be at least 1.25 g/cc, 1.5 g/cc, 1.75 g/cc, 2 g/cc, 2.25 g/cc, 2.5 g/cc or other values. In certain applications, the carbon fibre density may be between 1.25 g/cc to 2.5 g/cc, 1.75 g/cc to 1.95 g/cc, 1.5 g/cc to 2.5 g/cc, 1.75 g/cc to 2.25 g/cc or other values. In certain applications, the carbon fibre may have an elongation at break of at least 0.2%, 0.3%, 0.5%, 1%, 2%, 4%, or other values. In certain applications, the carbon fibre may have an elongation at break of between 0.2% to 4%, 0.3% to 2.5% 0.5% to 2% or other values. In certain applications, the carbon fibre may have a tensile strength of at least 1000 MPa, 2500 MPa, 4000 MPa, 5000 MPa, 6000 MPa, 7000 MPa, 8000 MPa or other values. In certain applications, the carbon fibre may have a tensile strength of between 1000 MPa to 8000 MPa, 2500 MPa to 6000 MPa, 3000 MPa to 7000 MPa, or other values. In certain applications, the glass fibre density may be at least 1.25 g/cc, 1.5 g/cc, 1.75 g/cc, 2 g/cc, 2.5 g/cc, 3 g/cc or other values. In certain applications, the glass fibre density may be between 2 g/cc to 3 g/cc, 1 g/cc to 4 g/cc, or other values. In certain applications, the glass fibre may have a tensile strength of at least 1000 MPa, 1500 MPa, 2000 MPa, 2500 MPa, 3000 MPa, 3500 MPa, 4000 MPa or other values. In certain applications, the glass fibre may have a tensile strength of between 1000 MPa to 4000 MPa, 2000 MPa to 3500 MPa, 2000 MPa to 4000 MPa, or other values. In certain applications, the glass fibre may have an elongation at break of at least 3%, 4%, 5%, 6%, 7%, or other values. In certain applications, the glass fibre may have an elongation at break of between 4% to 7%, 4.53% to 6%, 5% to 8% or other values.

In certain applications, matting may be defined as a woven, non-woven, or a combination of woven and non-woven fabric type material comprised at least in part of individual fibres to form a sufficiently continuous, substantially continuous, or continuous cloth like material. In certain applications, matting may be defined as a woven, non-woven, or a combination of woven and non-woven type material, a liner, a cloth, a cloth like material, a matting like material, at least 1, 2, 3, 4, 5, 6, 7 or 8 layers of cloth, at least 1, 2, 3, 4, 5, 6, 7 or 8 layers of cloth like material, preforms, etc. The material may be cut to the desired size and shape to produce a preform 2 dimensional shape. In certain applications, multiple layers of the material can be stacked up or combined to produce a multilayer piece of matting. In certain applications, the matting may contain other additives.

If the matting material is a woven material, then the properties of the final composite may vary depending on the style of weaving that has been used. For example, some carbon and/or glass fibre matting may either be a bidirectional weave in which fibres are oriented at typically 90° to one another or a unidirectional weave in which the individual fibres are oriented substantially parallel to one another. Another example is some carbon and/or glass fibre matting may have a twill weave. In certain applications, twill weaves may have better “drape” and conformability than other types of weaves. Typically a twill weave is a bidirectional weave due to how the weave is produced. There are also other types of bidirectional weaves. Matting may also be produced in other weave types such as fish weave, satin weave, harness weave, or combinations thereof. The type of weave or combinations of weaves that are used may depend at least in part on the particular application.

If the matting is a non-woven material, then the properties of the final composite may vary depending on the thickness of the non-woven fibre and properties of the non-woven fibre. For example, thinner non-woven material may produce a lesser amount of reinforcement in the final moulding. Non-woven materials may produce a composite with reduced properties compared to an appropriately selected woven fabric reinforced composite, due at least in part to the less regular orientation of the reinforcing fibres in the non-woven. The reduction may manifest itself in reduced tensile and/or flexural strength, but non-wovens do have the advantage of often being more cost effective choices than woven mattings.

The particles and resin composition may be defined in terms of weight %, whereas matting may be defined at least in part by the thickness of the matting used either before infusion and/or after infusion. In certain applications, the at least one matting layer may have a thickness of at least 0.1 mm, 0.5 mm, 1 mm, 2 mm, 4 mm, 5 mm, 10 mm, 20 mm, 30 mm, 40 mm 50 mm, 75 mm or 100 mm. In certain applications, the at least one matting layer may have a thickness of between 0.1 mm to 50 mm. 0.1 mm to 2 mm, 0.5 mm to 10 mm, 2 mm to 10 mm, 5 mm to 30 mm, 20 mm to 50 mm, 1 mm to 75 mm, 20 mm to 100 mm or other ranges. In certain applications, the at least one preform may have a thickness of at least 0.1 mm, 0.5 mm, 1 mm, 2 mm, 4 mm, 5 mm, 10 mm, 20 mm, 30 mm, 40 mm 50 mm, 75 mm, or 100 mm. In certain applications, the at preform may have a thickness of between 0.1 mm to 50 mm. 0.1 mm to 2 mm, 0.5 mm to 10 mm, 2 mm to 10 mm, 5 mm to 30 mm, 20 mm to 50 mm, 1 mm to 75 mm, 20 mm to 100 mm or other ranges.

### Methods/Configurations for Adding Matting to a Mould

In certain applications, where multiple layers of fabric are stacked up to form the matting, a layer of adhesive may be used to hold the separate fabric layers together. Multiple layers of fabric may be held sufficiently together in various ways, for example using one of more of the following: adhesive sprays; adhesive coatings; stitched together; mechanically attached, for example using staples; and a multilayer fabric may be produced by folding a large section of single layer cloth. For example, an adhesive such as 3M Spray 77 can be applied in a light layer, with the aim of making the cloth slightly tacky such that the next layer may be lightly adhered and not become dislodged during handling or lay up in the mould. The same or a similar process may be used when the matting is to be positioned on an outside surface of the mould, in this case, the fibre matting will have a light spray of adhesive applied to the surface intended to be against the mould wall then be positioned on the mould surface. In certain applications, the layer of adhesive need only be heavy enough to produce the slight tackiness desired to hold the matting in place, this is a much smaller amount than would be used if true bonding of the surfaces were desired.

In certain applications, for example, where a complex shape is desired, and/or production processes demand speed in mould preparation, a preform may be used instead of laying up individual or multiple layers of matting. Preforms may also be used in other situations as well. Such a preform may be made using a separate mould or blank and is prepared by applying the cloth to the mould or blank and using a slightly heavier coat of adhesive between each layer of cloth. In this case the adhesive provides bonding between the layers and stiffness to hold the shape of the preform during handling and installing in the final mould. In certain applications, it may be desirable to apply sufficient adhesive to maintain, or substantially maintain, the integrity of the preform but at the same time avoid using too much adhesive such that the fabric becomes saturated with adhesive as this may impede resin flow during the subsequent infusion step. Also the type of adhesive selected may be influenced by the resin system being used. Alternatively the fabric may be soaked in a liquid solution of adhesive and/or starch-like material and then applied to the mould or blank and allowed to dry to form the stiffened preform. In this case it is desirable to ensure that the water or solvent is sufficiently, or substantially, removed from the preform prior to using the preform.

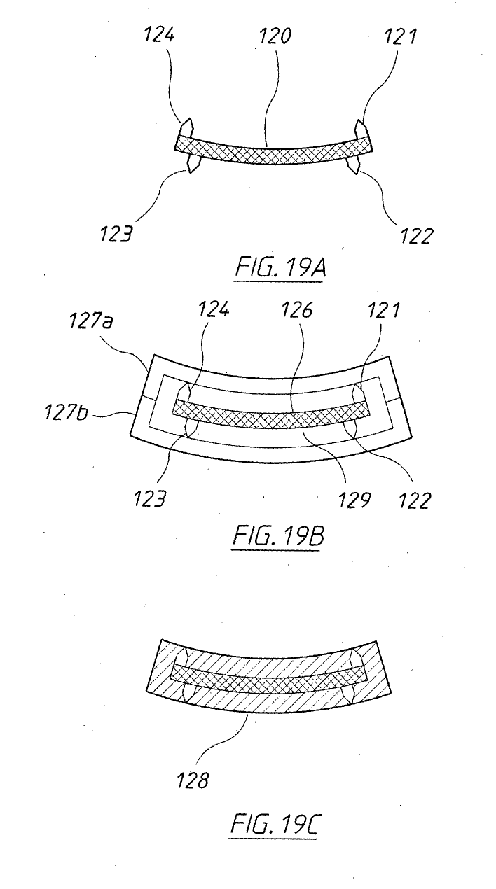

In the situation where the matting is to be included as an internal matting element, different techniques may be used to hold the matting in the desired position. In certain applications, it may be possible to include attachment points on a metal internal reinforcement to support the matting in the desired position. Alternatively, dowels or shims may be used. In certain applications, these dowels or shims may be formed using the resin that is used for the infusion and/or a similar resin type. The shims may then be attached to the preform. The shims or dowels permit the preform to be situated at a distance from the surface of the moulding. That distance may be controlled by the length and placement of the shims or dowels. Typically the shims and/or dowels are of a length sufficient to extend from the preform to one or more of the following: the interior surface of the mould, supporting reinforcement and other mould inserts. The shims and/or dowels also hold the preform in place as a result of contact with the one or more of the following: the mould, supporting reinforcement and other mould inserts. FIG. 19 discussed herein illustrates an exemplary embodiment, however, the placing and positioning to the shims and/or dowels may vary depending on the design of the mould, the design of the matting and/or preform, the design of the supporting reinforcement, the design of other mould inserts, or combinations thereof. The positioning of the matting and/or the preform may also be involved. When selecting and/or producing a fibre mat using the above methods disclosed herein, differential properties may be obtained by varying the orientation of the weave of subsequent layers of cloth, for example a 6 layer preform may be produced by orienting subsequent layers of standard bidirectional weave at around a 30° angle to one another with respect to weave direction. This may have the effect of providing a fibre mat with relatively uniform strength and properties in each direction. Alternatively, 6 layers of unidirectional weave cloth could be used in which one or more of 6 layers are aligned in a substantially parallel. This may have the effect of providing reinforcement and enhancement of properties in the direction of the weave but substantially less improvement of properties in the perpendicular direction. The variation in the arrangement of fabric mats is known in the composite industry, as are the variation in properties one can obtain by such variation.

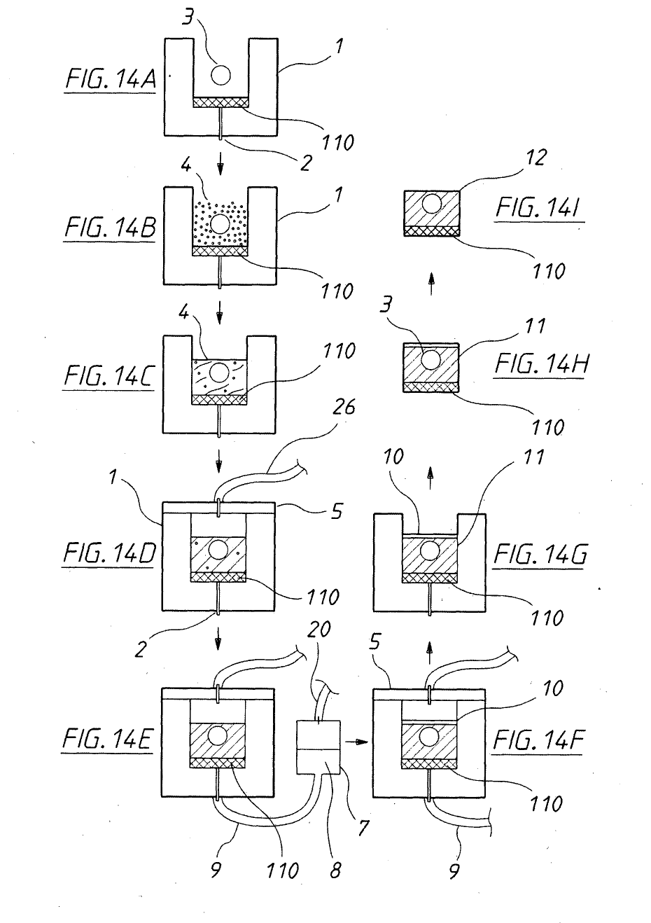

In certain applications, fibre matting may also be used advantageously to distribute the resin from the injection port. For example, the matting is positioned covering the infusion port and a continuous area of the tool where rapid resin distribution is desired. When the resin enters the port, it will rapidly infuse into the matting before continuing to fill the adjacent particulate filler. This happens because the weave of the fabric provides a path of lower resistance to resin flow than the densely packed filler. FIG. 14 illustrates such a process. In certain, embodiments, the at least one matting may be placed over the infusion port, on the infusion port opening, near the infusion opening, at least partial in the infusion port opening, in the infusion port opening, in close proximity to the infusion port opening or combinations thereof and this positioning of the at least one matting may permit faster infusion of the resin into the matting. If used in conjunction with matting on adjacent walls of the mould or supported internally in the mould, by ensuring that matting at the injection port overlays, or partially overlays, adjacent matting in the mould, then the rapid movement of resin may be further facilitated. This may have the effect of reducing the effective distance the resin travels to infuse through the particles.

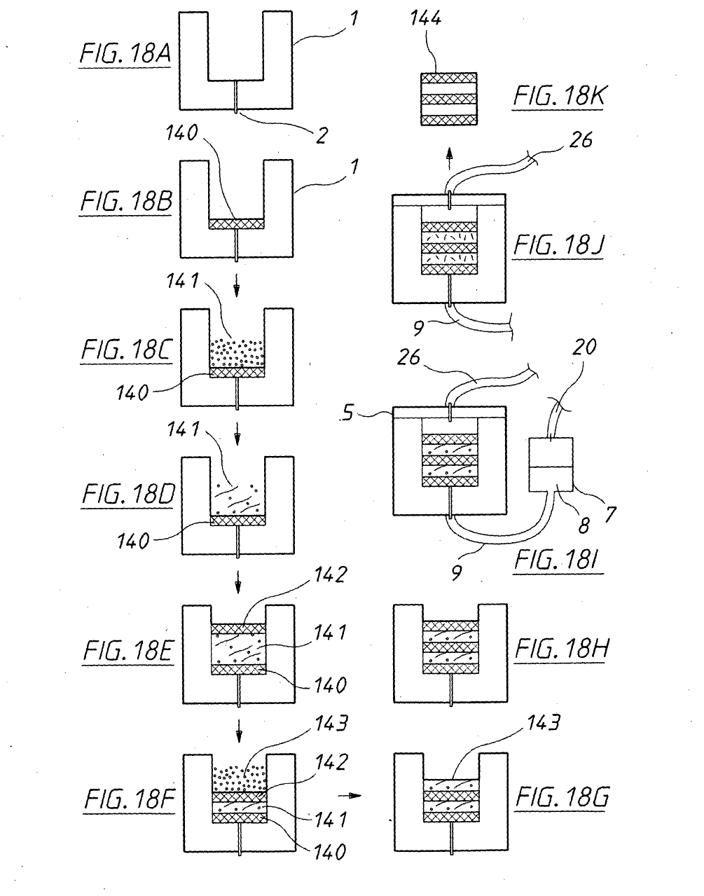

In certain embodiments, it may be desirable to alternatively fill the mould with solid filler and fibre matting to produce a multiple layer composite where layers of wear resisting media are interspersed with regions of reinforcing fibre matting. In certain embodiments, at least 2, 3, 4, 5, 6, 7, 8 or 9 layers may be used. This type of composite may be produced by applying matting to at least a portion of the mould surface (if desired), assembling the mould and adding particles to a predetermined level, vibrating to compact the particles, placing a stiffened fibre preform on top of the particles followed by filling with more particles and vibrocompacting. These steps could be repeated as many times as required until the mould is filled to the desired level, at which point it would undergo one or more of the infusion processes disclosed herein, for example, vacuum infusion, vacuum/positive pressure infusion, positive pressure infusion, gravitationally assisted infusion, etc. FIG. 18 illustrates such a process, according to certain embodiments.

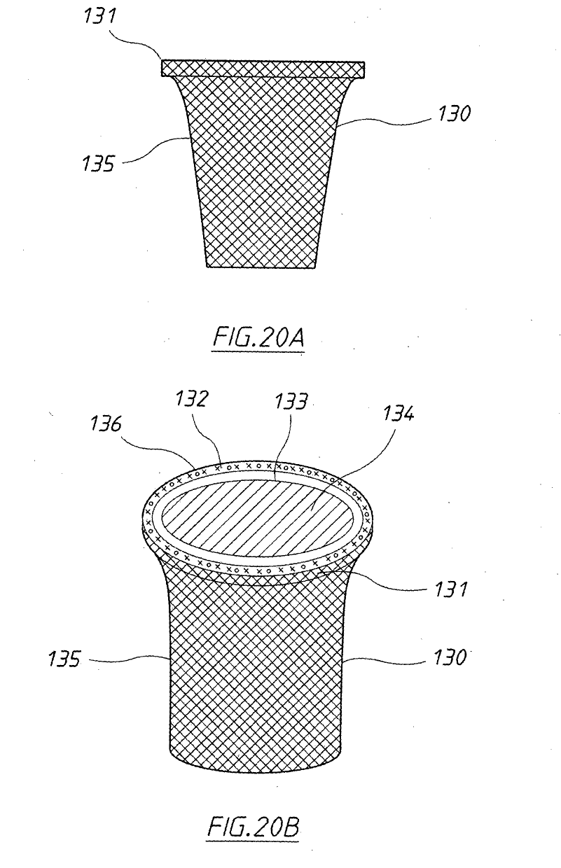

Various types of articles may be produced using the embodiments disclosed herein. For example, an article than can beneficially be produced with one or more of the methods disclosed herein is a hydrocyclone (see FIGS. 20A and 20B). In the traditional hydrocyclone an external casing of compression moulded fiberglass would be produced and rubber, ceramic or other material would be affixed to the inside of this external casing. Using the embodiment disclosed herein, the entire cyclone or a substantial portion of the cyclone may be fabricated as a unitary composite of matting, particle and resin. In this example, the infused fibre external layer provides at least in part the mechanical strength desired for the component to meet the service duty while the particulate ceramic composite provides at least in part the wear resistant internal surface desired for cyclones in abrasive duties. Using one or more of the methods embodiments disclosed herein, the need to produce a separate external casing may be eliminated, thereby significantly streamlining the manufacturing process.

Addition of matting to the articles disclosed herein may provide benefits to the final performance of the moulding. Depending on component geometry and the alignment of the matting within the component this could include substantial increases in tensile strength and/or flexural strength and significant changes to the modulus of the material. In certain applications such as the hydrocyclone described above or a pump, it may be possible to replace an existing metal casing using this composite arrangement by judicious selection and positioning of matting without compromising the strength of the finished article. This would produce a strong and lightweight finished article which has the added advantage of being produced in a single or reduced manufacturing steps.

FIG. 8 further illustrates and exemplary mould lined with matting. Where matting or other liner materials are used, these materials typically need to be infused with the resin composition. Certain embodiments disclosed herein make it possible to infuse, or to substantially infuse, the matting or other liner materials that have been inserted into the mould with the resin composition during the casting process. The technology of the present disclosure makes this much easier, as compared with other slurry casting methods. One of the reasons for this is that the resin is not premixed with the particles and therefore can effectively penetrate the liner materials already placed in the mould. In practice, it is commercially not possible to infuse such matting and/or other liner materials using known slurry casting methods. Certain of the casting techniques disclosed herein make it commercially possible to infuse and cast such composite articles. This represents a significant advance with respect to the casting of the types of composites disclosed herein.

Certain embodiments are directed to mould articles and methods of making such mould articles wherein a first portion of the mould article is prepared using the embodiments disclosed herein or other casting methods, for example, slurry casting. This first portion of the moulded article is at least partially cured or cured. And a second portion of the moulded article is prepared using embodiments disclosed herein and the second portion is at least partially cured or cured. The first portion and the second portion may then be combined and affixed or bonded together in a suitable manner. For example, a first portion is produced using slurry casting. A second portion is produced wherein matting or other liner materials are used as an outer lining and/or in building up the second portion. The matting may be made from a number of different materials, for example, glass fibers, carbon fibers or combinations thereof including all previously discussed fibre types. Where matting or other liner materials are used these materials typically need to be infused with the resin composition. Certain embodiments disclosed herein make it possible to infuse, or to substantially infuse, the matting or other liner materials that are being used with the second portion with the resin composition during the casting process. Certain of the casting techniques disclosed herein make it commercially possible to infuse and cast the second portion and thereafter combine the first portion and the second portion to produce a composite article.

Various fillers may also be used in certain embodiments. Fillers tend to affect properties of the composite and/or the articles produced. For example, fillers may impact on the hardness, porosity level, wear behavior, ease of machining, density, etc. Examples of filler materials include metal carbonates (such as calcium carbonate, chalk, calcite, marl, travertine, marble, limestone, calcium magnesium carbonate, sodium carbonate, magnesium carbonate), silicas (such as amorphous silica, quartz, glass beads, glass powder, glass bubbles, and glass fibers), silicates (such as talc, clays (montmorillonite), feldspar, mica, calcium silicate, calcium metasilicate, sodium aluminosilicate, sodium silicate), metal sulfates (such as calcium sulfate, barium sulfate, sodium sulfate, aluminum sodium sulfate, aluminum sulfate), aluminum trihydrate, metal oxides (such as calcium oxide (lime), aluminum oxide, titanium dioxide), metal sulfites (such as calcium sulfite), greystone, marble, gypsum, Na₂SiF₆, cryolite, vermiculite, carbide ceramics (such as tungsten carbides, silicon carbides, zirconium carbides, chromium carbide and other metal carbides) and combinations thereof.

### Resin Infusion and Other Methods

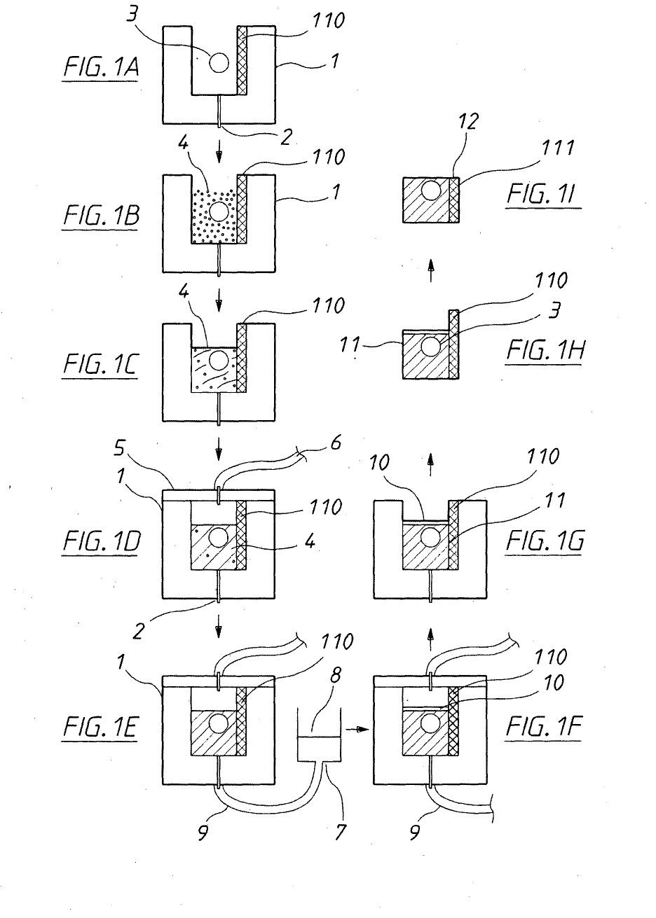

Various methods and/or systems are contemplated for infusing the resin into the mould tool once the particles have been added to the mould tool. Some exemplary arrangements are schematically shown in FIGS. 1 to 3 as well as in other Figures disclosed herein.

FIGS. 1A to 1I illustrates an exemplary method and/or system that use vacuum infusion, according to certain embodiments and may be used to produce a unitary polymer composite article(s) or a single casted polymer composite article(s). FIG. 1A shows a mould (1) suitable for the vacuum resin infusion processing. Also shown in FIG. 1A is at least one matting (110) that has be position in the mould along at least a portion of interior wall of the mould. In this exemplary embodiment, an exemplary matting that may be used is a unidirectional woven carbon fibre mat which consists of 3 individual layers of 0.25 mm thick carbon fibre fabric lightly bonded together using spray adhesive. However, it is to be understood that other types of matting may be used and the positioning of the at least one matting may be varied in the mould. The mould has at least one resin infusion port (2). The mould and other portions of the assembly may be optionally coated with a suitable mould release agent. This may be done either before or after the matting (110) is added, depending on the type of matting used and the impact the mould release agent may have on the matting. In certain applications, it may not be desirable to have uncured release agent in contact with the matting. In addition, if desired, the assembly may include a desired shaping element (3), insert and/or reinforcing element, etc. to form the final cast part, according to the part design parameters. Not shown here but the desired shaping element may be made of matting material or at least a portion of the desired shaping element may be made of matting material. FIG. 1A only shows one element (3), however, the mould may include a plurality of shaping elements, inserts and/or reinforcing elements, etc. or combinations thereof. The shaping elements, inserts or reinforcing elements, etc. may be formed from metal, silicon elastomer, polyurethane elastomer, thermoset plastic, wax, wood, matting or combination thereof. Other appropriate materials may also be used. The shaping elements and/or inserts may be multi-use items or single use consumables, as suits the component being manufactured. In the case of single use items, these would be destroyed during the demoulding process. Shaping elements and inserts similarly may be coated with a release agent to facilitate easy removal from the cured component. Reinforcing elements may be selected from a variety of suitable materials, for example, cast or fabricated metal elements. The reinforcing elements may be prepared and/or coated with an adhesive compatible with the resin material to be moulded, to facilitate at least in part bonding within the internals of the finish moulding component. At this time, it may be desirable to add a sealing cap (not shown) and to connect the tool to vacuum to ensure there are no vacuum leaks around the sealing elements prior to addition of moulding materials.

After the mould is assembled, some dry particulate filler (4) may be added to the mould. This is illustrated in FIG. 1B. The filler (4) may, or may not, be pretreated with a coupling agent and/or surfactant, but in either case it is desirable that the filler be sufficiently dry and/or sufficiently free of solvents, water or other liquid materials that may prevent free flow of the solid. Vibration may be used during and/or after the filling step to ensure the dry filler has sufficiently penetrated the cavities and/or regions of the mould. Vibration may also be used to further densify the filler material and/or reduce the volume of entrained air. Vibration is typically maintained for a sufficient time period to densify and/or transport the filler material. Excessive vibration may cause stratification of the filler. FIG. 1C illustrates the densified filler (4) and matting (110) after vibration is ceased.

FIG. 1D illustrates the mould (1) containing the densified filler (4) and matting (110) to which has been added the sealing cap (5) of the mould. The vacuum line (6) is connected to the mould and air is removed from the tool. In this case, the infusion port (2) is sealed, but the resin infusion line may be connected via a sealable tap fitting or other suitable mechanisms. For example, the infusion line may be directly clamped to facilitate vacuum formation. The vacuum pulled may vary and/or may be adjusted to different levels during the process. In certain applications, a vacuum of approximately less than 100 mbar may be applied. In certain applications, a vacuum of approximately less than 15 mbar, 20 mbar, 30 mbar, 40 mbar, 50 mbar, 150 mbar, 200 mbar, 300 mbar or even less than 500 mbar may be applied. A bleedable vacuum pump may be used to facilitate variation of the vacuum during the process. When the vacuum is sufficiently stable as determined by, for example a vacuum gauge fitted to the vacuum pump, this stage is complete.

Next a resin pot (7) is attached to the mould (1) via a resin infusion line and to the pot is added the premixed resin (8). This is illustrated in FIG. 1E. The resin may be premixed by hand, by static mixer or by continuous pot mixing. Other suitable mixing procedures may also be used. In certain applications, it is desirable for the resin mixture to be homogenous, or substantially homogenous, when added to the resin pot. The resin pot (7) in this example is open to the atmosphere, but in the case of air sensitive resins a sealable vacuum pot may be used. In addition, an inert atmosphere of, for example, nitrogen and/or argon gas under slight positive pressure may also be added. If desired, the resin pot may be suspended at a height above the mould to allow gravity assistance during resin infusion but this may not be needed as the vacuum force can overcome gravitational effects. The resin infusion line (9) is then opened and resin is pulled into the mould by the vacuum and/or gravity. Other appropriate mechanisms or combinations of mechanisms, for infusing the resin may also be used.

As illustrated in FIG. 1F, the infusion step is ceased when the appropriate volume of resin is added. The appropriate volume may vary depending on the particular application. The appropriate volume may be determined volumetrically by calculating the volume of void space in the mould filled with dry filler and matting, or gravimetrically by comparing the mass of dried filler and matting to the expected mass of the final component, or visually by continuing the filling step until the top surface of the dry filler has been wetted by the resin and a thin resin rich zone (10) has formed, or combinations thereof. In the case of visual determination, the mould sealing cap (5) it is useful if the sealing cap is fabricated from a transparent material and/or features viewing windows to allow visualization of the dry filler and eventual resin rich zone. When the filling step is deemed complete, the resin infusion is stopped by either closing the infusion line tap if one is in use, or clamping the infusion line (9). As illustrated in FIG. 1G, after resin infusion is completed and the infusion line is clamped, the tool can optionally be vibrated again to further densify the resin, matting and filler composite (11). This densification may be used to remove or minimize resin wash effects, where the velocity of infusing resin moves the filler away from the infusion port creating an undesirable resin rich zone at the infusion point. During this densification step the resin rich zone (10) at the top surface of the moulded article may increase in thickness due to further settling of the filler. Another option is to rotate the tool at least one time by at least 20% and vibrate the tool again to further densify the resin, matting and filler composite. After vibration is removed, the vacuum on the tool is released and the resin composition is allowed to cure in the tool. This curing step may occur at room temperature and/or one or more elevated temperatures.

As illustrated in FIG. 1H, the cured composite (11) is removed from the mould and, if desired, shaping elements or inserts (3) are removed from the moulding. In the case of components with reinforcing elements, these elements would remain bonded within and/or upon the component. A portion of the matting can also be removed, trimmed or further shaped at this step (not shown) or at another stage, for example, prior to post curing, during post curing, after post curing, during final machining, or combinations thereof.

As illustrated in FIG. 1I, after demoulding the component may be post-cured if necessary. One advantage of post-curing is for the resin composition to gain optimum properties. In addition, the resin rich zone and any excess of filler may be machined to produce the final component (12). Final machining may include, for example, balancing and/or smoothing of seal faces if the component end user requires this, but generally the component will be produced to net shape with the exception of any top surface resin rich zone. FIG. 1I also shows the matting (111) after a portion of the matting has been removed. The article produced is a unitary polymer composite article comprising: a weight percentage of particles; a weight percentage of resin; at least one layer of matting integrally incorporated in the article; and the article is sufficiently void free, substantially void free or a void free of pockets. In such an arrangement when the matting, or a portion of the matting, has been positioned at or near one or more external surfaces of the unitary polymer composite article, the flexural properties may be increased substantially when load is applied in such a way that the fibre mat portion of the article is at or near the surface of the article which is opposite the applied load. In this example, the composite article was found to possess a flexural strength of around 120 MPa compared to around 50 MPa for a similar part with no fibre reinforcement. The ability to produce unitary polymer composite articles, as disclosed herein, represents a significant advantage over the existing prior art.

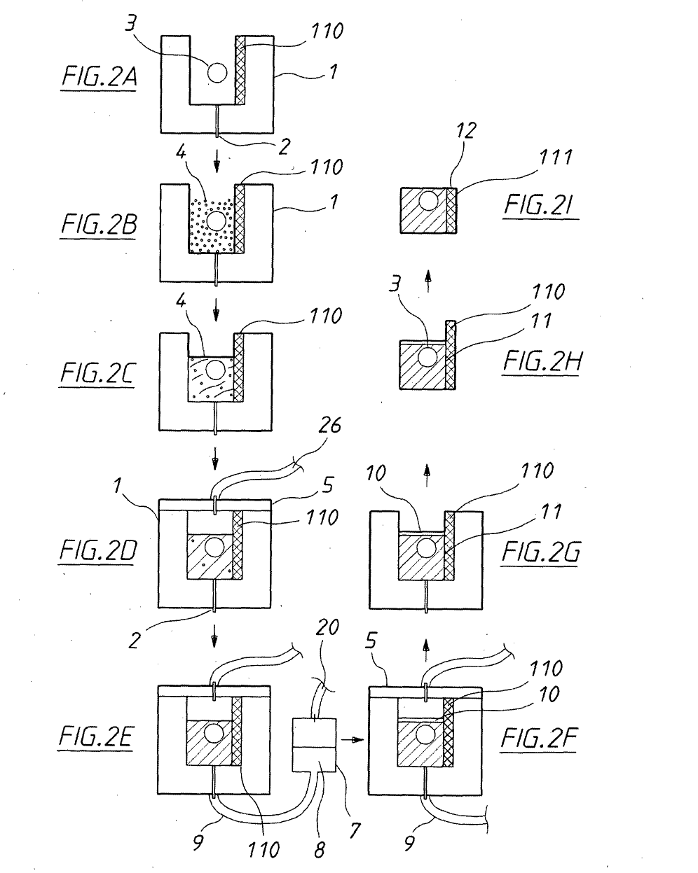

FIG. 2 illustrates an exemplary method and/or system that use pressure infusion and may be used to produce a unitary polymer composite article(s) or a single casted polymer composite article(s). FIG. 2A illustrates a mould (1) suitable for resin infusion processing featuring a resin infusion port (2) which may be coated with a suitable mould release agent and assembled including required shaping elements, inserts or reinforcing elements (3) to form the component according to the component design. Also shown in FIG. 2A is at least one matting (110) that has been position in the mould along at least a portion of interior wall of the mould. In this exemplary embodiment, the matting used is a non-woven glass fibre mat used in a single layer, using E type glass fibres. However, it is to be understood that other types of matting may be used and the positioning of the at least one matting may be varied in the mould. The coating with a suitable mould release agent may be done either before or after the matting (110) is added, depending on the type of matting used and the impact the mould release agent may have on the matting. In certain applications, it may not be desirable to have uncured release agent in contact with the matting. Not shown here but the desired shaping element may be made of matting material or at least a portion of the desired shaping element may be made of matting material. These shaping elements may be formed from metal, silicon elastomer, polyurethane elastomer, thermoset plastic, wax, wood, matting or combination of these materials. The shaping elements or inserts may be multi-use items or single use consumables, as suits the component being manufactured. In the case of single use items, these would be destroyed during the demoulding process. Shaping elements and inserts may be coated with a release agent to facilitate easy removal from the cured component. Reinforcing elements would typically, but not exclusively, be cast or fabricated metal elements, prepared and coated with an adhesive compatible with the resin material to be moulded, to facilitate sound bonding within the finished moulding. At this time it may be desirable to add the sealing cap and connect the tool to pressure to ensure there are no air leaks around the sealing elements prior to addition of moulding materials. In certain applications, it may be sufficient to have minimum air leaks in the system.

As illustrated in FIG. 2B, to the assembled mould (1) is added the dry particulate filler (4). The filler may or may not be pretreated with a coupling agent and/or surfactant, but in either case it is desirable that the filler be sufficiently dry and free of solvents, water or other liquid materials that may hinder free flow of the solid. Vibration can be advantageously used during and/or immediately after the filling step to ensure the dry filler has sufficiently penetrated the cavities and/or regions of the mould. Vibrations may also further densify the material and/or reduce the volume of entrained air. Vibration is typically maintained only for sufficient time to densify and/or transport the filler, as excessive vibration may cause stratification of the dry filler. FIG. 2C illustrates the densified filler (4) and matting (110) after vibration has ceased.

As illustrated in FIG. 2D, to the mould (1) containing densified filler and matting (110) is added the sealing cap (5) of the mould and the pressure inlet line (26) is connected to the mould and the tool is pressurised. The amount of pressure that is applied may vary depending on the particular application. In addition, the pressure applied may vary and/or may be adjusted to different levels during the process. In this illustration, the infusion port (2) is sealed, but the resin infusion line may also be connected via a sealable tap fitting, or the infusion line can be directly clamped to facilitate holding of a positive pressure. A bleedable pressure inlet line may be used to facilitate variation of the pressure during the process.

As illustrated in FIG. 2E, the resin pot (7) may be attached to the mould via a resin infusion line (9) and to the pot is added premixed resin (8). The resin pot (7) is sealed from the atmosphere and a positive pressure is applied to the resin pot via a pressure inlet line (20). The pressure in the tool and resin pot may be balanced to create a pressure differential which will facilitate transfer of the resin from the higher pressure resin pot (7) to the lower pressure mould (1). Advantageously the resin pot (7) may be suspended at a height above the mould to allow gravity assistance during resin infusion, if desired. However, this may not be needed as the induced pressure differential can overcome gravitational effects. The resin infusion line (9) is then opened and resin (8) is pushed into the tool by the positive pressure.

As shown in FIG. 2F, the infusion step is ceased when the appropriate volume of resin is added. This can be determined volumetrically by calculating the volume of void space in the mould filled with dry filler and matting, or gravitmetrically by comparing the mass of dried filler and matting to the expected mass of the final component, or visually by continuing the filling step until the top surface of the dry filler has been wetted by the resin and a resin rich zone (10) has formed or combinations thereof. In the case of visual determination, the mould sealing cap (5) may be fabricated from a transparent material and/or feature viewing windows to allow visualization of the dry filler and eventual resin rich zone (10). When the filling step is deemed complete, the resin infusion is stopped by either closing the infusion line tap or clamping the infusion line (9).

As shown in FIG. 2G, after resin infusion is completed and the infusion line is clamped, the tool can optionally be vibrated again to further densify the resin and filler composite (11). During this densification step the resin rich zone at the top surface (10) of the moulding may increase in thickness due to further settling of the filler. Another option is to rotate the tool at least one time by at least 20% and vibrate the tool again to further densify the resin, matting and filler composite. After vibration is removed the, the pressure on the tool and resin pot are released and the resin composition is allowed to cure in the tool. This curing step may occur at room temperature and/or one or more elevated temperatures. As shown in FIG. 2H, the cured composite (11) is removed from the mould and shaping elements and/or inserts (3) are removed from the moulding. In the case of components with reinforcing elements, these elements would remain bonded within or upon the component. A portion of the matting can also be removed, trimmed or further shaped at this step (not shown) or at another stage, for example, prior to post curing, during post curing, after post curing, during final machining, or combinations thereof.

As shown in FIG. 2I, after demoulding the component is post-cured if necessary. One advantage of post-curing is it allows for the resin composition to gain optimum properties and in the final step the resin rich zone and excess of filler is machined to produce the final component (12). Final machining may include balancing and/or smoothing of seal faces if the component end user requires this, but generally the component will be produced to a net shape with the exception of any top surface resin rich zone. FIG. 2I also shows the matting (111) after a portion of the matting has been removed. The article produced is a unitary polymer composite article comprising: a weight percentage of particles; a weight percentage of resin; at least one layer of matting integrally incorporated in the article. In certain applications, the article produced may be sufficiently void free, substantially void free or a void free of pockets. In such an arrangement when the matting, or a portion of the matting, has been positioned at or near one or more external surfaces of the unitary polymer composite article, the flexural properties may be increased substantially when load is applied in such a way that the fibre mat portion of the article is at or near the surface of the article which is opposite the applied load.

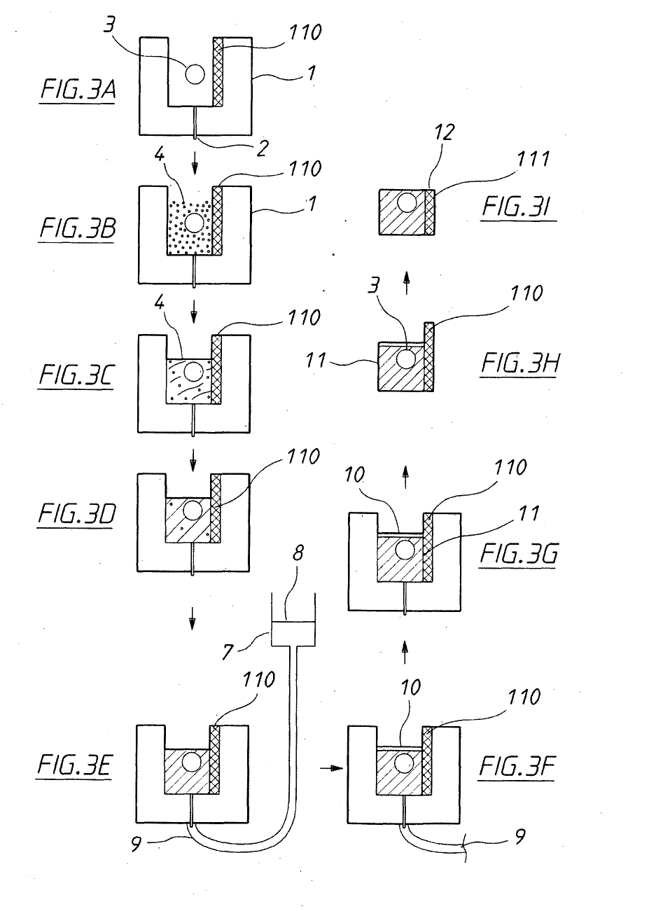

FIG. 3 illustrates an exemplary method and/or system that use atmospheric pressures to infuse the resin and may be used to produce a unitary polymer composite article(s) or a single casted polymer composite article(s). Other arrangements and configurations are also contemplated. FIG. 3A shows mould (1) suitable for resin infusion processing featuring a resin infusion port (2) which may be coated with a suitable mould release agent and assembled including required shaping elements, inserts or reinforcing elements (3) to form the final part according to the part design. Also shown in FIG. 3A is at least one matting (110) that has been position in the mould along at least a portion of interior wall of the mould. In this exemplary embodiment, the exemplary matting used is bidirectional carbon fibre weave matting consisting of 3 layers of 0.25 mm thick fabric. However, it is to be understood that other types of matting may be used and the positioning of the at least one matting may be varied in the mould. The coating with a suitable mould release agent may be done either before or after the matting (110) is added, depending on the type of matting used and the impact the mould release agent may have on the matting. In certain applications, it may not be desirable to have uncured release agent in contact with the matting. Not shown here but the desired shaping element may be made of matting material or at least a portion of the desired shaping element may be made of matting material. The shaping elements or inserts may be multi-use items or single use consumables, as suits the part being manufactured. In the case of single use items, these would be destroyed during the demoulding process. Shaping elements and/or inserts may be coated with a release agent to facilitate easy removal from the cured component. Reinforcing elements would typically, but not exclusively, be cast or fabricated metal elements, prepared and coated with an adhesive compatible with the resin material to be moulded, to facilitate sound bonding within the finished moulding.

As illustrated in FIG. 3B, to the assembled mould (1) is added the dry particulate filler (4). The filler may or may not be pretreated with a coupling agent or surfactant, but in either case the filler will be substantially dry and free of solvents, water or other liquid materials that may hinder free flow of the solid. Vibration can be advantageously used during and/or after the filling step to ensure the dry filler has sufficiently penetrated the cavities and/or regions of the mould. Vibration is typically maintained only for sufficient time to densify and/or transport the filler, as excessive vibration may cause stratification of the dry filler. FIG. 3C shows the densified filler (4) and matting (110) near the end of filling after vibration is ceased. FIG. 3D shows the densified filler (4) and matting (110) after filling has been completed and vibration is ceased.

As shown is FIG. 3E, the resin pot (7) is attached to the mould via a resin infusion line (9) and to the pot is added premixed resin (8). The resin pot is to be suspended at a height above the mould to create sufficient head pressure for resin infusion to occur. The amount of head pressure that is applied may vary depending on the particular application. In addition, the head pressure applied may vary and/or may be adjusted to different levels during the process by adjusting the height difference between the resin pot and the mould. The resin infusion line (9) is then opened and resin is pushed into the tool by the created head.

As shown in FIG. 3F, the infusion step is ceased when the appropriate volume of resin is added. This can be determined volumetrically by calculating the volume of void space in the mould filled with dry filler and matting, or gravitmetrically by comparing the mass of dried filler and matting to the expected mass of the final component, or visually by continuing the filling step until the top surface of the dry filler has been wetted by the resin and a thin resin rich zone (10) has formed. As the tool will be open to the atmosphere, visual inspection may be the easiest method of inspection depending on tool geometry. When the filling step is deemed complete, the resin infusion is stopped by either closing the infusion line tap or clamping the infusion line (9).

As shown in FIG. 3G, after resin infusion is completed and the infusion line is clamped, the tool can optionally be vibrated again to further densify the resin and filler composite (11). This densification may remove or minimize resin wash effects, where the velocity of infusing resin moves the filler away from the infusion port creating an undesirable resin rich zone at the infusion point. During this densification step the resin rich zone at the top surface (10) of the moulding may increase in thickness due to further settling of the filler. Another option is to rotate the tool at least one time by at least 20% and vibrate the tool again to further densify the resin, matting and filler composite. After vibration is removed the resin composition is allowed to cure. This curing step may occur at room temperature and/or at one or more elevated temperatures.

As shown in FIG. 3H, the cured composite (11) is removed from the mould and shaping elements or inserts (3) are removed from the moulding. In the case of components with reinforcing elements, these elements would remain bonded within or upon the component. A portion of the matting can also be removed, trimmed or further shaped at this step (not shown) or at another stage, for example, prior to post curing, during post curing, after post curing, during final machining, or combinations thereof.

As shown in FIG. 3I, after demoulding, the component may be post-cured, if necessary for the resin composition to gain optimum properties, and in the final step the resin rich zone and excess of filler is machined to produce the final component (12). Final machining may include balancing and smoothing of seal faces if the component end user requires this, but generally the component will be produced to net shape with the exception of the top surface resin rich zone. FIG. 3I also shows the matting (111) after a portion of the matting has been removed. The unitary polymer composite article produced has the matting integrally incorporated in the article, and the article is sufficiently void free, substantially void free or a void free of pockets. In such an arrangement when the matting, or a portion of the matting, has been positioned at or near one or more external surfaces of the unitary polymer composite article, the flexural properties may be increased substantially when load is applied in such a way that the fibre mat portion of the article is at or near the surface of the article which is opposite the applied load.

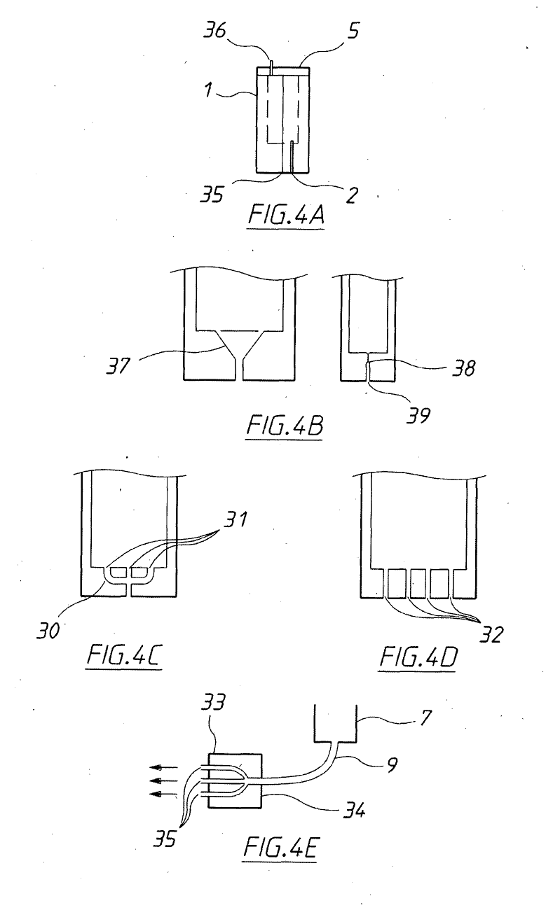

Various designs of moulds and infusion ports may be used with certain disclosed embodiments. For example, FIG. 4A illustrates a mould (1) that may be used for vacuum infusion, according to certain embodiments. The mould consists of a mould cavity which is shaped for forming the component, a resin infusion port (2) generally at the bottom of the mould, a sealable mould cap to facilitate sealing of the mould and holding of a vacuum, and parting lines (35) to allow disassembly of the mould and removal of the cured composite. The sealable mould cap (5) will usually have a vacuum inlet point (36) to allow the application of vacuum to the mould, however, this may be positioned elsewhere in the mould. For this process, the mould cavity is designed such that the dry filler and/or matting may be added to the mould prior to sealing with the mould cap (5). Other variations of this design may also be used. In certain embodiments, (not shown here) matting may be placed on the infusion port opening, near the infusion opening or in close proximity to the infusion port opening.

FIG. 4B illustrates a fanned style infusion port (37), according to certain embodiments. This infusion port has a fan shape, such that from the point of infusion the resin path widens to form a fan shape when viewed from one angle. When viewed from the side, the fan section is relatively thin (38) in comparison to its width and in comparison to the bore diameter of the resin inlet (39). This fan orientation advantageously reduces resin wash by dispersing the resin over a wider area at the infusion point and therefore reducing the point velocity of the resin to minimize resin wash of particulate filler near the port. Other variations of this design may also be used. In certain embodiments, (not shown here) matting may be placed on the infusion port opening, near the infusion opening, at least partial in the infusion port opening, in the infusion port opening, in close proximity to the infusion port opening or combinations thereof. Matting may also be positioned internal to the moulding, remote from the infusion ports.

FIG. 4C shows a split port style (30), according to certain embodiments. In this resin infusion port orientation the port splits into numerous inlet points (31) after the resin enters the tool. This allows for wider dispersion of the resin to multiple points in the tool with only a single resin line from the resin pot to the tool. Doing so can reduce the infusion velocity to reduce resin wash of particle fillers near the infusion point. Furthermore, this orientation allows resin to be introduced into multiple remote areas of the component to ensure a fully infused part is produced. Other variations of this design may also be used. In certain embodiments, (not shown here) matting may be placed on one or more of the infusion port openings, near one or more of the infusion openings, at least partial in one or more of the infusion port openings, in one or more of the infusion port openings, in close proximity to one or more of the infusion port openings or combinations thereof. Matting may also be positioned internal to the moulding, remote from the infusion ports.

FIG. 4D shows multiple ports (32), according to certain embodiments. In this orientation, a multitude of infusion ports are present in the mould with the objective of achieving similar benefits to those described for FIG. 4C. By not requiring a complex internal resin flow path, multiport tools can be more easily produced as compared with split port tools. However, such multiport tools generally require use of a distributor block or unit to feed the tool (FIG. 4E), otherwise multiple resin infusions lines may be required to run from the resin pot. Other variations of this design may also be used. In certain embodiments, (not shown here) matting may be placed on one or more of the infusion port openings, near one or more of the infusion openings, at least partial in one or more of the infusion port openings, in one or more of the infusion port openings, in close proximity to one or more to of the infusion port openings or combinations thereof. Matting may also be positioned internal to the moulding, remote from the infusion ports.

FIG. 4E shows a distributor unit (33) according to certain embodiments. This component may be used in conjunction with the multiple port style of tool. This block can be formed of metal, polymer, other suitable materials or combinations thereof, and consists of a single resin inlet point (34) which splits internally to feed multiple resin outlet points (35). Typically one or more of the outlet points is smaller than the inlet point. The advantage of this tool is that only a single line (9) from the resin pot (7) is required to feed the distributor block (33) which can be positioned close to the mould, or even on the mould, with multiple lines running from the distributor unit outlet points (35) to feed the multiple port mould. Furthermore, a distributor block unit can be used to feed several different moulds from a single resin pot allowing for increased manufacturing speed. Other variations of this design may also be used.

FIG. 5 illustrates a mould (1) that may be used for pressure infusion, according to certain embodiments. The mould consists of a mould cavity (42) shaped for forming the component, a resin infusion port (43) generally at the bottom of the mould, a sealable mould cap (44) to facilitate sealing of the mould and the holding of a positive pressure, and parting lines (45) to allow disassembly of the mould and removal of the cured composite. The sealable mould cap (44) will usually have a pressure inlet point (46) to allow the application of a pressure; however, this may be positioned elsewhere in the mould. For this process, the mould cavity is typically designed such that the dry filler and matting can be added to the mould prior to sealing. Other variations of this design may also be used. In certain, embodiments, (not shown here) matting may be placed on the infusion port opening, near the infusion opening, at least partial in the infusion port opening, in the infusion port opening, in close proximity to the infusion port opening or combinations thereof. Matting may also be positioned internal to the moulding, remote from the infusion ports.

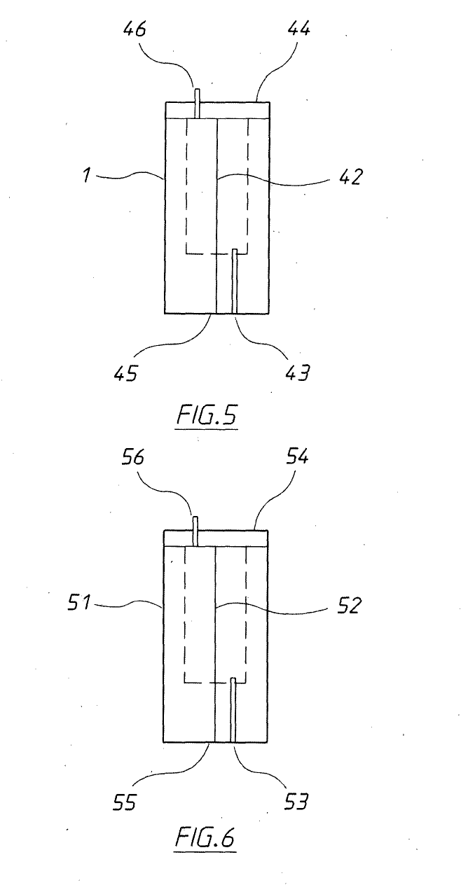

FIG. 6 shows a mould (51) for atmospheric infusion, according to certain embodiments. The mould consists of a mould cavity (52) shaped for forming the component, a resin infusion port (53) generally at the bottom of the mould, an optional sealing mould cap (54) to keep undesirable environmental particles and/or dust out of the mould, and parting lines (55) to allow disassembly of the mould and removal of the cured composite. If used, the sealable mould cap (54) will usually have an air outlet port (56) to allow the infusing resin to push air from the mould, however, this may be positioned elsewhere in the mould. For this process, the mould cavity is typically designed such that the dry filler and matting can be added to the mould prior to sealing. Other variations of this design may also be used. In certain, embodiments, (not shown here) matting may be placed on the infusion port opening, near the infusion opening, at least partial in the infusion port opening, in the infusion port opening, in close proximity to the infusion port opening or combinations thereof. Matting may also be positioned the internal to moulding, remote from the infusion ports.

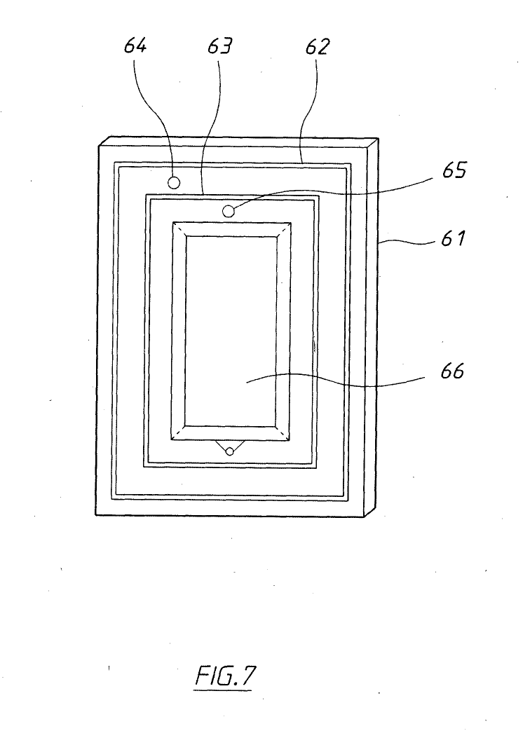

FIG. 7 shows a mould (61) with a double vacuum seal, according to certain embodiments. This style of mould features two parallel sealing grooves (62, 63) fitted with elastomeric sealing cord. A small void space is formed between the two sealing grooves when the mould is assembled and a vacuum port (64) may be located in this void space such that application of a vacuum to this port will effectively seal the tool along the double seal lines (62, 63) and create an interseal vacuum. This vacuum port is typically not responsible for the resin infusion step and exists as a sealing failsafe. A second vacuum port (65) is present within the mould cavity (or on the optional sealable mould cap as described in FIGS. 4A, 5A and 6A) to apply vacuum to the filler and/or facilitate resin infusion. The mould cavity (66) is recessed. Use of this sealing arrangement can advantageously reduce the impact of seal leaks on the infusion process. If the outer seal (62) has a slight leak, the interseal vacuum will substantially remove this air to reduce the likelihood of it penetrating through the inner seal (63) into the mould cavity (66). Similarly, if the inner seal (63) is not airtight the outer seal (62) can still hold the system under a substantially steady vacuum. This arrangement uses the concept of a redundant vacuum seal to increase the robustness of the process. Other variations of this design may also be used.

FIG. 8 shows a mould (71) lined with glass fibre, carbon fibre, other reinforcing fibre matting material or combinations thereof (72). In this exemplary embodiment, an internal surface of the mould cavity (73) may be lined with a carbon fibre and/or glass fibre matting material (72) either prior to or subsequent to mould assembly but prior to filling with the dry filler. The fibre mat, whether glass and/or carbon, may be held in place using a light coating of spray adhesive such as, but not limited to, 3M Spray 77 spray adhesive. Other exemplary ways of holding the matting in place include, but are not limited to using stitches to secure the fabric layers together, mechanically attached for example using staples, or a multilayer fabric could be produced by folding a large section of single layer cloth. Multiple layers and/or alternating layers of carbon and glass fibre can be used to achieve differential and/or complementary reinforcement properties arising from the arrangement of the layers. If carbon fibre is used, an additional layer of glass fibre can advantageously be added to segregate the carbon fibre from the dry filler to ensure there is minimal degradation of the carbon fibre reinforcing effect due to entrainment of small particles. After the resin is infused and cured and the component is demoulded, the fibre matting element (72) will be positioned on a visible external surface of the moulding and typically contain resin in a continuous manner throughout the moulding, in other words, in this example, there is no adhesive or other layer other than the resin between the bulk particulate moulding and the fibre reinforcement. This composite arrangement may improve the tensile and/or flexural strength of the particulate filled composite material. The method of reinforcement is compatible with vacuum, pressure or atmospheric infusion methods described herein, and illustrates an advantage of the disclosed methods in comparison to the prior art of slurry casting as such a composite material cannot be prepared using known commercial slurry casting methods. This arrangement is particularly advantageous to strengthen components exposed to wear from one side only such that the fibre reinforcement layer (72) would be positioned on the non-wear side of the moulding.

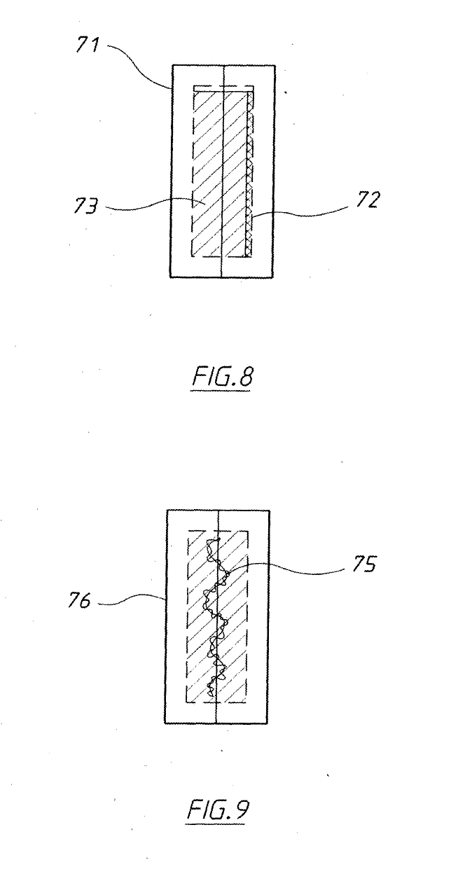

FIG. 9 shows an alternative arrangement to that described in FIG. 8 utilizing matting, for example, glass fibre, carbon fibre, other known fibre mat reinforcing materials or combinations thereof (75) to internally reinforce the particular moulding. In this case a portion of reinforcing fibre mat may be suspended or otherwise positioned within the mould (76) prior to filling with particulate fillers. If so desired, the portion of reinforcing fibre may be shaped to various configurations. After filling, infusion, curing and demoulding a component is produced which contains an internal reinforcement. This is particularly advantageous to strengthen components which may be exposed to wear from both sides, for example, the vanes of a turbine or pump impeller. The use of internal reinforcements compensates for one or more known problems, i.e., brittleness, poor flexural properties, and poor tensile properties of the particulate filled resin composites. The use of internal reinforcements allows for the moulding of thinner sections while achieving higher strength than would otherwise be possible without the reinforcement. In certain embodiments the strength may be increased by 10%, 20%, 30%, 50%, 70%, 100% or 150% while at the same time producing a composite component that is 0%, 5%, 10%, 15%, 20%, 30%, 40%, 50%, 60%, or 70% thinner. In certain embodiments the strength may be increased by at least 10%, 20%, 30%, 50%, 70%, 100% or 150% while at the same time producing a composite component that is at least 0%, 5%, 10%, 15%, 20%, 30%, 40%, 50%, 60%, or 70% thinner. In certain embodiments the strength may be increased by between 10% to 150%, 20% to 100%, 10% to 30%, 30% to 100%, 50% to 80% or 30% to 60% while at the same time producing a producing a composite component that is between 0% to 70%, 5% to 70%, 5% to 15%, 10% to 50%, 20% to 70%, 20% to 40% or 50% to 70% thinner. These thinner sections can yield higher performing parts, such as increased efficiency in pumping elements or turbine blades. This method is compatible with vacuum, pressure and atmospheric infusion methods described herein.

As discussed herein, the mould tool is filled to a predetermined level with the selected particles and matting may be positioned in the mould tool as discussed herein. The particles may be added in various manners that results in appropriate packing and filling of the tool. These particles may, or may not, have been treated with wetting agents, coupling agents, flow agents, other suitable additives or combinations thereof. Vibration of the mould tool and/or other suitable addition techniques such as compressed air to fluidize the particles being added may be used. In certain embodiments, during particle addition, the mould tool (and/or at other stages in the process) is vibrated in order to facilitate packing and addition of the particles to the tool. This is useful where the geometry of the mould tool is complex. The vibration rate is typically between 1 to 10,000 Hz. Other ranges of vibration may also be used, for example, 1 to 100 Hz, 1 to 1000 HZ, 100 to 1500 Hz, 500 to 2000 Hz, 1000 to 5000 Hz, 3000 to 7000 Hz or 5000 to 10,000 Hz. The vibration may be turned on and off in various time periods such as between 1 minute to 3 minutes, 2 minutes to 10 minutes or 5 minutes to 10 minutes. Other time periods may also be used, such as between 30 second to 1 hour, 15 minutes to 30 minutes or 30 minutes to 90 minutes. In certain applications, compressed air may also be used to fluidize the granular material during addition to the mould tool. Compressed air may be useful when filling complex geometries. Use of compressed air and other suitable technique may be combined with vibration in order to facilitate the process. Uniform distribution, or substantial uniform distribution, of the particles in the mould too is desired to the extent it can be achieved.

In certain embodiments, the vibration is continued for a period of time after filling to the predetermined level is completed to facilitate packing of the particles and even flow of the particles into geometries of the mould. In certain embodiments, during particle filling, the mould is vibrated at a vibration rate of between 100 to 10,000 Hz and vibration continues for up to one minute after filling is completed to facilitate packing of the particles and even flow of the particles into geometries of the mould. Infusion of the resin composition into the mould tool is carried out using a variety of different suitable techniques. For example, vacuum infusion, infusion under pressure and/or infusion at atmospheric pressure.

With respect to vacuum infusion, one technique is to attach a resin infusion port to the mould at one or several filling points. Typically this is carried out from the bottom portion or the lower region of the mould tool. Other locations may also be used. The tool with matting and filled particles is then sealed and placed under a vacuum of less than 100 mbar. Other vacuums may also be used or pulled. For example, a vacuum of less than 15 mbar, 20 mbar, 25 mbar, 50 mbar, 100 mbar, 150 mbar or 500 mbar. Ranges of vacuums and/or variation in the amount of vacuum pulled may also be used. For example, a vacuum of between 75 to 150 mbar, 50 to 200 mbar, 25 to 125 mbar or 50 to 150 mbar. Different methods may be used as to how the vacuum is applied to the mould tool or a portion of the mould tool. For example, the mould tool can either be a vacuum sealable tool itself or placed in a vacuum chamber or even a sealed bag attached to vacuum which is commonly known in the composite industry as “vacuum bagging.” Vacuum filling allows for faster infusion of the resin composition into the tool and/or also reduces the likelihood of air entrapment during infusion. An exemplary schematic for vacuum infusion is illustrated in FIG. 1.

Vacuum leakage may be an issue in certain equipment. This can be dealt with in a number of ways as long as a suitable vacuum is applied to facilitate the infusion. For example, as shown in FIG. 7, a mould with a double seal arrangement that facilitates creation of an interseal vacuum between the inner and outer seal is one way of mitigating vacuum leakage. Other methods may include the use of mastic vacuum tapes to seal junctions, hose fittings and other attachments in addition to clamping of the tool to ensure good seal compression. Combinations of various approaches may also be used in certain applications.

In order to add the resin composition, in certain embodiments, the resin composition is then mixed through a static mixer and dispensed into a resin pot attached to the other end of the infusion hose. A tap is opened on the infusion hose to allow resin to be induced into the tool under the pull of the vacuum. The resin is allowed to infuse through the particles and matting to fill the tool to the desired level. After filling, in certain embodiments, the tool is again vibro-compacted for a period of up to 5, 10, 20 or 30 minutes to ensure maximum densification and to mitigate against “resin wash” where particles are washed away from the injection port by resin flow resulting in a resin rich zone. Another option is to rotate the tool at least one time by at least 20% and vibrate the tool again to further densify the resin, matting and filler composite.

In certain embodiment, the methods using vacuum infusion may reduce the amount of wastage in resin and/or particles that has to be used as compared with traditional methods that premix the resin and particles before adding to the tool. In certain embodiments, the wasted resin and/or particles may be less than 20%, 15%, 10%, 8%, 5%, 3%, 2%, 1% or 0.5% by weight of the materials used for a particular manufacture. Such savings in waste and disposal costs may be advantages in this manufacturing process.

With respect to infusion of the resin composition into the mould tool under pressure, one technique is to attach a resin infusion port to the mould at one or several filling points. Typically this is carried out from the bottom, or the lower region of the mould tool. Other locations may also be used. The tool filled to the desired level with particles and matting is then subject to a pressure of approximately 10 psi or less. Other pressures may also be used. For example, a pressure of approximately 20 psi, 15 psi, 10 psi, 8 psi, 6 psi, 5 psi or less or the tool can be left open to atmospheric pressure. Ranges of pressure and/or variation in the amount of pressure applied may also be used. In addition, different pressures may be applied from different ports. For example, a pressure of between 5 psi to 25 psi, 5 psi to 15 psi, 8 psi to 20 psi or 5 psi to 10 psi may be applied to one or more ports. Different methods may be used as to how the pressure is applied to the mould tool or a portion of the mould tool, as long as a suitable pressure is applied in order to facilitate the infusion. An exemplary schematic for pressure infusion is illustrated in FIG. 2. In order to add the resin composition, in certain embodiments, the resin composition is then mixed through a static mixer and dispensed into a resin pot attached to the other end of the infusion hose. The resin pot is pressurized to a higher pressure than is present within the tool, i.e., a pressure differential is created to facilitate resin flow. By manipulating the magnitude of this differential, the rate of infusion can be controlled. A tap is opened on the infusion hose to allow resin to flow under pressure into the tool. The resin is allowed to infuse through the particles and matting to fill the tool. After filling, in certain embodiments, the tool is again vibro-compacted for a period of up to 5, 10, 15, 20 or 30 minutes to ensure maximum densification and to mitigate against “resin wash” where particles are washed away from the injection port by resin flow resulting in a resin rich zone. Another option is to rotate the tool at least one time by at least 20% and vibrate the tool again to further densify the resin, matting and filler composite. In certain embodiment, the methods using pressure infusion may reduce the amount of wastage in resin and/or particles that has to be used as compared with traditional methods that premix the resin and particles before adding to the tool. In certain embodiments, the wasted resin and/or particles may be less than 20%, 15%, 10%, 8%, 5%, 3%, 2%, 1% or 0.5% by weight of the materials used for a particular manufacture. Such savings in waste and disposal costs are useful in this manufacturing process.

Alternatively, the infusion step can be performed at atmospheric pressure. However, extended vibration times up to 30 minutes, 45 minutes, 60 minutes, 90 minutes, 2 hours, 3 hours, or 5 hours may be required after infusion under atmospheric pressure. In certain applications, longer infusion times may be needed. In certain embodiments, the infusion times may be a time period that is sufficient to ensuring that the formed composite has been sufficiently mixed. One advantage of atmospheric filing is that it requires significantly reduced investment in vacuum tooling and plant equipment, and the resin can be injected directly into the mould by a static mixing system without the need for an intervening resin pot. This allows for almost exact resin volumes to be used with minimal waste. In certain embodiments, the waste may be less than 10%, 8%, 5%, 3%, 2%, 1% or 0.5% by weight of the materials used for a particular manufacture. Such savings in waste and disposal costs are useful in this manufacturing process. An alternative method of practicing atmospheric infusion involves the use of a resin pot that is held at a height sufficiently above the tool to create a sufficient pressure differential, based on the use of gravity, to provide the force to infuse the resin into the interior of the mould tool.

With respect to infusing the resin composition into the mould, this may be accomplished via at least one, two, three or four port(s). This may also be accomplished using a progressive feeding system wherein a first port is used to feed the resin composition into the mould from one position on the mould to fill a first portion of the mould and then a second port is opened to feed the resin composition into a second portion of the mould. Variations on how the resin composition is feed into the mould are contemplated.

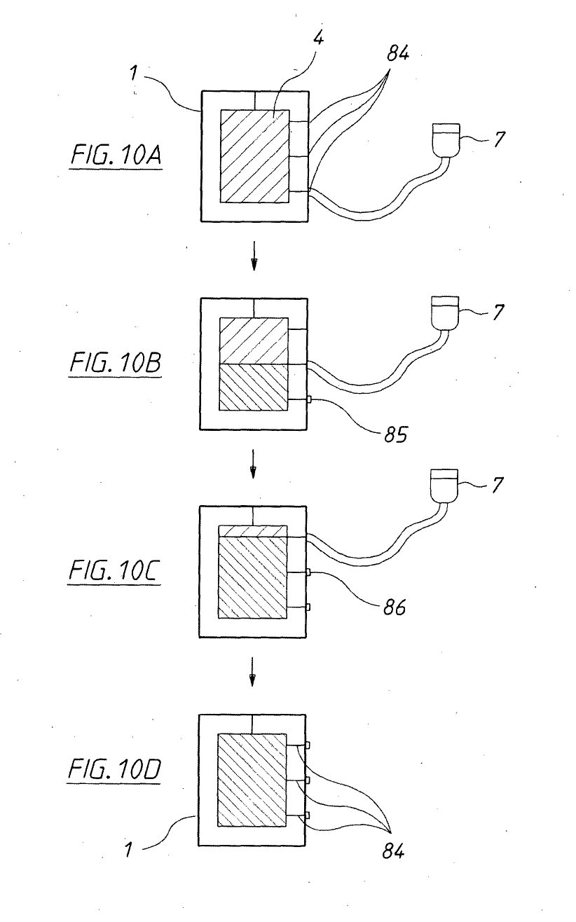

FIGS. 10A to 10D illustrates a mould infused progressively through several ports, according to certain embodiments. FIG. 10A shows a mould tool (1) which has been assembled, filled with dry filler (4) and optionally fibre mats (not shown) and sealed. This mould tool is shown connected to pressure or vacuum as appropriate to the infusion method being used, with a resin pot (7) connected. This example shows three resin infusion ports (84) oriented along a vertical axis of the mould. Alternatively, this mould could be open to atmosphere to perform atmospheric infusion as described herein. FIG. 10B shows the resin infusion commences under one or more of the following: vacuum, pressure, atmospheric pressure and combinations thereof and continues until the height of the resin reaches approximately the level of the second resin infusion port. At this point, the resin pot (7) is disconnected from the first resin infusion port and the port is sealed with a small plug (85). The resin pot (7) is then connected to the second resin infusion port and the infusion continued. The resin infusion ports may advantageously have sealing taps to facilitate easy connection and disconnection of the resin infusion line without the need for plugging. FIG. 10C shows the resin infusion continues until the resin reaches approximately the level of the third infusion port at which time the resin pot (7) is disconnected from the second resin infusion port, the port is sealed with a small plug (86) and the resin pot (7) is reconnected to the third infusion port and the infusion continued. This process would repeat until the mould was filled at which time the three resin ports would be sealed. Advantageously, this method allows for filling of a mould where otherwise large gravitational head pressures would be generated by the mass of resin within the mould slowing down the infusion rate. This method provides an alternative to using an ever higher vacuum or positive pressure to fill a large mould. FIG. 10D shows the fully infused mould (1) with the three resin infusion ports (84) sealed. In certain, embodiments, (not shown here) matting may be place on one or more of the infusion port openings, near one or more of the infusion openings, in close proximity to one or more of the infusion port openings or combinations thereof.

In certain embodiments, when placing matting in the mould tool and filling the mould tool with the particles and/or the resin composition or after placing the matting in the mould tool and filling the mould tool with the particles and/or the resin composition, it is desirable to apply mechanical and/or physical forces ensure that one or more of the following have occurred: the tool has been sufficiently filled, air pockets in the materials added have been sufficiently eliminated, the particles and resin composition have been sufficient mixed, the resin composition has sufficiently infused the matting, and complex geometries of the tool have been sufficiently filled. The mould tool may also contain other fillers and/or other materials as disclosed herein. Various techniques may be used to ensure that this occurs. For example vibration may be used. In certain embodiments, it is useful to vibrate the mould tool for a portion of time at one or more of the following stages: during the filling with the particles, after the filling with particles, during the infusing of the resin composition and after the infusions of the resin composition. In certain applications, after the mould tool with matting is filled with the particles and the resin composition, the mould tool is vibrated at one or more vibration rates of between 1 to 10,000 Hz for a time period of between 1 minute to 45 minutes. In certain applications, after the mould tool with matting is filled with the particles and the resin composition, the mould tool is vibrated at one or more vibration rates of between 1 to 10,000 Hz for a time period of between 1 minute to 75 minutes in order to facilitate one or more of the following: densification and to mitigate against resin wash; to achieve uniform distribution, or substantially uniform, distribution of the resin composition and the particles to the extent it can be achieved; infusion of the resin composition into the matting; infusion of the resin composition into at least a portion of the matting; substantial infusion of the resin composition into the matting; substantial infusion of the resin composition into at least a portion of the matting; sufficient infusion of the resin composition into the matting; and sufficient infusion of the resin composition into at least a portion of the matting. Other ranges of vibration may also be used to vibrate the mould tool containing matting, particles and the resin composition and optionally other fillers, for example, 1 to 100 Hz, 1 to 1000 HZ, 100 to 1500 Hz, 500 to 2000 Hz, 1000 to 5000 Hz, 3000 to 7000 Hz or 5000 to 10,000 Hz. The vibration may be turned on and off in various time periods such as between 1 minute to 3 minutes, 2 minutes to 10 minutes or 5 minutes to 10 minutes. Other time periods for vibration may also be used, such as between 30 second to 1 hour, 15 minutes to 30 minutes, 30 minutes to 90 minutes or 1 hour to 4 hours. These time periods may be applied to, in certain applications, to one or more of the stages where vibration is desired. Another option, in certain embodiments, is to rotate the tool at least one time by at least 20% and vibrate the tool again to in order to further facilitate one or more of the following: densification and to mitigate against resin wash; to achieve uniform distribution, or substantially uniform, distribution of the resin composition and the particles to the extent it can be achieved; infusion of the resin composition into the matting; infusion of the resin composition into at least a portion of the matting; substantial infusion of the resin composition into the matting; substantial infusion of the resin composition into at least a portion of the matting; sufficient infusion of the resin composition into the matting; and sufficient infusion of the resin composition into at least a portion of the matting. In certain embodiments, the filled mould tool may be rotated at least 1, 2, 3, 4 or 5 times by at least 10%, 20%, 30%, 50% or 60% and vibrated tool again to in order to further facilitate one or more of the following: densification and to mitigate against resin wash; to achieve uniform distribution, or substantial uniform distribution, of the resin composition and the particles to the extent it can be achieved; infusion of the resin composition into the matting; infusion of the resin composition into at least a portion of the matting; substantial infusion of the resin composition into the matting; substantial infusion of the resin composition into at least a portion of the matting; sufficient infusion of the resin composition into the matting; and sufficient infusion of the resin composition into at least a portion of the matting.

The percentages of the particles and the resin composition that may be found in the composite may vary. The amount and/or volume of matting that may be found in the composite may also vary. In certain embodiments, the composite comprises: between 10% to 50% by weight of the resin composition and between 50% to 90% by weight of the particles. In other embodiments, the composite comprises: between 20% to 30% by weight of the resin composition and between 70% to 80% by weight of the particles. In certain embodiments, the resin composition comprises approximately 10% to 50%, 20% to 25%, 20% to 30%, 25% to 35%, 30% to 45%, 40% to 55% or 50% to 80%, by weight of the total weight of the composite. In certain embodiments, the particles comprise approximately 90% to 50%, 80% to 75%, 80% to 70%, 75% to 65%, 70% to 55%, 60% to 45% or 20% to 50% by weight of the total weight of the composite. In certain embodiments, the resin composition comprises at least 10%, 20%, 30%, 40%, 50%, 60%, 70% or 80% by weight of the total weight of the composite. In certain embodiments, the particles comprises at least 20%, 30%, 40%, 50%, 60%, 70%, 80% or 90% by weight of the total weight of the composite. In addition, other components may be present in the composite. For example, chopped glass fibre, chopped or milled carbon fibre, microspheres, or combinations thereof can be used up to 3%, 5%, 7% or 10% by weight. Hollow microspheres can be used up to 30%, 40%, 50% or 60% by volume (the by weight will change based on density of microspheres). These materials may be used to displace the filler, but typically not the resin.

Following infusion and after the composite is sufficiently formed, the tool is removed from the vacuum, pressure and/or vibration source and is placed in an oven to cure. Various curing time periods and temperatures may be used to achieve the desired properties of the cured moulded composite article. For example, curing can be achieved by simply heating to 80° C. and holding for 4 hours. Alternatively, certain embodiments include a temperature ramp in the process whereby the filled tool is first heated to a lower temperature of for example 50° C. for two hours followed by increasing to for example 60° C. and finally to for example 80° C. for a minimum of one hour hold at each of these temperatures. Other temperatures may also be used in the ramp curing. In certain embodiments, the filled tool is subjected to 1, 2, 3, 4 or 5 different curing temperatures. For example, the filled tool is subject to curing between 40° C. to 60° C. for a time period of between 30 minutes to 3 hours and between 70° C. to 90° C. for a time period of between 1 hour to 3 hours. Another example is the filled tool is subject to curing between 40° C. to 60° C. for a time period of between 30 minutes to 3 hours, and then subjected to curing temperature of 50° C. to 70° C. for a time period of between 30 minutes to 2 hours and finally subject to a curing temperature of between 70° C. to 90° C. for a time period of between 1 hour to 3 hours.

In certain embodiments, the method comprises the mould tool being substantially filled with the silicon carbide particles and the resin composition is cured in a temperature range between 70° C. and 90° C. for between 3 hours to 6 hours.

In certain embodiments, the method comprises the mould tool being substantially filled with the silicon carbide particles and the resin composition is cured using a temperature ramp of at least one, two, three or four different temperatures wherein the silicon carbide particles and the resin composition is held at each temperature for between 30 minutes to 3 hours.

Other methods and/or variations on resin infusion are also contemplated in the present disclosure. In certain embodiments, at least one layer of matting may be positioned in a mould tool, the mould tool may be partially filled with a first portion of a resin composition and then a first portion of the particles may be added. Vibration and/or other suitable techniques may be used to mix and distribute the resin composition and the particles at one or more stages in this process. Uniform distribution, or substantial uniform distribution, of the resin composition and the particles is desired to the extent it can be achieved. Thereafter, the mould tool may be partially filled with a second portion of a resin composition and then a second portion of the particles may be added. Alternatively, at least one second layer of matting may be positioned in the mould either before or after the second portion of a resin composition and/or a second portion of the particles has been added. Vibration and/or other suitable techniques may be used again to mix and suitably distribute the resin composition and the particles at one or more stages in this process. These steps can be repeated until the mould tool is filled to a predetermined level and the composite is formed. The composite may then be cured to form a moulded composite article. Other fillers may also be used in forming the product to be cured.

In certain embodiments, the mould tool may be partially filled with a first portion of particles and then a first portion of a resin composition may be added. Vibration and/or other suitable techniques may be used to mix and suitably distribute the resin composition and the particles at one or more stages in this process. Uniform distribution, or substantially uniform distribution, of the resin composition and the particles is desired to the extent it can be achieved. Thereafter, the mould tool may be partially filled with a second portion of particles and then a second portion of the resin composition. Vibration and/or other suitable techniques may be used again to mix and suitably distribute the resin composition and the particles at one or more stages in this process. These steps can be repeated until the mould tool is filled to a predetermined level and the composite is formed. Other fillers and/or matting or liners may also be used in forming the product to be cured. The composite may then be cured to form a moulded composite article.

In certain embodiments, at least one layer of matting may be positioned in a mould tool, the particles may be premixed with a powdered resin composition and this mixture of powdered resin composition and particles may be added to the mould tool to a predetermined level. Vibration and/or other suitable techniques may be used to mix and suitably distribute the resin composition and the particles at one or more stages in this process. Uniform distribution, or substantially uniform distribution, of the resin composition and the particles is desired to the extent it can be achieved. Other fillers may also be used in forming the product to be cured. The filled tool is then evacuated with a vacuum of less than 100 mbar and heated to effect fusion and curing and yield the consolidated composite article.

In certain embodiments, at least one layer of matting may be positioned in a mould tool, the particles may be premixed with a resin composition that has a higher viscosity at a first temperature and the resin/particles composition added to a mould tool to a predetermined level. And thereafter, the resin/particles composition may be heated to a second temperature such that the viscosity of the resin composition is reduced to a suitable level. Vibration and/or other suitable techniques may be then used to mix and suitably distribute the resin composition and the particles at one or more stages in this process. Uniform distribution, or substantially uniform distribution, of the resin composition and the particles is desired to the extent it can be achieved. Other fillers may also be used in forming the product to be cured. Once the composite is formed it may be cured to form a moulded composite article.

In certain embodiments, at least one layer of matting may be positioned in a mould tool, the particles may be added to a predetermined level in the mould tool. Thereafter a resin composition that has a higher viscosity at a first temperature may be infused into the mould tool. And the resin/particles composition may be heated to a second temperature such that the viscosity of the resin composition is reduced to a suitable level. Vibration and/or other suitable techniques may be then used to mix and suitably distribute the resin composition and the particles. Uniform distribution, or substantially uniform distribution, of the resin composition and the particles is desired to the extent it can be achieved. Once the composite is formed it may be cured to form a moulded composite article. Other fillers may also be used in forming the product to be cured.

In certain embodiments, at least one layer of matting may be positioned in a mould tool, the particles may be premixed with a first resin composition that has a higher viscosity and the resin/particles composition added to a mould tool to a predetermined level. And thereafter, a second resin composition may be added such that the viscosity of the combined first and second resin composition is reduced to a suitable level. Vibration and/or other suitable techniques may be then used to mix and suitably distribute the resin composition and the particles at one or more stages in this process. Uniform distribution, or substantially uniform distribution, of the resin composition and the particles is desired to the extent it can be achieved. Once the composite is formed it may be cured to form a moulded composite article. Other fillers may also be used in forming the product to be cured.

In certain embodiments, at least one layer of matting may be positioned in a mould tool, the particles may be added to a predetermined level in the mould tool. Thereafter, a resin composition that has a higher viscosity may be infused into the mould tool. Vibration and/or other suitable techniques may be then used to mix and suitably distribute the resin composition and the particles. Thereafter, a second resin composition may be added via infusion or using other suitable ways of addition or combinations thereof. Vibration and/or other suitable techniques may be then used to mix and suitably distribute the resin composition and the particles. Uniform distribution, or substantially uniform distribution, of the resin composition and the particles is desired to the extent it can be achieved. Once the composite is formed it may be cured to form a moulded composite article. Other fillers and/or matting or liners may also be used in forming the product to be cured.

In certain embodiments, at least one layer of matting may be positioned in a mould tool, the particles may be premixed with a thixotropic resin composition that has a higher viscosity than desired and the resin/particles composition added to a mould tool to a predetermined level. And thereafter, the resin/particles composition may be vibrated such that the viscosity of the resin composition is reduced to a suitable level. Vibration and/or other suitable techniques may be used to reduce the viscosity to an acceptable level, mix and suitably distribute the resin composition and the particles. Uniform distribution, or substantially uniform distribution, of the resin composition and the particles is desired to the extent it can be achieved. Once the composite is formed it may be cured to form a moulded composite article. Other fillers may also be used in forming the product to be cured.

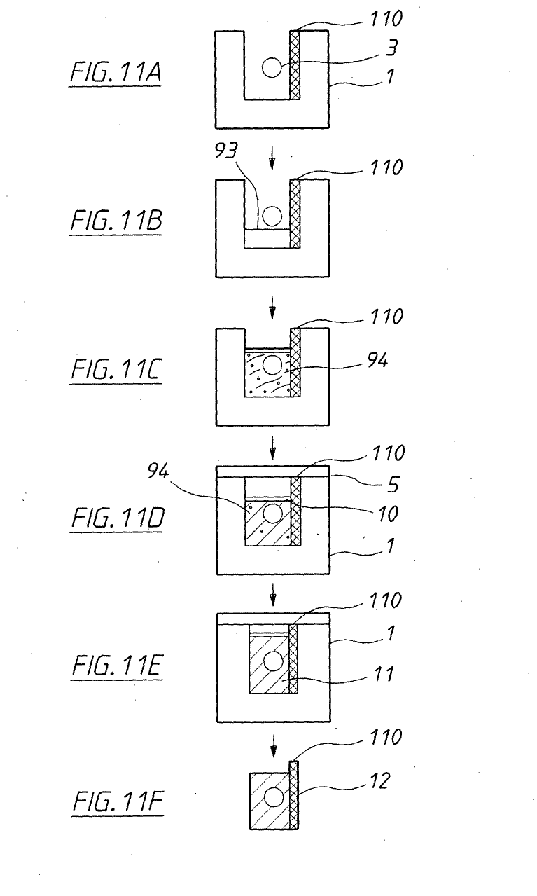

FIGS. 11A to 11F illustrates an exemplary method and/or system, according to certain embodiments and may be used to produce a unitary polymer composite article. In this exemplary embodiment, resin is added to the mould tool before the particle filler is added. The matting may be positioned in the mould tool either before the addition of the resin or after the addition of the resin. FIG. 11A shows a mould (1) is assembled and at least one shaping elements, inserts and/or reinforcements (3) are added. Also shown in FIG. 11A is at least one matting (110) that has been positioned in the mould along at least a portion of interior wall of the mould. In this exemplary embodiment, the matting used may be a single layer of unidirectional woven carbon fibre fabric that is about 0.25 mm thick. However, it is to be understood that other types of matting may be used and the positioning of the at least one matting may be varied in the mould. Not shown here but the desired shaping element may be made of matting material or at least a portion of the desired shaping element may be made of matting material. FIG. 11B shows the resin is mixed, weighed and poured into the mould, to form a pool of liquid resin (93) at the bottom of the tool. The approximate mass of resin can be calculated based on the desired density of the final part and the filler type. FIG. 11C shows the dry filler is gradually added to the resin with, in this example, vibration. The resin starts to mix with the particles and infuse into the matting. The filler is added at a rate that minimizes air entrainment in the resin and the vibration facilitates rapid settling and densification of the filler as well as reducing the amount of air voids (94) entrained within the resin during filling or in the matting during filling. FIG. 11D shows the mould (1) is then sealed with a mould sealing cap (5) and a vacuum is applied to the mould and vibration continued. This step of vacuum vibrocompression aids in the removal of residual air voids (94) in the composite and produces a substantially densified and a sufficiently void free, a substantially void free or a void free moulding. The vibrocompression step may generally induce the formation of a resin rich zone (10) on the top surfaces of the moulding. The composite is then cured as appropriate to the requirements of the resin system. FIG. 11E shows the cured composite (11) in the mould (1) prior to demoulding. FIG. 11F shows the cured composite after demoulding the component may be post-cured if necessary for the resin composition to gain optimum properties and in the final step the resin rich zone and excess filler may be machined to produce the final component (12). A portion of the matting can also be removed, trimmed or further shaped at this step (not shown) or at another stage, for example, prior to post curing, during post curing, after post curing, during final machining, or combinations thereof. The article produced is a unitary polymer composite article or a single casted polymer composite article comprising: a weight percentage of particles; a weight percentage of resin; at least one layer of matting integrally incorporated in the article. Final machining may include balancing and smoothing of seal faces if the component end use requires this, but generally the component will be produced to net shape with the exception of the top surface resin rich zone.

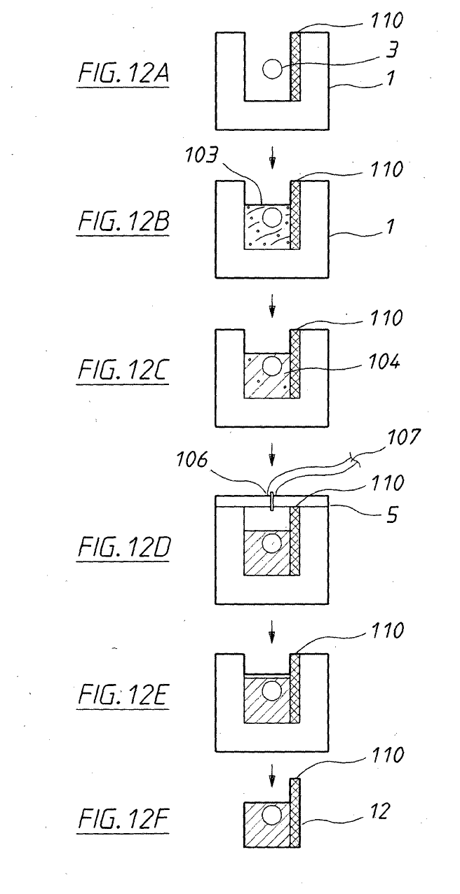

FIGS. 12A to 12F illustrate the use of powdered resin and solid filler, according to certain embodiments to produce a unitary polymer composite article. FIG. 12A shows the empty mould (1) is assembled and shaping elements, inserts or reinforcements (3) are added. Also shown in FIG. 12A is at least one matting (110) that have be position in the mould along at least a portion of interior wall of the mould tool. In this exemplary embodiment, the matting used may be bidirectional carbon fibre twill weave matting consisting of 10 layers of fabric at 0.3 mm thick each. However, it is to be understood that other types of matting may be used and the positioning of the at least one matting may be varied in the mould. Not shown here but the desired shaping element may be made of matting material or at least a portion of the desired shaping element may be made of matting material. FIG. 12B shows a pre-prepared mixture (103) of powdered resin and dry filler is added to mould (1). The powdered resin is a compounded, uncured resin which is a solid at room temperature. FIG. 12C shows the material is briefly vibrocompressed to remove some entrained air voids (104) but vibration intensity and time is carefully applied to prevent segregation of resin and filler. FIG. 12D shows the mould is then sealed with a mould sealing cap (5) fitted with a vacuum port (106) and vacuum line (107) and a vacuum is applied. The filled, evacuated mould is then heated to facilitate liquefaction of the solid resin. Typically the mould is heated to a first temperature to facilitate resin liquefaction then vibrated to densify the filler and liquid resin composition as well as sufficient infusion of the resin into the matting and finally heated to a second, higher temperature to facilitate curing. FIG. 12E shows the mould after the composition has cured, the vacuum is released and the sealing cap is removed. FIG. 12F shows the composite after it is demoulded. A portion of the matting can also be removed, trimmed or further shaped at this step (not shown) or at another stage, for example, prior to post curing, during post curing, after post curing, during final machining, or combinations thereof. The composite may be post-cured if required and machined if required yielding the final composite component (12). The article produced is a unitary polymer composite article comprising: a weight percentage of particles; a weight percentage of resin; at least one layer of matting integrally incorporated in the article. In certain applications, the article is sufficiently void free, substantially void free or a void free of pockets.

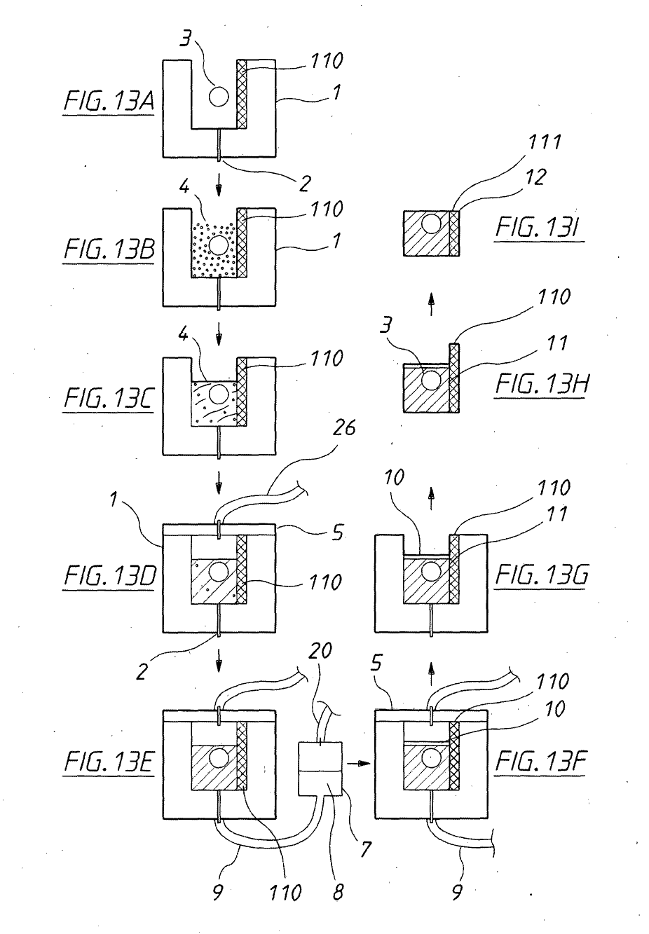

In a variation of the process described in FIGS. 2A to 2I, FIGS. 13A to 13I illustrate a process used to make a moulded composite article that combines pressure infusion and vacuum infusion, according to certain embodiments. This process and/or system may be used to produce a unitary polymer composite article. In this exemplary, the pressure differential may be created by holding the mould tool under vacuum and injecting the resin under a positive pressure. In this embodiment, FIG. 13A illustrates a mould (1) suitable for resin infusion processing featuring a resin infusion port (2) which may be coated with a suitable mould release agent and assembled including optionally shaping elements, inserts and/or reinforcing elements (3) to form the component according to the component design. Also shown in FIG. 13A is at least one matting (110) that has be position in the mould along at least a portion of interior wall of the mould. Not shown here but the desired shaping element may be made of matting material or at least a portion of the desired shaping element may be made of matting material. These shaping elements may also be formed from metal, silicon elastomer, polyurethane elastomer, thermoset plastic, wax, wood, matting or combination of these materials. The shaping elements or inserts may be multi-use items or single use consumables, as suits the component being manufactured. In the case of single use items, these may be destroyed during the demoulding process. Shaping elements and inserts may be coated with a release agent to facilitate easy removal from the cured component. Reinforcing elements may typically, but not exclusively, be cast or fabricated metal elements, prepared and coated with an adhesive compatible with the resin material to be moulded, to facilitate sound bonding within the finished moulding. At this time, it may be desirable to add the sealing cap and connect the tool to vacuum to ensure there are minimum air leaks around the sealing elements prior to addition of moulding materials. In certain applications, it may be possible to use less vacuum due at least in part to the addition of positive pressure. One advantage of combining pressure infusion and vacuum infusion is that the vacuum may not need to be as high. Another advantage of combining pressure infusion and vacuum infusion is that the vacuum leakage may be less of an issue during the moulding process. This may result in less expensive equipment being suitable for the moulding process. This may also result in less expensive set up procedures for the moulding process.

As illustrated in FIG. 13B, to the assembled mould (1) is added the dry particulate filler (4). The filler may or may not be pretreated with a coupling agent and/or surfactant, but in either case it is desirable that the filler be sufficiently dry and free of solvents, water or other liquid materials that may hinder free flow of the solid. Vibration can be advantageously used during and/or immediately after the filling step to ensure the dry filler has sufficiently penetrated the cavities and/or regions of the mould. Vibrations may also further densify the material and/or reduce the volume of entrained air. Vibration is typically maintained only for sufficient time to densify and/or transport the filler, as excessive vibration may cause stratification of the dry filler. FIG. 13C illustrates the densified filler (4) and matting (110) after vibration has ceased.

As illustrated in FIG. 13D, to the mould (1) containing densified filler and matting is added the sealing cap (5) of the mould and the vacuum line (26) is connected to the mould and the tool is placed under a vacuum. The amount of vacuum that is applied may vary depending on the particular application. In addition, the vacuum applied may vary and/or may be adjusted to different levels during the process. In this illustration, the infusion port (2) is sealed, but the resin infusion line may also be connected via a sealable tap fitting, or the infusion line can be directly clamped to facilitate holding of a positive pressure which will be applied on the resin injection line. A bleedable vacuum valve may be attached to the vacuum line to facilitate variation of the vacuum during the process.

As illustrated in FIG. 13E, the resin pot (7) may be attached to the mould via a resin infusion line (9) and to the pot is added premixed resin (8). The resin pot (7) is sealed from the atmosphere and a positive pressure is applied to the resin pot via a pressure inlet line (20). The vacuum in the tool and pressure in the resin pot may be balanced to create a pressure differential which will facilitate transfer of the resin from the higher pressure resin pot (7) to the lower pressure mould (1). Advantageously the resin pot (7) may be suspended at a height above the mould to allow gravity assistance during resin infusion, if desired. However, this may not be needed as the induced pressure differential can overcome gravitational effects. The resin infusion line (9) is then opened and resin (8) is pushed into the tool by the positive pressure. Advantageously, the resin injection pressure can be increased or adjusted during the injection step to maintain a constant flow of resin as the resin front advances through the filler. Pressure can be applied by utilizing a resin injection pump instead of a resin pot, in this method the pneumatic force driving the injection pump controls the amount of pressure applied to the resin in the mould.

As shown in FIG. 13F, the infusion step is ceased when the appropriate volume of resin is added. This can be determined volumetrically by calculating the volume of void space in the mould filled with dry filler and matting, or gravitmetrically by comparing the mass of dried filler and matting to the expected mass of the final component, or visually by continuing the filling step until the top surface of the dry filler has been wetted by the resin and a resin rich zone (10) has formed or combinations thereof. In the case of visual determination, the mould sealing cap (5) may be fabricated from a transparent material and/or feature viewing windows to allow visualization of the dry filler and eventual resin rich zone (10). When the filling step is deemed complete, the resin infusion is stopped by either closing the infusion line tap or clamping the infusion line (9).

As shown in FIG. 13G, after resin infusion is completed and the infusion line is clamped, the tool can optionally be vibrated again to further densify the resin and filler composite (11). Another option is to rotate the tool at least one time by at least 20% and vibrate the tool again to further densify the resin and filler composite. During this densification step the resin rich zone at the top surface (10) of the moulding may increase in thickness due to further settling of the filler. After vibration is removed the, the pressure on the tool and resin pot are released and the resin composition is allowed to cure in the tool. This curing step may occur at room temperature and/or one or more elevated temperatures. As shown in FIG. 13H, the cured composite (11) is removed from the mould and shaping elements and/or inserts (3) are removed from the moulding. In the case of components with reinforcing elements, these elements would remain bonded within or upon the component. A portion of the matting can also be removed, trimmed or further shaped at this step (not shown) or at another stage, for example, prior to post curing, during post curing, after post curing, during final machining, or combinations thereof.

As shown in FIG. 13I, after demoulding the component is post-cured if necessary. One advantage of post-curing is it allows for the resin composition to gain optimum properties and in the final step the resin rich zone and excess of filler is machined to produce the final component (12). Final machining may include balancing and/or smoothing of seal faces if the component end user requires this, but generally the component will be produced to a net shape with the exception of any top surface resin rich zone.

FIG. 13I also shows the matting (111) after a portion of the matting has been removed. The article produced is a unitary polymer composite article comprising: a weight percentage of particles; a weight percentage of resin; at least one layer of matting integrally incorporated in the article. In certain applications, the article is sufficiently void free, substantially void free or a void free of pockets. In such an arrangement with matting located on an external surface of the moulding, the flexural properties can be increased substantially when load is applied in such a way that the fibre mat is on the surface opposite the applied load.

In certain positive pressure and vacuum embodiments, the resin pot can advantageously be complemented with a piece of equipment designed for injecting resins or other liquid under elevated pressures. For example, a piston injection pump can be installed in the injection line between the tool and the resin pot to apply a positive pressure to the resin injection. Such a piston pump can either be pneumatically fed resin through pumps and tubing from resin storage and/or fed directly from a resin pot either under gravity feed or using a small positive pressure in the resin pot. This advantageously allows the creation of a sealed system of resin transfer from resin storage to infusion. In certain embodiments, the piston pump and resin pot can be replaced with a multi-component static mixer incorporated into a piston injection system. In this system, a multitude of piston pumps transport the resin through the static mixer at suitable injection pressures and from the static mixer, the mixed resin may be introduced either directly and/or indirectly into the tool.

The pressures and vacuum levels used for a combined vacuum/positive pressure system may vary. In certain embodiments, the mould may be placed under a vacuum of at least 150 mbar or at least 50 mbar and the resin infusion may begin solely under the force of vacuum to mitigate the amount of resin wash that occurs. After a small amount of resin has been introduced, the pressure can be increased gradually during the infusion to facilitate a continuous resin infusion speed. In certain applications, the final injection pressure will reach at least 20 psi, but at least 35 psi may also be used. In certain applications, final injection pressures of at least 100 psi may be used. In certain embodiments the resin infusion may begin solely under one or more of the following: vacuum, pressure, and vacuum and pressure. In certain embodiments, the mould may be placed under a vacuum of at least 150 mbar or at least 50 mbar and the resin infusion will begin solely under the force of vacuum to mitigate the amount of resin wash that occurs.

In certain embodiments, for at least a portion of the resin infusion process the mould tool may be placed under a vacuum of between 15 mbar to 500 mbar, 50 mbar to 150 mbar, 100 mbar to 400 mbar, 75 mbar to 175 mbar, 20 mbar to 60 mbar 150 mbar or 200 mbar to 800 mbar and the injection pressure may be one or more of the following: kept substantial constant, increased gradually, increased in steps, increased and decreased gradually, and increased and decreased in steps to pressures of between 1 psi to 2000 psi, 5 psi to 20 psi, 5 psi to 35 psi, 5 psi to 100 psi, 5 psi to 100 psi, 15 psi to 25 psi, 30 psi to 40 psi, 5 psi to 1000 psi, 5 psi to 500 psi or other suitable pressure ranges. In certain embodiments, the infusion of the resin composition into the mould tool under pressure may be carried out by using at least 1, 2, 3, 4, 5 or 6 resin infusion ports or infusion points to the mould, wherein during at least a portion of the resin infusion process the mould may be placed under a vacuum of between 15 mbar to 500 mbar, 50 mbar to 150 mbar, 100 mbar to 400 mbar, 75 mbar to 175 mbar, 20 mbar to 60 mbar 150 mbar, or 200 mbar to 800 mbar and the injection pressure may one or more of the following: be kept substantial constant, increased gradually, increased in steps, increased and decreased gradually, or increased and decreased in steps to pressures of between 1 psi to 2000 psi, 5 psi to 20 psi, 5 psi to 35 psi, 5 psi to 100 psi, 5 psi to 100 psi, 15 psi to 25 psi, 30 psi to 40 psi, 5 psi to 1000 psi, 5 psi to 500 psi or other suitable pressure ranges.

FIGS. 14A to 14I illustrate a process used to make a moulded composite article that combines pressure infusion and vacuum infusion, according to certain embodiments. This process and/or system may be used to produce a unitary polymer composite article. In this exemplary embodiment, the at least one matting (110) is positioned over the injection port (2) as shown in the figures. In certain, embodiments, the at least one matting may be placed over the infusion port, on the infusion port opening, near the infusion opening, at least partial in the infusion port opening, in the infusion port opening, in close proximity to the infusion port opening or combinations thereof and this positioning of the at least one matting may permit faster infusion of the resin into the matting as discussed herein. The position of the matting as illustrated in FIGS. 14A to 14I may also be used with other infusions processes disclosed herein. For example, one or more of the following: vacuum infusion, infusion under pressure, infusion under combined vacuum and pressure, and infusion at atmospheric pressure.

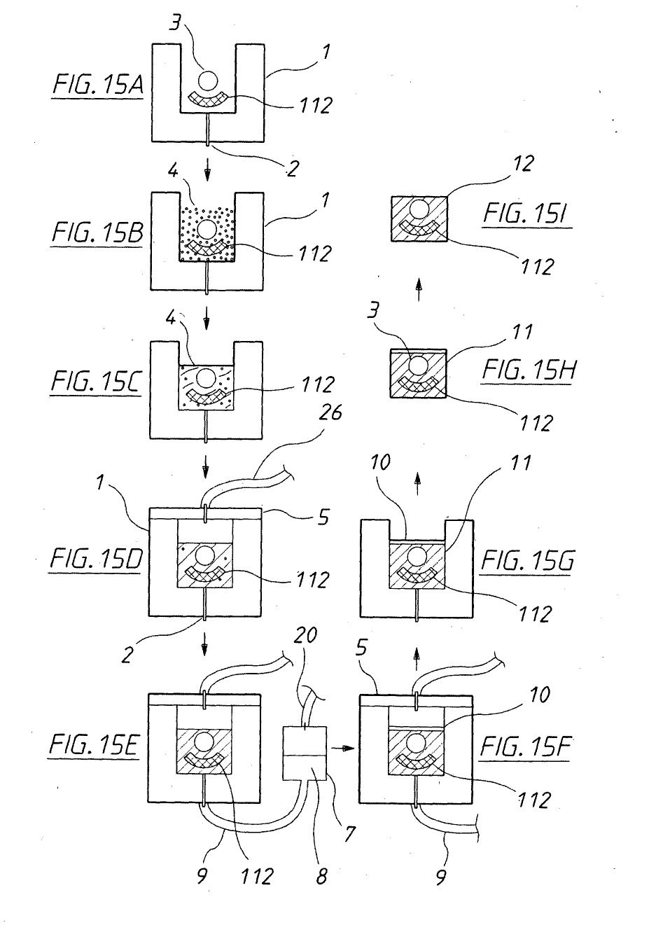

FIGS. 15A to 15I illustrate a process used to make a moulded composite article that combines pressure infusion and vacuum infusion, according to certain embodiments. This process and/or system may be used to produce a unitary polymer composite article. In this exemplary embodiment, the at least one matting (112) is positioned in the internal portion of the mould as shown in the figures and the matting is in the form of a stiffened preform. As disclosed herein, the shape of the at least one matting may vary depending on the particular application of the article. The position of the matting in the mould as illustrated in FIGS. 15A to 15I may be also used with other infusions processes disclosed herein. The matting may be held in position by attaching shims or dowels which contact the mould surface or reinforcements in the mould, in combination with the stiffened matting this serves to hold the preform in position during particulate filling and resin infusion. Alternatively, the preform or fabric can be secured by attachment to an internal reinforcement and/or insert or even suspended from a surface of the mould using wires, strings and/or filaments to secure it in the appropriate position. For example, one or more of the following: vacuum infusion, infusion under pressure, infusion under combined vacuum and pressure, and infusion at atmospheric pressure.

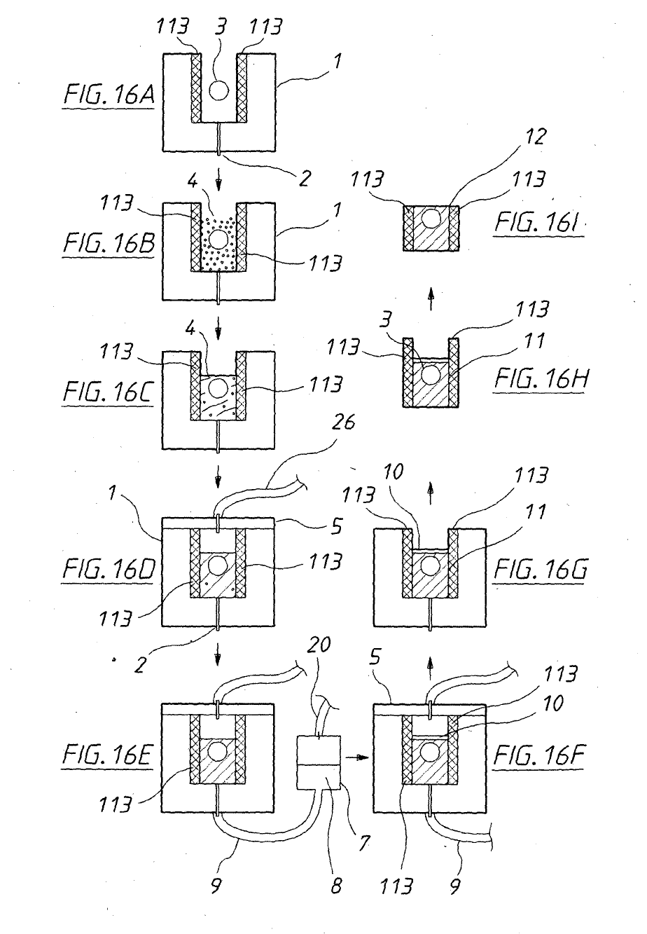

FIGS. 16A to 16I illustrate a process used to make a moulded composite article that combines pressure infusion and vacuum infusion, according to certain embodiments. This process and/or system may be used to produce a unitary polymer composite article. In this exemplary embodiment, the at least one matting (113) is position in the mould along a sufficient portion of the interior wall of the mould such that it is illustrated as being shown on two opposite side. In certain applications, there are at least two separate pieces of matting. In certain applications, the matting covers at least 180 degrees of the interior wall of the moulding tool. The shape of the at least one matting may vary depending on the particular application of the article. The position of the matting in the mould as illustrated in FIGS. 16A to 16I may be also used with other infusions processes disclosed herein. For example, one or more of the following: vacuum infusion, infusion under pressure, infusion under combined vacuum and pressure, and infusion at atmospheric pressure.

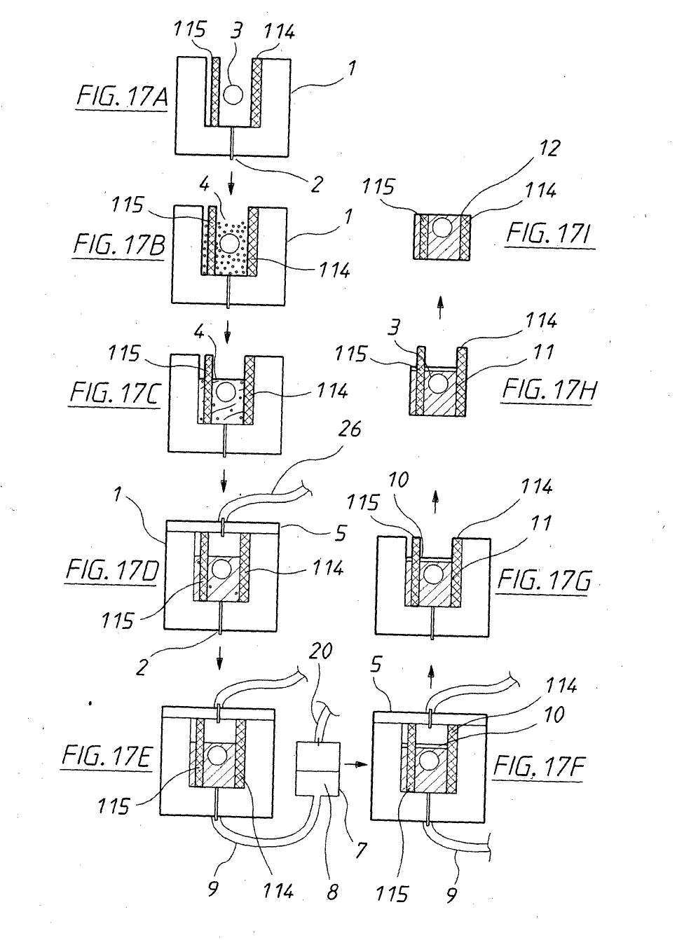

FIGS. 17A to 17I illustrate a process used to make a moulded composite article that combines pressure infusion and vacuum infusion, according to certain embodiments. This process and/or system may be used to produce a unitary polymer composite article. In this exemplary embodiment, a first at least one matting (114) is position in the mould along the interior wall of the mould and a second at least one matting (115) is positioned in the mould interior. The shape and/or positioning of the first at least one matting and/or the second at least one matting may vary depending on the particular application of the article being produced. The matting (114) and (115) illustrated in FIGS. 16A to 16I may be also used with other infusions processes disclosed herein. For example, one or more of the following: vacuum infusion, infusion under pressure, infusion under combined vacuum and pressure, and infusion at atmospheric pressure.

FIGS. 18A to 18K illustrate a process used to make a moulded composite article that combines pressure infusion and vacuum infusion, according to certain embodiments. This process and/or system may be used to produce a unitary polymer composite article. In this exemplary embodiment, the at least one matting (140) is positioned over the injection port (2) as shown in the FIG. 18B. In certain embodiments, the at least one matting may be place over the infusion port, on the infusion port opening, near the infusion opening, at least partial in the infusion port opening, in the infusion port opening, in close proximity to the infusion port opening or combinations thereof and this positioning of the at least one matting may permit faster infusion of the resin into the matting as discussed herein. In certain embodiments, the infusion port may be alternatively covered by a first layer of particles and then a first layer of matting positioned over the first layer of particles.

After the mould is assembled, some dry particulate filler (141) may be added to the mould. This is illustrated in FIG. 18B. Vibration may be used during and/or after the filling step to ensure the dry filler has sufficiently penetrated the cavities and/or regions of the mould. Vibration may also be used to further densify the filler material and/or reduce the volume of entrained air. Vibration is typically maintained for a sufficient time period to densify and/or transport the filler material. FIG. 18D illustrates the densified filler (141) and matting (140) after vibration is ceased. In FIG. 18E another layer of matting (142) is positioned in the mould tool and the process of adding additional dry particulate filler (143) to the mould tool and vibrating the particulates added is repeated as shown in FIGS. 18F and 18G. Another layer of matting is positioned in the mould as shown in FIG. 18H.

As illustrated in FIG. 181E, the resin pot (7) may be attached to the mould via a resin infusion line (9) and to the pot is added premixed resin (8). The resin pot (7) is sealed from the atmosphere and a positive pressure is applied to the resin pot via a pressure inlet line (20). The vacuum in the tool and pressure in the resin pot may be balanced to create a pressure differential which will facilitate transfer of the resin from the higher pressure resin pot (7) to the lower pressure mould (1). The resin infusion line (9) is then opened and resin (8) is pushed into the tool by the positive pressure. Advantageously, the resin injection pressure can be increased or adjusted during the injection step to maintain a constant flow of resin as the resin front advances through the filler.

When the filling step is deemed complete, the resin infusion is stopped by either closing the infusion line tap if one is in use, or clamping the infusion line (9). As illustrated in FIG. 18JG, after resin infusion is completed and the infusion line is clamped, the tool can optionally be vibrated again to further densify the resin, matting and filler composite. After vibration is removed, the vacuum on the tool is released and the resin composition is allowed to cure in the tool. As illustrated in FIG. 18K, the cured composite (144) is removed from the mould and as with other embodiments disclosed herein post-curing and final machining may be performed, if desired. The process used in FIGS. 18A to 18K may be used with one or more of the following: vacuum infusion, infusion under pressure, and infusion under combined vacuum and pressure. The article produced is a unitary polymer composite article comprising: a weight percentage of particles; a weight percentage of resin; at least one layer of matting integrally incorporated in the article. In certain application, the article is sufficiently void free, substantially void free or void free.

In certain embodiments where the matting is to be included as an internal matting element in the article, different techniques can be used to hold the matting in the desired position. FIGS. 19A to 19C illustrate and exemplary schematic of a method of positioning the internal matting element. FIG. 19A shows a preformed matting element (120) to which four shims have been attached (121, 122, 123, and 124). The placement of the shims may be varied depending on the design of the mould and/or the article to be moulded. FIG. 19B shows in cross section the matting element with the shims being positioned in the interior of the mould. In this embodiment, the mould is made up of two parts (127a, 127b). In FIG. 19B, the mould cavity (129) is shown with no resin and/or particles yet added. After the matting element has been positions and the mould made ready, the mould may be filled with resin and particles and casting may be carried out using one or more of the embodiments disclosed here. FIG. 19C shows in a sliced cross section what the article would look like after casting has been completed and the mould removed. In this sliced cross section the matting element is positioned in the interior of the mould article and the shims are still present in the casted article.

FIGS. 20A and 20B illustrates an exemplary a unitary polymer composite article or a single casted polymer composite article, according to certain embodiments. FIG. 20A shows a side view of a hydrocyclone (135) with a flange (131). The unitary hydrocyclone illustrated may be made in a single casting. The exterior portion of the wall of the hydrocyclone is substantially made up of shaped resin infused matting (130). As can be seen in FIG. 20B, a perspective view of the hydrocyclone, the interior portion of the wall surface of the hydrocyclone is substantially made up of a layer of resin and particles composite (134). The outer layer of resin infused matting (132) and the inner layer resin and particles composite (133) can also be seen in FIG. 20B. Also shown in FIG. 20B are the bolts holes (136) located on upper surface of the flange (131). Using one or more of the embodiments disclosed herein, the entire cyclone or a substantial portion of the cyclone may be fabricated as a composite of matting, particle and resin.

The methods, method steps and/or systems disclosed herein are not intended to be limiting as to the embodiments disclosed. In addition, limitations of one embodiment may be combined with limitations of other embodiments to form additional embodiments.

In certain embodiments, post cure touch up and reworking may also be performed if desired and/or required. Additional curing may also be performed, if needed, by placing the cured item in an oven and curing at a suitable temperature for a period of time. For example, additional curing may be performed in an oven at a temperature of between 90° C. to 140° C. over a time period of between 2 hours to 6 hours. Other suitable temperatures and time periods may also be used. The temperature and/or time period selected may depend on the components used to form the article and/or its proposed use.

In certain embodiments, a moulded composite article comprising a substantial portion of the Silicon carbide particles having a Mohs hardness of greater than 7 and matting and the article comprising at least between 10% to 50% by weight of the resin composition and between 50% to 90% by weight of the Silicon carbide particles can be further cured in an oven at 120° C. for approximately 4 hours. The percentages of the particles and resin composition that may be found in the composite may vary. In certain embodiments, the composite comprises between 10% to 50% by weight of the resin composition and between 50% to 90% by weight of the particles. In other embodiments, the composite comprises between 20% to 30% by weight of the resin composition and between 70% to 80% by weight of the particles. In certain embodiments, the resin composition comprises approximately 10% to 50%, 20% to 25%, 20% to 30%, 25% to 35%, 30% to 45% or 40% to 55% by weight of the total weight of the composite. In certain embodiments, the particles comprise approximately 90% to 50%, 80% to 75%, 80% to 70%, 75% to 65%, 70% to 55% or 60% to 45% by weight of the total weight of the composite. In addition, other components may be present in the composite. For example, chopped glass fibre, chopped or milled carbon fibre, microspheres, or combinations thereof can be used up to 3%, 5%, 7% or 10% by weight. Hollow microspheres can be used up to 30%, 40%, 50% or 60% by volume (the by weight will change based on density of microspheres). These materials may be used to displace the filler, but typically not the resin.

The percentages of the particles and the resin composition that may be found in the moulded composite article may vary. In certain embodiments, the moulded composite article comprises between 10% to 50% by weight of the resin composition and between 50% to 90% by weight of the particles. In other embodiments, the moulded composite article comprises between 20% to 30% by weight of the resin composition and between 70% to 80% by weight of the particles. In certain embodiments, the resin composition comprises approximately 10% to 50%, 20% to 25%, 20% to 30%, 25% to 35%, 30% to 45% or 40% to 55% by weight of the total weight of the moulded composite article. In certain embodiments, the particles comprise approximately 90% to 50%, 80% to 75%, 80% to 70%, 75% to 65%, 70% to 55% or 60% to 45% by weight of the total weight of the moulded composite article. In addition, other components may be present in the composite article. For example, chopped glass fibre, chopped or milled carbon fibre, microspheres, or combinations thereof can be used up to 3%, 5%, 7% or 10% by weight. Hollow microspheres can be used up to 30%, 40%, 50% or 60% by volume (the by weight will change based on density of microspheres). These materials may be used to displace the filler, but typically not the resin. In certain embodiments, the composite comprises between 15 to 30% by weight of the resin composition and between 70 to 85% by weight of the silicon carbide particles. In certain embodiments the moulded composite article comprises between 15 to 30% by weight of the resin composition and between 70 to 85% by weight of the silicon carbide particles. The weight percentages of the particles and resin composition disclosed herein may be combined with other physical properties of the composite articles disclosed herein.

In certain embodiments, the at least one layer of matting is at least 0.1%, 0.5%, 1%, 5%, 10%, 20%, or 30% by volume of the total volume of the unitary polymer composite article. In certain embodiments, the at least one layer of matting is between 0.1% to 30%, 0.5% to 30%, 1% to 20%, or 5% to 20% by volume of the total volume of the unitary polymer composite article. Other % volume amounts may also be used. In certain embodiments, the at least one layer of matting is at least 0.1%, 0.5%, 1%, 5%, 10%, or 20% by weight of the total weight of the unitary polymer composite article. In certain embodiments, the at least one layer of matting is between 0.1% to 20%, 0.5% to 20%, 1% to 10%, 5% to 20%, or 10% to 20% by weight of the total weight of the unitary polymer composite. Other % weights amounts may also be used. The amount of matting that may be present in the composite article may vary; the % weights and the % volumes disclosed herein may be combined with the other properties of the composite articles disclosed herein.

### Moulded Composite Article

Various moulded composite articles are produced using the methods and/or systems disclosed herein. In certain applications, these unitary polymer composite articles are suitable for use either alone or in combination with other components in mechanical equipment, for example, pumps, and are particular useful in highly corrosion and/or wear-resistant environments. Some non-limiting examples are ceramic type pumps, components of ceramic type pumps, other mechanical equipment, and/or parts for mechanical equipment. In certain applications, the unitary polymer composite articles produced may be pumps, pump components, preforms and/or other components, these articles may be combined with, or used in conjunction with, other pumps, pump components, and/or parts produced using other methods, for example, slurry casting to produce the desired equipment. The unitary polymer composites disclosed herein may be used in the mining industry, the chemical industry, flue gas desulphurization, for example in power generation, desalination and/or other fields of use and are particular are useful for highly corrosion and/or wear-resistant environments.

As used herein, a unitary polymer composite article may have several different definitions. In certain embodiments, a unitary polymer composite article may be defined as an article comprising: resin, particles and matting, wherein the matting is infused, substantially infused or sufficiently infused with the resin and the unitary article is formed during in the mould process. This may include, in certain applications, a portion of the matting being only substantially infused or sufficiently infused with the resin. In certain applications, the unitary polymer composite article produced may be sufficiently void, substantially void or void of air pockets. This is in contrast to a manufacturing process where, for example, slurry casting is used to form a portion of the article and another portion of the article, such as the matting, is formed separately and the two portions of the article are combined together by, for example gluing. In certain embodiments, a unitary polymer composite article may be defined as an article comprising: resin, particles and matting, a mould tool containing the polymer/matting/resin composite is vibrated for a portion of time at one or more of the following stages: during the filling with the particles, after the filling with particles, during the infusing of the resin composition and after the infusion of the resin composition. In certain applications, the unitary polymer composite article produced may be sufficiently void, substantially void or void of air pockets. In certain embodiments, a unitary polymer composite article may be defined as an article comprising: resin, particles and matting, wherein the article is produced in a single moulding or casting process.

The composite articles have applications in a variety of fields such as mining, chemical industry, flue gas desulphurization, desalination or other fields. In certain embodiments, the physical and chemical properties disclosed herein may be combined in various combinations.

In certain embodiments, the unitary polymer composite article produced has a flexural strength of at least 20, 25, 30, 40, 50, 55 or 60 MPa. In certain embodiments, the flexural strength of the articles produced is between 25 to 60 MPa, 30 to 55 MPa, 40 to 55 MPa, 50 to 60 MPa or other suitable flexural strengths. In certain embodiments, the cured resin composite has a flexural strength of at least 20, 25, 30, 40, 50, 55 or 60 MPa. In certain embodiments, the flexural strength of the cured resin composition is between 30 to 55 MPa, 25 to 40 MPa, 30 to 50 MPa, 25 to 60 MPa or other suitable flexural strengths.

In certain embodiments, the unitary polymer composite article produced has a tensile strength of at least 5, 10, 15, 20 or 30 MPa. In certain embodiments, the tensile strength of the article produced is between 5 to 15 MPa, 10 to 30 MPa, 5 to 25 MPa, 15 to 30 MPa or other suitable tensile strengths. In certain embodiments, the cured resin composition has a tensile strength of at least 15, 30, 50, 70 or 100 MPa. In certain embodiments, the tensile strength of the cured resin composition is between 15 to 100 MPa, 30 to 100 MPa, 15 to 70 MPa, 50 to 100 MPa or other suitable tensile strengths.

In certain embodiments, the unitary polymer composite article produced has a glass transition temperature of at least 90° C., 100° C., 110° C., 115° C., or 120° C. In certain embodiments, the cured resin composition has a glass transition temperature of at least 90° C., 100° C., 110° C., 115° C., or 120° C.

In certain embodiments, the unitary polymer composite article produced is substantially uniform in dispersion of the particles within the resin matrix. Air pockets are substantially eliminated. The distribution of particles is substantially uniform and resin rich zones are substantially eliminated. This results in a substantially consistent density in the cured product. Density of the cured composite article may be between 2 to 3 g/cc, 2.2 to 2.8 g/cc or 2.4 to 2.7 g/cc. Other densities ranges and/or some density variation may be found in the cured product of certain embodiments.

In certain embodiments, the article produced is sufficiently void, substantially void or void free of air pockets. In certain applications, void free of air pockets may be determined by cutting open a portion of the article produced and visually inspecting for air pockets or holes. If the upon visually inspecting without magnification a 5 cm squared surface area of the cut open article has less than 10%, 8%, 6%, 5%, 3%, 2% or 1% of that surface area made up of air pockets, then in certain applications the article produced may be considered void free. In certain embodiments, sufficiently void of air pockets may be determined by cutting open a portion of the article produced and visually inspecting for air pockets or holes. If the upon visually inspecting without magnification a 5 cm squared surface area of the cut open article has less than 40%, 35%, 25%, or 20%, of that surface area made up of air pockets, then in certain applications the article produced may be considered sufficiently void free. Reducing the number of air pockets is one advantage of certain embodiments.

In certain embodiments, the unitary polymer composite article produced has a suitable wear resistance. In certain applications, wear resistance may be defined by performance is the flue gas desulfurization application, where this material would be considered erosion and/or corrosion resistant. Typical application life span may be above 15,000 hours of use and as high at 100,000 hours of use or higher. In certain embodiments, wear resistance may be defined as wherein the material produced has a life span of between 10,000 to 200,000 hours of use, 15,000 to 100,000 hours of use, 15,000 to 60,000 hours of use, 25,000 to 100,000 hours of use or 40,000 to 80,000 hours of use. Typical lifespan for rubber or metals may be 5000 to 30,000 hours under normal conditions. In certain embodiments, wear resistance may be defined as wherein the material produced has a life span of between 3,000 to 40,000 hours of use, 5,000 to 30,000 hours of use, 10,000 to 30,000 hours of use or 15,000 to 25,000 hours of use. In certain embodiments, the article produced has a suitable acid resistance. In certain embodiments, the article produced has a suitable chemical resistance. In certain embodiments, the article produced has one or more of the following properties: a suitable wear resistance, a suitable acid resistance, and a suitable chemical resistance. In certain embodiments, the article produced has a suitable wear resistance, a suitable acid resistance, and/or a suitable chemical resistance wherein the material produced has a life span of between 5,000 to 30,000 hours of use, 15,000 to 200,000 hours of use, 5,000 to 20,000 hours of use, 15,000 to 100,000 hours of use, 25,000 to 100,000 hours of use or 40,000 to 80,000 hours of use.

It is to be understood that the physical property ranges disclosed herein can be combined in various combinations. For example, certain disclosed embodiments are directed methods and systems that produce a unitary polymer composite article that has a flexural strength of between 30 to 150 MPa, a tensile strength of between 15 and 120 MPa and a glass transition temperate of at least 110° C. Certain disclosed embodiments are directed methods and systems that produce a unitary polymer composite article that has one or more of the following properties: a flexural strength of at least 30 MPa, a tensile strength of between 20 and 50 MPa and a glass transition temperate of at least 110° C. Another example is a method and/or system that produces a moulded composite article comprising a substantial portion of the Silicon carbide particles have a Mohs hardness of greater than 7 and the article comprising at least between 10% to 50% by weight of the resin composition and between 50% to 90% of the Silicon carbide particles, wherein the article produced has one or more of the following properties: a flexural strength of between 50 to 80 MPa, a tensile strength of between 20 and 50 MPa, a glass transition temperate of at least 110° C., suitable wear resistance, suitable acid resistance, and suitable chemical resistance.

For example, certain disclosed embodiments are directed to a unitary polymer composite article that has a flexural strength of at least 100 MPa, a tensile strength of between 20 and 80 MPa and a glass transition temperate of at least 110° C. For example, certain disclosed embodiments are directed to an article that has a flexural strength of between 30 to 55 MPa, a tensile strength of between 20 and 50 MPa and a glass transition temperate of at least 110° C.

### EXAMPLES

Example 1, two SiC blend, vacuum infusion and 80° C. curing: In the following example a moulded composite article is prepared using Silicon carbide particles. The final articles contained approximately 75% by weight Silicon carbide particles and approximately 25% by weight Polymer. The polymer/resin composition contains:

100 parts by weight Daron 45 vinyl ester urethane hybrid polymer;

35 parts by weight polymeric methylene diphenyl isocyanate (MDI);

2 parts by weight peroxide catalyst; and

5 parts by weight zeolite molecular sieve.

The process of manufacture involves the following steps (see FIG. 1 for a schematic of the manufacturing process):

1. Resin: Part A and Part B resin mixtures are prepared:

Part A contains the 100 parts of a vinylester hybrid polymer and 5 parts zeolites sieves and
Part B contains 35 parts of polymeric methylene diphenyl isocyanate and 2 parts of peroxide catalyst. Part A and Part B resin mixtures were carried out in a flask fitted with a mechanical stirrer. Approximately 1 kg is prepared for this example.

2. Silane treated Silicon carbide preparation: In this example, the Silicon carbide used is a mixture of two different grade sizes (between 50 μm and 1 mm) and is prepared as follows. One kilogram of Silicon carbide (24 mesh) was added to a solution of 30 grams of an alkyl silane in 450 mL absolute Ethanol. The 24 mesh screened Silicone carbide is made up particles that are around 750 μm in size or smaller. The alkyl silane is selected so that it will be reactive with the above resin composition. Here the alkyl silane is 3-methacryloxypropyltrimethoxysilane (3-MPS). The mixture is stirred to ensure particles are fully wetted and then allowed to stand at room temperature for about one hour. The mixture is filtered using a vacuum filter flask and Buchner funnel and the residue was washed with ethanol, and then dried under a vacuum of around 20 mbar to yield the final silane treated SiC. This procedure was repeated for 46 mesh screened Silicon carbide particles to provide a similar amount of 200 μm size SiC particles.

3. The selected grades of silane treated Silicon carbide are dry blended prior to use. In this example the blend is a 70:30 mix of 750 μm:200 μm.

4. A piece of matting approximately 0.75 mm thick in total and 20 cm×8 cm in size consisting of 3 layers of carbon fibre twill woven fabric bonded together with spray adhesive is positioned in the mould. The matting used here is a carbon fibre twill woven fabric and contains carbon fiber. The matting is placed in the desired position within a mould tool and secured as needed.

5. The mould tool is filled with the above blend of the treated Silicon carbide grains. During particle filling the mould is vibrated at a vibration rate of between 100 to 10,000 Hz and vibration continues for up to one minute after filling is completed to facilitate packing of the particles and even flow of the particles into geometries of the mould. Compressed air may is also used, if needed, to fluidize the granular material during filling, particularly when filling complex geometries.

6. A resin infusion hose is attached to the mould at one or several filling points on the bottom of the tool and the particle filled and vibro-compacted mould is then sealed and placed under a vacuum of less than 100 mbar. The mould tool is either a vacuum sealable tool itself or is placed in a vacuum chamber or even a sealed bag attached to vacuum as is commonly known in the composite industry as “vacuum bagging.” Vacuum filling allows for resin faster filling of the tool and also reduces the likelihood of air entrapment during infusion.

7. A heat curable, two component resin material is then mixed through a static mixer and dispensed into a resin pot attached to the other end of the infusion hose. A tap is opened on the infusion hose to allow resin to be induced into the tool under the pull of the vacuum. The resin is allowed to infuse through the matting and particles and fill the tool. After filling, the tool is again vibro-compacted for a period of up to 5 minutes to ensure maximum densification and to mitigate against any “resin wash” where particles are washed away from the injection port by resin flow resulting in a resin rich zone.

8. Following this the mould tool is removed from vibration and vacuum and placed in an oven to cure the unitary polymer composite. Here in this example curing is achieved by simply heating to 80° C. and holding for 4 hours. After curing, the unitary polymer composite article is removed from the tool.

9. Post cure touch up and reworking of the article is performed as needed.

10. Additional annealing of the article is performed, if needed, by placing the cured item in an oven and curing at a temperature of over 120° C. for 4 hours with no vacuum.

The resulting unitary polymer composite article had the following properties: flexural strength of 110 MPa, flexural modulus of 15000 MPa, and tensile strength of 25 MPa.

Example 2, five particles size SiC blend, vacuum infusion and 80° C. curing: In the following example a moulded composite article is prepared using five different sizes of Silicon carbide particles. The final articles contained approximately 75% by weight Silicon carbide particles and approximately 25% by weight Polymer as well as a portion of matting. The polymer/resin composition contains

100 parts by weight Daron 45 vinyl ester urethane hybrid polymer

35 parts by weight polymeric methylene diphenyl isocyanate (MDI)

2 parts by weight peroxide catalyst

5 parts by weight zeolite molecular sieve

The process of manufacture involves the following steps (see FIG. 1 for a schematic of the manufacturing process):

1. Resin: Part A and Part B resin mixtures are prepared:

Part A contains the 100 parts of a vinylester hybrid polymer and 5 parts zeolites sieves and
Part B contains 35 parts of polymeric methylene diphenyl isocyanate and 2 parts of peroxide catalyst. Part A and Part B resin mixtures were carried out in a flask fitted with a mechanical stirrer. Approximately 1 kg is prepared for this example.

2. Silane treated Silicon carbide preparation: In this example, the Silicon carbide used is a mixture of five different grade sizes and is prepared as follows. One kilogram of Silicon carbide (24 mesh) was added to a solution of 30 grams of an alkyl silane in 450 mL absolute Ethanol. The 24 mesh screened Silicone carbide is made up particles that are around 750 μm in size or smaller. The alkyl silane is selected so that it will be reactive with the above resin composition. Here the alkyl silane is 3-methacryloxypropyltrimethoxysilane (3-MPS). The mixture is stirred to ensure particles are fully wetted and then allowed to stand at room temperature for about one hour. The mixture is filtered using a vacuum flask and filter funnel and the residue was washed with ethanol, and then dried under a vacuum of around 20 mbar to yield the final silane treated SiC. This procedure was repeated for other sizes of screened Silicon carbide particles to provide a similar amount of 1 mm, 750 μm, 500 μm, 250 μm and 100 μm grade size SiC particles. For the 100 mesh (150 μm grade size) material, the suspension was stirred mechanically for one hour rather than allowed to stand, to ensure that the particles were fully wetted and able to react with the silane due to the reduced ability of the solvent the permeate the mass.

3. The five grades of silane treated Silicon carbide are dry blended prior to use. Here the a blend of treated SiC grades is one part by weight 1 mm, one part by weight 750 μm, one part by weight 500 μm, one part by weight 250 μm and one part by weight 100 μm.

4. A layer of matting approximately 0.25 mm thick in total and 20 cm×8 cm in size consisting of 1 layer of non-woven E glass fibre fabric is positioned in a mould tool. The matting used here is a non-woven E glass fibre and contains glass fiber. The matting is placed in the desired position within the mould tool and secured as needed.

5. The mould tool is filled with the above blend of the treated Silicon carbide grains. During particle filling the mould is vibrated at a vibration rate of between 100 to 10,000 Hz and vibration continues for up to one minute after filling is completed to facilitate packing of the particles and even flow of the particles into geometries of the mould. Compressed air may is also used, if needed, to fluidize the granular material during filling, particularly when filling complex geometries.

6. A resin infusion hose is attached to the mould at one or several filling points on the bottom of the tool and the particle filled and vibro-compacted mould is then sealed and placed under a vacuum of less than 100 mbar. The mould tool is either be a vacuum sealable tool itself or is placed in a vacuum chamber or even a sealed bag attached to vacuum as is commonly known in the composite industry as “vacuum bagging.” Vacuum filling allows for resin faster filling of the tool and also reduces the likelihood of air entrapment during infusion.

7. A heat curable, two component resin material is then mixed through a static mixer and dispensed into a resin pot attached to the other end of the infusion hose. A tap is opened on the infusion hose to allow resin to be induced into the tool under the pull of the vacuum. The resin is allowed to infuse through the particles and matting and fill the tool. After filling, the tool is again vibro-compacted for a period of up to 5 minutes to ensure maximum densification and to mitigate against any “resin wash” where particles are washed away from the injection port by resin flow resulting in a resin rich zone.

8. Following this, the tool is removed from vibration and vacuum and placed in an oven to cure the unitary polymer composite or the single casted polymer composite. Here in this example curing is achieved by simply heating to 80° C. and holding for 4 hours. After curing, the unitary polymer composite article or the single casted polymer composite article is removed from the tool.

9. Post cure touch up and reworking of the article is performed as needed.

10. Additional annealing of the article is performed, if needed, by placing the cured item in an oven and curing at a temperature of over 120° C. for about 4 hours with no vacuum.

The resulting unitary polymer composite article had the following properties: flexural strength of 65 MPa, flexural modulus of 12500 MPa, and tensile strength of 22 MPa.

Example 3, two SiC blend, matting, vacuum infusion and Ramp curing: Here the polymer composite is prepared as in Example 1, however was curing was carried using a temperature ramp in the process. The filled mould tool is first heated to a lower temperature of 50° C. for two hours followed by increasing to 60° C. and finally 80° C. for a minimum of one hour hold at each of these temperatures. The resulting unitary polymer composite article had the following properties: flexural strength of 58 MPa, flexural modulus of 14000 MPa, and tensile strength of 34 MPa.

Example 4 five particles size SiC blend, vacuum infusion and Ramp curing: Here the polymer composite is prepared as in Example 2, however, firing was curing was carried using a temperature ramp in the process. The filled tool is first heated to a lower temperature of 50° C. for two hours followed by increasing to 60° C. and finally 80° C. for a minimum of one hour hold at each of these temperatures. The resulting unitary polymer composite article had the following properties: flexural strength of 122 MPa, flexural modulus of 12700 MPa, and tensile strength of 29 MPa.

Example 5, two particle size SiC blend, matting, vacuum infusion and 80° C. curing: In this example, the Siliconcarbide blend used was the same as that in Example 1, however, in this case the Silicon carbide had been treated with the silane Silquest® A1100, gamma-aminopropyltriethoxysilane according to the method described in example 1. And the article was made up of approximately 75% by weight Silicon carbide particles and approximately 25% by weight Polymer, as well as a portion of matting. However, the polymer/resin composition used in this example was a two part infusion grade epoxy resin and hardener system Epolam 2035, with a viscosity preferably less than 1000 cps, and optimally less than 500 cps. To prepare the resin compositions Part A and Part B resin mixtures are prepared as follows: Part A contains the 100 parts of a vinylester hybrid polymer and 5 parts zeolites sieves and Part B contains 35 parts of polymeric methylene diphenyl isocyanate and 2 parts of peroxide catalyst. Part A and Part B are commercially available materials. Part A contains 100 parts of an infusion grade epoxy resin with glass transition temperature above 120° C. Parts B contains an amine hardener matched to the epoxy resin in Part A. The resulting unitary polymer composite article had the following properties: flexural strength of 135 MPa, flexural modulus of 8000 MPa, and tensile strength of 35 MPa.

Example 6, five particle size SiC blend, matting vacuum infusion and 80° C. curing: In this example, the Silicon Carbide blend used was the same as that in Example 2. And the article was made up of approximately 75% by weight Silicon Carbide particles and approximately 25% by weight Polymer in this case the silicon carbide grains we not treated with a silane coupling agent and were used as received. However, the polymer/resin composition used in this example was a two part infusion grade epoxy resin and hardener system Epolam 2035, with a viscosity preferably less than 1000 cps, and optimally less than 500 cps. To prepare the resin compositions, Part A and Part B resin mixtures are prepared as follows: Part A contains the 100 parts of a vinylester hybrid polymer and 5 parts zeolites sieves and Part B contains 35 parts of polymeric methylene diphenyl isocyanate and 2 parts of peroxide catalyst. Part A and Part B are commercially available materials. Part A contains 100 parts of an infusion grade epoxy resin with glass transition temperature above 120° C. Parts B contains an amine hardener matched to the epoxy resin in Part A. The resulting unitary polymer composite article had the following properties: flexural strength of 85 MPa, flexural modulus of 3000 MPa, and tensile strength of 26 MPa.

Example 7, Two particle size SiC blend, matting, pressure infusion and 80° C. curing: The SiC particles and the resin composition used are prepared as in Example one. However, here pressure infusion was used. A resin infusion hose is attached to the mould at one or several filling points on the top of the tool and the particle filled and vibro-compacted mould is subject to a pressure of 1.1 bar. The resin infusion hose is attached to a pressurized resin pot which is subject to an internal pressure of 1.5 bar. The pressure differential is maintained until the tool is filled. Thereafter the tool was vibrated for an additional time period of 10 minutes. The resulting unitary polymer composite article had the following properties: flexural strength of 62 MPa, flexural modulus of 16000 MPa, and tensile strength of 33 MPa.

Example 8 Two particle size SiC blend, matting, atmosphere infusion and 80° C. curing: The SiC particles and the resin composition used are prepared as in Example one. However, here atmospheric infusion was used. A resin infusion hose is attached to the mould at one or several filling points on the top of the tool and the tool is infused with the resin composition. After infusion, the tool is vibrated around 30 minutes in order to eliminate air pockets and to ensure full densification of the Silicon carbide particles. The composition was then placed in an oven to cure and cured by heating the oven to 80° C. and holding the tool in the oven for 4 hours. One advantage of atmospheric infusion is that it significantly reduced investment in vacuum tooling and plant equipment, and resin can be injected directly into the mould by a static mixing system with no intervening resin pot. This allows for almost exact resin volumes to be used with minimal waste. The resulting unitary polymer composite article had the following properties flexural strength of 57 MPa, flexural modulus of 11000 MPa, and tensile strength of 30 MPa.

Example 9, two different type of particles, matting, vacuum infusion and 80° C. curing: In the following example a moulded composite article is prepared using Silicon carbide and alumina particles. The final unitary polymer composite article contained approximately 50% by weight Silicon carbide particles, approximately 25% by weight alumina particles, approximately a 1 mm thick layer of unidirectional carbon fibre matting consisting of 4 layers of unidirectional weave carbon fibre fabric bonded together with spray adhesive and approximately 25% by weight Polymer. The polymer/resin composition contains

100 parts by weight Daron 45 vinyl ester urethane hybrid polymer

35 parts by weight polymeric methylene diphenyl isocyanate (MDI)

2 parts by weight peroxide catalyst

5 parts by weight zeolite molecular sieve

The process of manufacture involves the following steps (see FIG. 1 for a schematic of the manufacturing process):

1. Resin: Part A and Part B resin mixtures are prepared:

Part A contains the 100 parts of a vinylester hybrid polymer and 5 parts zeolites sieves and
Part B contains 35 parts of polymeric methylene diphenyl isocyanate and 2 parts of peroxide catalyst. Part A and Part B resin mixtures were carried out in a flask fitted with a mechanical stirrer. Approximately 1 kg is prepared for this example.

2. Silane treated Silicon carbide preparation: In this example, the Silicon carbide used is a mixture of two different grade sizes (between 50 μm and 1 mm) and is prepared as follows. One kilogram of silicon carbide (24 mesh) was added to a solution of 30 grams of an alkyl silane in 450 mL absolute Ethanol. The 24 mesh screened Silicone carbide is made up particles that are around 750 μm in size or smaller. The alkyl silane is selected so that it will be reactive with the above resin composition. Here the alkyl silane is 3-methacryloxypropyltrimethoxysilane (3-MPS). The mixture is stirred to ensure particles are fully wetted and then allowed to stand at room temperature for about one hour. The mixture is filtered using a vacuum filter flask and Buchner funnel and the residue was washed with ethanol, and then dried under a vacuum of around 20 mbar to yield the final silane treated SiC. This procedure was repeated for 46 mesh screened Silicon carbide particles to provide a similar amount of 200 μm size SiC particles.

3. The alumina particles are similarly treated with 3-methacryloxypropyltrimethoxysilane (3-MPS), using alumina particles of between 50 μm and 1 mm in size.

4. The selected grades of silane treated silicon carbide & alumina are dry blended prior to use. In this example the blend is a 70:30 mix of 750 μm:200 μm of each silicon carbide and alumina.

5. The carbon fibre matting is positioned on the surface of a mould tool and held in place using a light coat of spray adhesive.

6. The mould tool is filled with the above blend of the treated Silicon carbide and treated alumina grains. During particle filling the mould tool is vibrated at a vibration rate of between 100 to 10,000 Hz and vibration continues for up to one minute after filling is completed to facilitate packing of the particles and even flow of the particles into geometries of the mould. Compressed air may is also used, if needed, to fluidize the granular material during filling, particularly when filling complex geometries.

7. A resin infusion hose is attached to the mould tool at one or several filling points on the bottom of the tool and the particle filled and vibro-compacted mould is then sealed and placed under a vacuum of less than 100 mbar. The mould is either be a vacuum sealable tool itself or is placed in a vacuum chamber or even a sealed bag attached to vacuum as is commonly known in the composite industry as “vacuum bagging.” Vacuum filling allows for resin faster filling of the tool and also reduces the likelihood of air entrapment during infusion.

8. A heat curable, two component resin material is then mixed through a static mixer and dispensed into a resin pot attached to the other end of the infusion hose. A tap is opened on the infusion hose to allow resin to be induced in to the tool under the pull of the vacuum. The resin is allowed to infuse through the particles and fill the tool. After filling, the tool is again vibro-compacted for a period of up to 5 minutes to ensure maximum densification and to mitigate against any “resin wash” where particles are washed away from the injection port by resin flow resulting in a resin rich zone.

9. Following this the mould tool is removed from vibration and vacuum and placed in an oven to cure. In this example curing is achieved by simply heating to 80° C. and holding for 4 hours.

10. Post cure touch up and reworking is performed as needed.

11. Additional annealing is performed, if needed, by placing the cured item in an oven and curing at a temperature of over 120° C. for about 4 hours with no vacuum.

The resulting unitary polymer composite article had the following properties: flexural strength of 140 MPa in the direction of the unidirectional carbon fibre weave, flexural modulus of 13000 MPa, and tensile strength of 27 MPa.

Example 10, combine positive pressure and vacuum infusion: The Silicon carbide particles and the resin composition used may be prepared as disclosed herein. A pump liner is made using an appropriate tool to form the desired shape. A series of bidirectional carbon fibre twill weave fabric layers are placed across the surface of the mould in order to produce matting with an average thickness of approximately 12.5 mm (5 layers of fabric). The mould tool is sealed and utilizes a double vacuum seal arrangement as disclosed herein. Other suitable vacuum arrangements may also be used. The resin infusion line is attached to the mould tool and clamped to seal, then connected to the piston infusion pump. About 8150 grams of suitable Silicon carbide powder is added via the vertical pump discharge neck and the assembly is vibrated at about 20 Hz during filling with Silicon carbide. Filling is continued until the mould tool is sufficiently full of compacted Silicon carbide. The discharge is then covered with a sealed mould cap and the mould is placed under vacuum at about 50 mbars. Prime™ 20 LV epoxy resin and Prime 20LV slow hardener (manufactured by Gurit Holding AG) are mixed and placed in a resin pot supported above a piston infusion pump. The pump is primed with resin and the infusion line clamp is removed allowing resin to enter the filled mould through the piston pump, under vacuum suction. After about 2 minutes, a positive pressure of about 5 psi is applied to the resin through the piston pump and each subsequent 2 minute period the pressure is increased by about 5 psi. After 12 minutes the resin injection pressure is about 30 psi while in-tool vacuum is held at about 50 mbar. These conditions are retained for around a further 15 minutes, or when resin is observed entered the vacuum line which has been positioned in the discharge neck sealing cap. The total mass of resin infused is about 2770 grams. The vacuum line and infusion line are both clamped shut and disconnected from the respective pumps. The tool is then vibrated again at about 20 Hz⁻¹ for around 10 minutes. Vibration is ceased and the component is allowed to cure for about 12 hours at ambient temperature at which time the mould is opened and the cured liner demoulded. The moulding is then post cured for around 12 hours at 80° C. and trimmed as needed of flash using suitable machining techniques. The article produced is unitary polymer composite article.

In the following, further embodiments are explained with the help of subsequent examples. Example A1. A unitary polymer composite article comprising: 50% to 90% by weight of particles; 10% to 50% by weight of resin; and at least one layer of matting integrally incorporated in the unitary polymer composite.

### Example A1.2

A unitary polymer composite article comprising: 50% to 90% by weight of particles; 10% to 50% by weight of resin; and at least one layer of substantially continuous matting integrally incorporated in the unitary polymer composite article

### Example A1.5

A unitary polymer composite article comprising: 20% to 80% by weight of particles, wherein at least 20% of the particles have a have a Mohs hardness of greater than 6.5, 6.8 or 7; 20% to 80% by weight of resin; and at least one layer of matting integrally incorporated in the unitary polymer composite article.

### Example A1.5

A unitary polymer composite article comprising: 20% to 80% by weight of particles, wherein at least 20% of the particles have a have a Mohs hardness of greater than 6.5, 6.8 or 7; 20% to 80% by weight of resin; and at least one layer of substantially continuous matting integrally incorporated in the unitary polymer composite article.

### Example A2

The article of one or more of the A Examples, wherein a substantial portion of the particles have a Mohs hardness of greater than 7.

### Example A3

The article of one or more of the A Examples, wherein the at least one layer of matting is at least 0.1%, 0.5%, 1%, 5%, 10%, 20% or 30% by volume of the total volume of the article.

### Example A4

The article of one or more of the A Examples, wherein the article is void, substantially void or sufficiently void of air pockets.

### Example A5

The article of one or more of the A Examples, wherein the at least one layer of matting is at least 0.1%, 0.5%, 1%, 5%, 10% or 20% by weight of the total weight of the article.

### Example A6

The article of one or more of the A Examples, wherein the at least one layer of matting is comprised of one or more of the following materials: glass, glass fibers, carbon, carbon fibers, ceramics, ceramic fibers, polymers, polymer fibers, minerals and mineral fibres.

### Example A7

The article of one or more of the A Examples, wherein the article comprises at least two, three, four, five, six or seven layers of matting.

### Example A8

The article of one or more of the A Examples, wherein the article is void, substantially void or sufficiently void of air pockets.

### Example A9

The article of one or more of the A Examples, wherein the at least one layer of matting of the article is void, substantially void or sufficiently void of air pockets.

### Example A10

The article of one or more of A Examples, wherein the at least two, three, four, five, six or seven layers of matting of the article are void, substantially void or sufficiently void of air pockets.

### Example A11

The article of one or more of the A Examples, wherein the at least one layer of matting is at least 5 mm, 10 mm, or 20 mm, thick and the article is void, substantially void or sufficiently void of air pockets.

### Example A12

The article of one or more of the A Examples, wherein the at least one layer of matting is between 5 mm to 25 mm, 1 mm to 10 mm, or 10 mm to 20 mm thick and the article is void, substantially void or sufficiently void of air pockets.

### Example A13

The article of one or more of the A Examples, wherein the at least one layer of matting is made with glass fibre and the at least one second layer is made with carbon fiber and the article is void, substantially void or sufficiently void of air pockets.

### Example A14

The article of one or more of the A Examples, wherein the at least one layer of matting is made with glass fibre and the at least one second layer is made with carbon fiber and the article is void, substantially void or sufficiently void of air pockets.

### Example A15

The article of one or more of the A Examples, wherein the at least two, three, four, five, six or seven layers of matting are alternating layers made of one or more of the following: glass fibre, carbon fibre, ceramic fibre and cellulose fibre, and the article is void, substantially void or sufficiently void of air pockets.

### Example A16

The article of one or more of the A Examples, wherein the at least two, three, four, five, six or seven layers of matting are made of one or more of the following: glass fibre, carbon fibre, ceramic fibre and cellulose fibre, and the article is void, substantially void or sufficiently void of air pockets.

### Example A17

The article of one or more of the A Examples, wherein the at least two, three, four, five, six or seven layers of matting are made of one or more of the following: glass, carbon, ceramic and cellulose, and the article is void, substantially void or sufficiently void of air pockets.

### Example A18

The article of one or more of the A Examples, wherein the at least two, three, four, five, six or seven layers of matting are made of at least two, three or four different materials and the article is void, substantially void or sufficiently void of air pockets.

### Example A19

The article of one or more of the A Examples, wherein at least 20%, 30%, 40%, 50%, 60%, 70% or 85% by weight of the particles have a Mohs hardness of 7 or greater.

### Example A20

The article of one or more of the A Examples, wherein a substantial portion of the particles have an aspect ratio of between 0.5 to 2.

### Example A21

The article of one or more of A Examples, wherein at least 20%, 30%, 40%, 50%, 60%, 70% or 85% by weight of the particles have an aspect ratio of between 0.5 to 2.

### Example A22

The article of one or more of A Examples, wherein a substantial portion of the particles have an aspect ratio of between 0.7 to 1.3.

### Example A23

The article of one or more of A Examples, wherein at least 20%, 30%, 40%, 50%, 60%, 70% or 85% by weight of the particles have an aspect ratio of between 0.7 to 1.3.

### Example A24

The article of one or more of the A Examples, wherein a substantial portion of the particles are between 50 μm to 1 mm in size.

### Example A25

The article of one or more of the A Examples, wherein at least 20%, 30%, 40%, 50%, 60%, 70% or 85% by weight of the particles are between 50 μm to 1 mm in size.

### Example A26

The article of one or more of A Examples, wherein the particles comprises a blend of two or more different size grades of particles.

### Example A27

The article of one or more of the A Examples, wherein the particles comprises a blend of at least 1, 2, 3, 4, 5 or 6 different size grades of particles.

### Example A28

The article of one or more of the A Examples, wherein the particles comprises about a 70:30 weight ratio blend of about 750 μm graded Silicon carbide particles and about 200 μm graded Silicon carbide particles.

### Example A29

The article of one or more of the A Examples, wherein the particles comprises a 65 to 75:25 to 35 weight ratio blend of 725 to 775 μm graded Silicon carbide particles and 175 to 225 μm graded Silicon carbide particles.

### Example A30

The article of one or more of the A Examples, wherein the particles comprises a blend of at least 5 different grades of particles comprising about one part 1 mm particles, about one part 750 μm particles, about one part 500 μm particles, about one part 250 μm particles and about one part 100 μm particles.

### Example A31

The article of one or more of the A Examples, wherein the particles comprises a blend of at least 5 different grades of particles comprising about 15 to 25 parts of 0.9 to 1.1 mm particles, 15 to 25 parts 730 to 770 μm particles, 15 to 25 parts 480 to 520 μm particles, 15 to 25 parts 230 to 270 μm particles and 15 to 25 parts 90 to 110 μm particles.

### Example A32

The article of one or more of the A Examples, wherein the particles comprises a blend of at least two different types of particles.

### Example A33

The article of one or more of the A Examples, wherein the particles comprises a blend of at least two to four different types of particles.

### Example A34

The article of one or more of the A Examples, wherein a substantial portion of the particles have a Mohs hardness of between 8.8 and 9.2.

### Example A35

The article of one or more of the A Examples, wherein a substantial portion of the particles have a Mohs hardness of greater than 9 and are substantially inert.

### Example A36

The article of one or more of the A Examples, wherein at least 20%, 30%, 40%, 50%, 60%, 70% or 85% by weight of the particles have a Mohs hardness of greater than 9 and are substantially inert.

### Example A37

The article of one or more of the A Examples, wherein the particles are selected from one or of the following: Silicon carbide, Alumina carbide, Tungsten carbide, Titanium carbide, Corundum, Quartz, Silicon dioxide, Silica, Silica sand, and other suitable non-absorbent particles.

### Example A38

The article of one or more of the A Examples, wherein the particles are Silicon carbide particles.

### Example A39

The article of one or more of the A Examples, wherein the resin composition is an infusion grade resin.

### Example A40

The article of one or more of the A Examples, wherein the resin composition comprises one or more of the following: a vinyl ester urethane resin and an epoxy resin.

### Example A41

The article of one or more of the A Examples, wherein the resin composition comprises a thermosetting infusion grade resin.

### Example A42

The article of one or more of the A Examples, wherein the article has a complex geometry and there is a substantial uniform distribution of the resin composition and the particles.

### Example A43

The article of one or more of the A Examples, wherein the article has a substantial uniform distribution of the resin composition and the particles.

### Example A44

The article of one or more of the A Examples, wherein the article comprises between 15% to 30% by weight of the resin composition and between 70% to 85% by weight of the particles; the particles are a blend comprising two or more grades of silane treated Silicon carbide particles; and a substantial portion of the blended particles are between 50 μm to 1 mm in size.

### Example A45

The article of the A Examples, wherein the at least one matting is a fibre matting comprising: glass fibre, carbon fibre, other reinforcing fibre material or combinations thereof.

### Example A46

The article of the A Examples, wherein the at least one layer of matting is continuous, substantially continuous or sufficiently continuous.

### Example A47

The article of the A Examples, wherein the at least one layer of matting is at least 30%, 40%, 50%, 60%, 70%, 80% or 90% continuous.

### Example A48

The article of the A Examples, wherein the at least one layer of matting is at least 30%, 40%, 50%, 60%, 70%, 80% or 90% by length continuous.

### Example A49

The article of the A Examples, wherein the at least one layer of matting is made up at least 1, 2, 3, 4, 5, 6, 7, 8 or 9 discontinuous portions and the discontinuous portions are continuous, substantially continuous or sufficiently continuous.

### Example A50

The article of the A Examples, wherein the article comprises at least two, three, four, five, six or seven layers of matting and the matting is a fibre matting comprising: glass fibre, carbon fibre, other reinforcing fibre material or combinations thereof.

### Example A51

The article of the A Examples, wherein the article comprises at least two, three, four, five, six or seven layers of matting and at least one of the layers is continuous, substantially continuous or sufficiently continuous.

### Example A52

The article of the A Examples, wherein the article comprises at least two, three, four, five, six or seven layers of matting and at least two, three or four of the layer are continuous, substantially continuous or sufficiently continuous.

### Example B1.1

A method for producing a moulded composite article comprising: a) providing at least one layer of matting to a mould tool; b) filling to a predetermined level the mould tool with particles, wherein a substantial portion of the particles have a Mohs hardness of greater than 7; c) infusing a resin composition into the mould tool filled with the particles and the at least one layer of matting in order to form a composite, wherein at least a portion of the mould tool is subjected to a vacuum and at least a portion of the mould tool is subject to a positive pressure during at least a portion of the infusing of the resin composition; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and e) curing the composite to form the moulded composite article.

### Example B1.2

A method for producing a moulded composite article comprising: a) providing at least one layer of matting to a mould tool; b) filling to a predetermined level a mould tool with particles; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and e) curing the composite to form the moulded composite article.

### Example B1.3

A method for producing a moulded composite article comprising: a) providing at least one layer of matting to a mould tool; b) filling to a predetermined level a mould tool with particles, wherein at least 20%, 30%, 40%, 50%, 60%, 70% or 85% by weight of the particles have a Mohs hardness of 7 or greater; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 50% by weight of the resin composition and between 50% to 90% by weight of the particles; and e) curing the composite to form the moulded composite article.

### Example B1.4

A method for producing a moulded composite article comprising: a) providing at least one layer of matting to a mould tool; b) filling to a predetermined level a mould tool with particles, wherein at least 20%, 30%, 40%, 50%, 60%, 70% or 85% by weight of the particles have a Mohs hardness of 7 or greater; c) infusing a resin composition into the mould tool filled with the particles and the at least one layer of matting in order to form a composite; d) vibrating the mould tool for a portion of time at one or more of the following stages: during the filling with the particles, after the filling with particles, during the infusing of the resin composition and after the infusions of the resin composition; wherein the composite comprises between 10% to 80% by weight of the resin composition and between 20% to 90% by weight of the particles; and e) curing the composite to form the moulded composite article.

### Example B1.5

A method for producing a moulded composite article comprising: a) providing at least one layer of matting to a mould tool; b) substantially filling a mould tool interior with a blend comprising two or more grades of silane treated Silicon carbide particles, wherein a substantial portion of the blended particles is between 50 μm to 1 mm in size and the mould tool is vibrated during at least a portion of the filling process at one or more vibration rates between 100 to 10,000 Hz; c) continuing to vibrate the mould tool after filling at one or more vibration rates between 100 to 10,000 Hz in order to facilitate a packing of the blended particles and to facilitate a substantially even flow of the blended particles into interior geometries of the mould tool; d) placing the mould tool filled with the blended particles under a vacuum of less than 100 mbar; e) infusing a resin composition into the mould tool interior substantially filled with the blended particles and the at least one layer of matting under a vacuum of less than 100 mbar; f) vibrating the mould tool substantially filled with the blended particles, the at least one layer of matting and the resin composition at one or more vibration rates of between 100 to 10,000 Hz for a time period of between 1 minute to 45 minutes in order to facilitate densification and to mitigate against resin wash; g) curing the mould tool substantially filled with the blended particles, the at least one layer of matting and the resin composition by heating until cured, wherein a portion of the resin composition is bonded to a substantial portion of the blended particles via a silane coupling agent coated on a substantial portion of the blended particles; and h) removing the cured moulded composite article from the mould tool, wherein the article comprises between 15% to 30% by weight of the resin composition and between 70% to 85% by weight of the blend particles.

### Example B1.6

A method for producing a moulded composite article comprising: a) providing at least one layer of matting to a mould tool; b) substantially filling a mould tool interior with a blend of silane treated Silicon carbide particles, wherein a substantial portion of the blended particles is between 50 μm to 1 mm in size and the mould tool is vibrated during at least a portion of the filling process; c) continuing to vibrate the mould tool after filling in order to facilitate a packing of the blended particles; d) placing the mould tool filled with the blended particles under a vacuum of less than 100 mbar; e) infusing a resin composition into the mould tool interior substantially filled with the blended particles and the at least one layer of matting under a vacuum of less than 100 mbar; f) vibrating the mould tool substantially filled with the blended particles, the at least one layer of matting and the resin composition in order to facilitate densification; g) curing the mould tool substantially filled with the blended particles, the at least one layer of matting and the resin composition by heating until cured, wherein a portion of the resin composition is bonded to a substantial portion of the blended particles via a silane coupling agent coated on a substantial portion of the blended particles; and h) removing the cured composite article from the mould tool, wherein the article comprises between 15% to 30% by weight of the resin composition and between 70% to 85% by weight of the blend particles.

### Example B1.7

A method for producing a moulded composite article comprising: a) providing at least one layer of matting to a mould tool; b) substantially filling a mould tool interior with treated Silicon carbide particles, wherein the mould tool is vibrated during at least a portion of the filling process; c) continuing to vibrate the mould tool after filling in order to facilitate a packing of the treated particles; d) placing the mould tool filled with the treated particles under a vacuum of less than 100 mbar; e) infusing a resin composition into the mould tool interior substantially filled with the treated particles and the at least one layer of matting under a vacuum of less than 100 mbar; f) vibrating the mould tool substantially filled with the treated particles, the at least one layer of matting and the resin composition in order to facilitate densification, wherein the treated particles and the resin composition comprises between 15 to 30% by weight of the resin composition and between 70 to 85% by weight of the treated particles; and g) curing the mould tool substantially filled with the treated particles and the resin composition by heating until cured.

### Example B1.8

A method for producing a moulded composite article comprising: a) providing at least one layer of matting to a mould tool; b) substantially filling a mould tool interior with a blend comprising two or more grades of silane treated silicon carbide particles, wherein a substantial portion of the blended particles is between 50 μm to 1 mm in size and the mould tool is vibrated during at least a portion of the filling process at one or more vibration rates between 100 to 10,000 Hz; c) continuing to vibrate the mould tool after filling at one or more vibration rates between 100 to 10,000 Hz in order to facilitate a packing of the blended particles and to facilitate a substantially even flow of the blended particles into interior geometries of the mould tool; d) infusing a resin composition into the mould tool interior substantially filled with the blended particles and the at least one layer of matting at atmospheric pressure; e) vibrating the mould tool substantially filled with the blended particles, the at least one layer of matting and the resin composition at one or more vibration rates of between 100 to 10,000 Hz for a time period of between 15 minutes to 75 minutes in order to facilitate densification and to mitigate against resin wash; f) curing the mould tool substantially filled with the blended particles, the at least one layer of matting and the resin composition by heating until cured, wherein a portion of the resin composition is bonded to a substantial portion of the blended particles via a silane coupling agent coated on a substantial portion of the blended particles; and g) removing the cured composite article from the mould tool, wherein the article comprises between 15 to 30% by weight of the resin composition and between 70 to 85% by weight of the blend particles.

### Example B1.9

A method for producing a moulded composite article comprising: a) providing at least one layer of matting to a mould tool; b) substantially filling a mould tool interior with a blend of silane treated Silicon carbide particles, wherein a substantial portion of the blended particles is between 50 μm to 1 mm in size and the mould tool is vibrated during at least a portion of the filling process; c) continuing to vibrate the mould tool after filling in order to facilitate a packing of the blended particles; d) infusing a resin composition into the mould tool interior substantially filled with the blended particles and the at least one layer of matting at atmospheric pressure; e) vibrating the mould tool substantially filled with the blended particles, the at least one layer of matting and the resin composition in order to facilitate densification; f) curing the mould tool substantially filled with the blended particles, the at least one layer of matting and the resin composition by heating until cured, wherein a portion of the resin composition is bonded to a substantial portion of the blended particles via a silane coupling agent coated on a substantial portion of the blended particles; and g) removing the cured composite article from the mould tool, wherein the article comprises between 15% to 30% by weight of the resin composition and between 70% to 85% by weight of the blend particles.

### Example B1.10

A method for producing a composite article comprising: a) providing at least one layer of matting to a mould tool; b) substantially filling a mould tool interior with treated Silicon carbide particles, and the mould tool is vibrated during at least a portion of the filling process; c) continuing to vibrate the mould tool after filling in order to facilitate a packing of the treated particles; d) infusing a resin composition into the mould tool interior substantially filled with the treated particles and the at least one layer of matting at atmospheric pressure; e) vibrating the mould tool substantially filled with the treated particles, the at least one layer of matting and the resin composition in order to facilitate densification, wherein the treated particles and the resin composition comprises between 15% to 30% by weight of the resin composition and between 70% to 85% by weight of the treated particles; and f) curing the mould tool substantially filled with the treated particles and the resin composition by heating until cured.

### Example B2

The method of one or more of the B Examples, wherein a substantial portion of the particles have an aspect ratio of between 0.5 to 2.

### Example B3

The method of one or more of the B Examples, wherein a substantial portion of the particles have an aspect ratio of between 0.7 to 1.3.

### Example B4

The method of one or more of B Examples, wherein a substantial portion of the particles are between 50 μm to 1 mm in size.

### Example B5

The method of one or more of the B Examples, wherein the particles comprises a blend of two or more different size grades of particles.

### Example B6

The method of one or more of the B Examples, wherein the particles comprises a blend of at least 1, 2, 3, 4, 5 or 6 different size grades of particles.

### Example B7

The method of one or more of the B Examples, wherein the particles comprises about a 70:30 weight ratio blend of about 750 μm graded Silicon carbide particles and about 200 μm graded Silicon carbide particles.

### Example B8

The method of one or more of the B Examples, wherein the particles comprises a 65 to 75:25 to 35 weight ratio blend of 725 to 775 μm graded Silicon carbide particles and 175 to 225 μm graded Silicon carbide particles.

### Example B9

The method of one or more of the B Examples, wherein the particles comprises a blend of at least 5 different grades of particles comprising about one part 1 mm particles, about one part 750 μm particles, about one part 500 μm particles, about one part 250 μm particles and about one part 100 μm particles.

### Example B10

The method of one or more of the B Examples, wherein the particles comprises a blend of at least 5 different grades of particles comprising about 15 to 25 parts of 0.9 to 1.1 mm particles, 15 to 25 parts 730 to 770 μm particles, 15 to 25 parts 480 to 520 μm particles, 15 to 25 parts 230 to 270 μm particles and 15 to 25 parts 90 to 110 μm particles.

### Example B11

The method of one or more of the B Examples, wherein the particles comprises a blend of at least two different types of particles.

### Example B12

The method of one or more of the B Examples, wherein the particles comprises a blend of at least two to four different types of particles.

### Example B13

The method of one or more of the B Examples, wherein a substantial portion of the particles have a Mohs hardness of between 8.8 and 9.2.

### Example B14

The method of one or more of the B Examples, wherein a substantial portion of the particles have a Mohs hardness of greater than 9 and are substantially inert.

### Example B15

The method of one or more of the B Examples, wherein the particles are selected from one or of the following: Silicon carbide, Alumina carbide, Tungsten carbide, Titanium carbide, Corundum, Quartz, Silicon dioxide, Silica, Silica sand, and other suitable non-absorbent particles.

### Example B16

The method of one or more of the B Examples, wherein the particles are Silicon carbide particles.

### Example B17

The method of one or more of the B Examples, wherein the particles are treated to enhance their wetting during the infusion of the resin composition.

### Example B18

The method of one or more of the B Examples, wherein the Silicon carbide particles are treated with a organo-silane coupling agent composition that is capable of bonding to a portion of the resin composition during curing of the composite.

### Example B19

The method of one or more of the B Examples, wherein the Silicon carbide particles are treated with an alkyl silane.

### Example B20

The method of one or more of the B Examples, wherein the resin composition is an infusion grade resin.

### Example B21

The method of one or more of the B Examples, wherein the resin composition comprises one or more of the following: a vinyl ester urethane resin and an epoxy resin.

### Example B22

The method of one or more of the B Examples, wherein the resin composition comprises a thermosetting infusion grade resin.

### Example B23

The method of one or more of the B Examples, wherein the resin composition has a viscosity of less than 1000 cps.

### Example B24

The method of one or more of the B Examples, wherein the resin composition has a viscosity of less than 500 cPs at 25 degrees C.

### Example B25

The method of one or more of the B Examples, wherein the resin composition has a viscosity of less than 60 cPs at 25 degrees C.

### Example B26

The method of one or more of the B Examples, wherein the resin composition has a viscosity of between 10 cPs to 500 cPs at 25 degrees C.

### Example B27

The method of one or more of the B Examples, wherein the resin composition has a viscosity of between 10 cPs to 500 cPs at 45 degrees C.

### Example B28

The method of one or more of the B Examples, wherein the resin composition is thixotropic.

### Example B29

The method of one or more of the B Examples, wherein and the mould tool is vibrated during at least a portion of the particle filling process at one or more vibration rates of between 100 to 10,000 Hz.

### Example B30

The method of one or more of the B Examples, wherein and the mould tool is vibrated after the particle filling process at one or more vibration rates of between 100 to 10,000 Hz in order to facilitate one or more of the following: a packing of the particles and a substantially even flow of the particles into interior geometries of the mould tool.

### Example B31

The method of one or more of the B Examples, wherein after the mould tool is filled with the particles and the resin composition the mould tool is vibrated at one or more vibration rates of between 100 to 10,000 Hz for a time period of between 1 minute to 45 minutes.

### Example B32

The method of one or more of the B Examples, wherein after the mould tool is filled with the particles and the resin composition the mould tool is vibrated at one or more vibration rates of between 100 to 10,000 Hz for a time period of between 1 minute to 75 minutes in order to facilitate one or more of the following: densification and to mitigate against resin wash.

### Example B33

The method of one or more of the B Examples, wherein infusing of the resin composition into the mould tool interior filled to the predetermined level with the particles is carried out in part at atmospheric pressure.

### Example B34

The method of one or more of the B Examples, wherein at least a portion of the mould tool after filling with the particles is subjected to a vacuum of less than 100 mbar and the resin composition is infused into the mould tool interior under vacuum.

### Example B35.1

The method of one or more of the B Examples, wherein the resin is infused into of the mould tool after filling with the particles.

### Example B35.2

The method of one or more of the B Examples, wherein the interior of the mould tool after filling with the particles is subjected to a vacuum of less than 100 mbar and the resin composition is infused into the mould tool interior under vacuum.

### Example B36

The method of one or more of the B Examples, wherein, during curing a portion of the resin composition is bonded to a substantial portion of the particles via a silane coupling agent coated on a substantial portion of the particles.

### Example B37

The method of one or more of the B Examples, wherein the mould tool substantially filled with the silicon carbide particles and the resin composition is cured at one temperature range between 70° C. and 90° C. for between 3 to 6 hours.

### Example B38

The method of one or more of the B Examples, wherein the mould tool substantially filled with the Silicon carbide particles and the resin composition is cured using a temperature ramp of at least one, two, three or four different temperatures wherein the Silicon carbide particles and the resin composition is held at each temperature for between 30 minutes to 3 hours.

### Example B39

The method of one or more of the B Examples, wherein the amount of the resin composition prepared is only what is needed to fill the mould tool.

### Example B40

The method of one or more of the B Examples, wherein the method is a closed system that reduces the need of personal to handle the resin composition.

### Example B41

The method of one or more of the B Examples, wherein the method is a closed system that reduces the exposure of the resin composition to the atmosphere.

### Example B42

The method of one or more of the B Examples, wherein the method is a closed system that improves worker safety and air quality controls.

### Example B43

The method of one or more of the B Examples, wherein the method results in a resin/particles composition with reduced air pockets in the composition.

### Example B44

The method of one or more of the B Examples, wherein the method produces composites in a complex geometry mould tool that have a substantial uniform distribution of the resin composition and the particles.

### Example B45

The method of one or more of the B Examples, wherein the method produces a complex geometry cured article that is substantial uniform in distribution of the resin composition and the particles.

### Example B46

The method of one or more of the B Examples, wherein the method produces composites that have a substantial uniform distribution of the resin composition and the particles.

### Example B47

The method of one or more of the B Examples, wherein the method produces a cured article that is substantial uniform in distribution of the resin composition and the particles.

### Example B48

The method of one or more of the B Examples, wherein at least a portion of the mould tool is subjected to one or more of the following: atmospheric pressure, vacuum and positive pressure during at least a portion of the infusing of the resin composition.

### Example B49

The method of one or more of the B Examples, wherein at least a portion of the mould tool is subjected to vacuum during at least a portion of the infusing of the resin composition and at least a portion of the mould tool is subject to positive pressure during at least a portion of the infusing of the resin composition.

### Example B49

The method of one or more of the B Examples, wherein the at least one layer of matting is comprised of one or more of the following materials: glass, glass fibers, carbon, carbon fibers, ceramics, ceramic fibers, polymers, polymer fibers, minerals and mineral fibres.

### Example B50

The method of one or more of the B Examples, wherein at least two, three, four, five, six or seven layers of matting are positioned in the mould tool.

### Example B51

The method of one or more of the B Examples, wherein the method produces an article that is void, substantially void or sufficiently void of air pockets.

### Example B52

The method article of one or more of the B Examples, wherein the at least one layer of matting of the article is void, substantially void or sufficiently void of air pockets.

### Example B53

The method of one or more of the B Examples, wherein the at least two, three, four, five, six or seven layers of matting of the article are void, substantially void or sufficiently void of air pockets.

### Example B54

The method of one or more of the B Examples, wherein the article produced has a substantial uniform distribution of the resin composition and the particles.

### Example B55

The method of one or more of the B Examples, wherein the at least one matting is a fibre matting comprising: glass fibre, carbon fibre, other reinforcing fibre material or combinations thereof.

### Example B56

The method of one or more of the B Examples, wherein the at least one layer of matting is continuous, substantially continuous or sufficiently continuous.

### Example B58

The method of one or more of the B Examples, wherein the at least one layer of matting is at least 30%, 40%, 50%, 60%, 70%, 80% or 90% by length continuous.

### Example B59

The method of one or more of the B Examples, wherein at least a portion of the mould tool is subjected to one or more of the following: atmospheric pressure, vacuum and positive pressure during at least a portion of the infusing of the resin composition.

### Example B60

The method of one or more of the B Examples, wherein at least a portion of the mould is subjected to vacuum during at least a portion of the infusing of the resin composition and at least a portion of the mould tool is subject to positive pressure during at least a portion of the infusing of the resin composition.

### Example B60

The method of one or more of the B Examples, wherein the moulded composite article is a unitary polymer composite article.

### Example B61

A system for producing a unitary polymer composite article that uses one or more of the methods of the B Examples.

While the present disclosure has been described in connection with certain embodiments, it is to be understood that the present disclosure is not to be limited to the disclosed embodiments, but on the contrary, is intended to cover various modifications and equivalent arrangements. Also, the various embodiments described herein may be implemented in conjunction with other embodiments, e.g., aspects of one embodiment may be combined with aspects of another embodiment to realize yet other embodiments. Further, each independent feature or component of any given embodiment may constitute an additional embodiment.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

1. A unitary polymer composite article for use in highly corrosive and/or wear-resistant environments comprising:
50% to 90% by weight of silicon carbide particles;
10% to 50% by weight of resin; and
at least one layer of carbon fibers matting integrally incorporated in the unitary polymer composite, wherein the article has a tensile strength of above 25 MPa, a density of between 2 to 3 g/cc, a hardness of between 70 to 95 Shore D, a flexural strength of at least 50 MPa and the article is wear resistant and acid resistant and has a life span of between 15,000 to 200,000 hours in use.

2. A unitary polymer composite article for use in highly corrosive and/or wear-resistant environments comprising:
50% to 90% by weight of particles;
10% to 50% by weight of resin; and
at least one layer of matting integrally incorporated in the unitary polymer composite, wherein the article has a tensile strength of above 25 MPa.

3. A unitary polymer composite article comprising:
50% to 90% by weight of particles;
10% to 50% by weight of resin; and
at least one layer of matting integrally incorporated in the wear resistant unitary polymer composite, wherein the article has a density of between 2 to 3 g/cc.

4. A unitary polymer composite article comprising:
50% to 90% by weight of particles;
10% to 50% by weight of resin; and
at least one layer of matting integrally incorporated in the unitary polymer composite, wherein the article has a hardness of between 70 to 95 Shore D.

5. A unitary polymer composite article for use in highly corrosive and/or wear-resistant environments comprising:
50% to 90% by weight of particles;
10% to 50% by weight of resin; and
at least one layer of matting integrally incorporated in the unitary polymer composite, wherein the article has a flexural strength of at least 50 MPa.

6. A unitary polymer composite article for use in highly corrosive and/or wear-resistant environments comprising:
50% to 90% by weight of particles;
10% to 50% by weight of resin; and
at least one layer of matting integrally incorporated in the unitary polymer composite, wherein the article is wear resistant, acid resistant and has a life span of between 10,000 to 200,000 hours in use.

7. A unitary polymer composite article for use in highly corrosive and/or wear-resistant environments comprising:
50% to 90% by weight of particles;
10% to 50% by weight of resin; and
at least one layer of matting integrally incorporated in the unitary polymer composite, wherein the article is wear resistant and acid resistant and has a life span of between 15,000 to 200,000 hours of use.

8. A unitary polymer composite article for use in highly corrosive and/or wear-resistant environments comprising:
50% to 90% by weight of particles;
10% to 50% by weight of resin; and
at least one layer of matting integrally incorporated in the unitary polymer composite, wherein the article has a flexural strength of between 30 to 150 MPa, a tensile strength of between 15 and 120 MPa and a glass transition temperate of at least 110° C.

9. A unitary polymer composite article for use in highly corrosive and/or wear-resistant environments comprising:
50% to 90% by weight of particles;
10% to 50% by weight of resin; and
at least one layer of matting integrally incorporated in the unitary polymer composite, wherein the article has a flexural strength of between 50 to 80 MPa, a tensile strength of between 20 and 50 MPa, a glass transition temperate of at least 110° C. and is suitable wear resistance and suitable acid resistance.

10. The article of claim 1, wherein a substantial portion of the particles have a Mohs hardness of 7 or greater.

11. The article of claim 1, wherein the at least one layer of matting is comprised of one or more of the following materials: glass, glass fibers, carbon, carbon fibers, ceramics, ceramic fibers, polymers, polymer fibers, minerals and mineral fibres.

12. The article of claim 1, wherein the article comprises at least two, three, four, five, six or seven layers of matting.

13. The article of claim 1, wherein the at least one layer of matting is at least 0.1%, 0.5%, 1%, 5%, 10%, 20% or 30% by volume of the total volume of the article.

14. The article of claim 1, wherein the article is void, substantially void or sufficiently void of air pockets.

15. The article of claim 1, wherein the at least one layer of matting of the article is void, substantially void or sufficiently void of pockets.

16. The article of claim 1, wherein the at least one layer of matting is at least 0.1%, 0.5%, 1%, 5%, 10% or 20% by weight of the total weight of the article.

17. The article of claim 1, wherein the at least two, three, four, five, six or seven layers of matting of the article are void, substantially void or sufficiently void of air pockets.

18. The article of claim 1, wherein at least 20%, 30%, 40%, 50%, 60%, 70% or 85% by weight of the particles have a Mohs hardness of 7 or greater.

19. The article of claim 1, wherein a substantial portion of the particles have an aspect ratio of between 0.5 to 2.

20. The article of claim 1, wherein at least 20%, 30%, 40%, 50%, 60%, 70% or 85% by weight of the particles have an aspect ratio of between 0.5 to 2.

21. The article of claim 1, wherein a substantial portion of the particles have an aspect ratio of between 0.7 to 1.3.

22. The article of claim 1, wherein at least 20%, 30%, 40%, 50%, 60%, 70% or 85% by weight of the particles have an aspect ratio of between 0.7 to 1.3.

23. The article of claim 1, wherein a substantial portion of the particles are between 50 μm to 1 mm in size.

24. The article of claim 1, wherein at least 20%, 30%, 40%, 50%, 60%, 70% or 85% by weight of the particles are between 50 μm to 1 mm in size.

25. The article of claim 1, wherein the particles comprise a blend of two or more different size grades of particles.

26. The article of claim 1, wherein the particles comprise a blend of at least 1, 2, 3, 4, 5 or 6 different size grades of particles.

27. The article of claim 1, wherein the particles comprise about a 70:30 weight ratio blend of about 750 μm graded Silicon carbide particles and about 200 μm graded Silicon carbide particles.

28. The article of claim 1, wherein the particles comprise a 65 to 75:25 to 35 weight ratio blend of 725 to 775 μm graded Silicon carbide particles and 175 to 225 μm graded Silicon carbide particles.

29. The article of claim 1, wherein the particles comprise a blend of at least 5 different grades of particles comprising about one part 1 mm particles, about one part 750 μm particles, about one part 500 μm particles, about one part 250 μm particles and about one part 100 μm particles.

30. The article of claim 1, wherein the particles comprise a blend of at least 5 different grades of particles comprising about 15 to 25 parts of 0.9 to 1.1 mm particles, 15 to 25 parts 730 to 770 μm particles, 15 to 25 parts 480 to 520 μm particles, 15 to 25 parts 230 to 270 μm particles and 15 to 25 parts 90 to 110 μm particles.

31. The article of claim 1, wherein the particles comprise a blend of at least two different types of particles.

32. The article of claim 1, wherein the particles comprise a blend of at least two to four different types of particles.

33. The article of claim 1, wherein a substantial portion of the particles have a Mohs hardness of between 8.8 and 9.2.

34. The article of claim 1, wherein a substantial portion of the particles have a Mohs hardness of greater than 9 and are substantially inert.

35. The article of claim 1, wherein at least 20%, 30%, 40%, 50%, 60%, 70% or 85% by weight of the particles have a Mohs hardness of greater than 9 and are substantially inert.

36. The article of claim 1, wherein the particles are selected from one or of the following: Silicon carbide, Alumina carbide, Tungsten carbide, Titanium carbide, Corundum, Quartz, Silicon dioxide, Silica, Silica sand, and other suitable non-absorbent particles.

37. The article of claim 1, wherein the particles are Silicon carbide particles.

38. The article of claim 1, wherein the resin composition is an infusion grade resin.

39. The article of claim 1, wherein the resin composition comprises one or more of the following: a vinyl ester urethane resin and an epoxy resin.

40. The article of claim 1, wherein the resin composition comprises a thermosetting infusion grade resin.

41. The article of claim 1, wherein the article has a complex geometry and there is a substantial uniform distribution of the resin composition and the particles.

42. The article of claim 1, wherein the article has a substantial uniform distribution of the resin composition and the particles.

43. The article of claim 1, wherein the article comprises between 15% to 30% by weight of the resin composition and between 70% to 85% by weight of the particles and the particles are a blend comprising two or more grades of silane treated Silicon carbide particles and a substantial portion of the blended particles are between 50 μm to 1 mm in size.

44. The article of claim 1, wherein the at least one matting is a fibre matting comprising: glass fibre, carbon fibre, other reinforcing fibre material or combinations thereof.

45. The article of claim 1, wherein the at least one layer of matting is continuous, substantially continuous or sufficiently continuous.

46. The article of claim 1, wherein the at least one layer of matting is at least 30%, 40%, 50%, 60%, 70%, 80% or 90% continuous.

47. The article of claim 1, wherein the at least one layer of matting is at least 30%, 40%, 50%, 60%, 70%, 80% or 90% by length continuous.

48. The article of claim 1, wherein the at least one layer of matting is made up at least 1, 2, 3, 4, 5, 6, 7, 8 or 9 discontinuous portions and the discontinuous portions are continuous, substantially continuous or sufficiently continuous.

49. The article of claim 1, wherein the article comprises at least two, three, four, five, six or seven layers of matting and the matting is a fibre matting comprising: glass fibre, carbon fibre, other reinforcing fibre material or combinations thereof.

50. The article of claim 1, wherein the article comprises at least two, three, four, five, six or seven layers of matting and at least one of the layers is continuous, substantially continuous or sufficiently continuous.

51. The article of claim 1, wherein the article comprises at least two, three, four, five, six or seven layers of matting and at least two, three or four of the layer are continuous, substantially continuous or sufficiently continuous.

52. A method for producing a moulded composite article comprising:
a) providing at least one layer of matting to a mould tool;
b) filling to a predetermined level the mould tool with particles;
c) infusing a resin composition into the mould tool filled with the particles and the at least one layer of matting in order to form a composite;
d) vibrating the mould tool for a portion of time at one or more of the following stages: during the filling with the particles, after the filling with particles, during the infusing of the resin composition and after the infusion of the resin composition; wherein the composite comprises between 10% to 50% by weight of the resin composition and between 50% to 90% by weight of the particles; and
e) curing the composite to form the moulded composite article.

53. The method of claim 52, wherein a substantial portion of the particles have a Mohs hardness of 7 or greater.

54. The method of claim 52, wherein a substantial portion of the particles have an aspect ratio of between 0.7 to 1.3.

55. The method of claim 52, wherein a substantial portion of the particles are between 50 μm to 1 mm in size.

56. The method of claim 52, wherein the particles comprise a blend of two or more different size grades of particles.

57. The method of claim 52, wherein the particles comprise a blend of at least 1, 2, 3, 4, 5 or 6 different size grades of particles.

58. The method of claim 52, wherein the particles comprise about a 70:30 weight ratio blend of about 750 μm graded Silicon carbide particles and about 200 μm graded Silicon carbide particles.

59. The method of claim 52, wherein the particles comprise a 65 to 75:25 to 35 weight ratio blend of 725 to 775 μm graded Silicon carbide particles and 175 to 225 μm graded Silicon carbide particles.

60. The method of claim 52, wherein the particles comprise a blend of at least 5 different grades of particles comprising about one part 1 mm particles, about one part 750 μm particles, about one part 500 μm particles, about one part 250 μm particles and about one part 100 μm particles.

61. The method of claim 52, wherein the particles comprise a blend of at least 5 different grades of particles comprising about 15 to 25 parts of 0.9 to 1.1 mm particles, 15 to 25 parts 730 to 770 μm particles, 15 to 25 parts 480 to 520 μm particles, 15 to 25 parts 230 to 270 μm particles and 15 to 25 parts 90 to 110 μm particles.

62. The method of claim 52, wherein the particles comprise a blend of at least two different types of particles.

63. The method of claim 52, wherein the particles comprise a blend of at least two to four different types of particles.

64. The method of claim 52, wherein a substantial portion of the particles have a Mohs hardness of greater than 6.5 and are substantially inert.

65. The method of claim 52, wherein the particles are Silicon carbide particles.

66. The method of claim 52, wherein the particles are treated to enhance their wetting during the infusion of the resin composition.

67. The method of claim 52, wherein and the mould tool is vibrated during at least a portion of the particle filling process at one or more vibration rates of between 100 Hz to 10,000 Hz.

68. The method of claim 52, wherein and the mould tool is vibrated after the particle filling process at one or more vibration rates of between 100 Hz to 10,000 Hz in order to facilitate one or more of the following: a packing of the particles and a substantially even flow of the particles into interior geometries of the mould tool.

69. The method of claim 52, wherein after the mould tool is filled with the particles and the resin composition the mould tool is vibrated at one or more vibration rates of between 100 Hz to 10,000 Hz for a time period of between 1 minute to 45 minutes.

70. The method of claim 52, wherein after the mould tool is filled with the particles and the resin composition the mould tool is vibrated at one or more vibration rates of between 100 Hz to 10,000 Hz for a time period of between 1 minute to 75 minutes in order to facilitate one or more of the following: densification and to mitigate against resin wash.

71. The method of claim 52, wherein infusing of the resin composition into the mould tool interior filled to the predetermined level with the particles is carried out in part at atmospheric pressure.

72. The method of claim 52, wherein at least a portion of the mould tool after filling with the particles is subjected to a vacuum of less than 100 mbar and the resin composition is infused into the mould tool interior under vacuum.

73. The method of claim 52, wherein the method produces composites in a complex geometry mould tool that have a substantial uniform distribution of the resin composition and the particles.

74. The method of claim 52, wherein the at least one layer of matting is comprised of one or more of the following materials: glass, glass fibers, carbon, carbon fibers, ceramics, ceramic fibers, polymers, polymer fibers, minerals and mineral fibres.

75. The method of claim 52, wherein at least two, three, four, five, six or seven layers of matting are positioned in the mould tool.

76. The method of claim 52, wherein the method produces an article that is void, substantially void or sufficiently void of air pockets.

77. The method of claim 52, wherein the at least one layer of matting of the article is void, substantially void or sufficiently void of air pockets.

78. The method of claim 52, wherein the at least two, three, four, five, six or seven layers of matting of the article are void, substantially void or sufficiently void of air pockets.

79. The method of claim 52, wherein the at least one matting is a fibre matting comprising: glass fibre, carbon fibre, other reinforcing fibre material or combinations thereof.

80. The method of claim 52, wherein the at least one layer of matting is continuous, substantially continuous or sufficiently continuous.

81. The method of claim 52, wherein the at least one layer of matting is at least 30%, 40%, 50%, 60%, 70%, 80% or 90% continuous.

82. The method of claim 52, wherein the at least one layer of matting is at least 30%, 40%, 50%, 60%, 70%, 80% or 90% by length continuous.

83. The method of claim 52, wherein at least a portion of the mould tool is subjected to one or more of the following: atmospheric pressure, vacuum and positive pressure during at least a portion of the infusing of the resin composition.

84. The method of claim 52, wherein at least a portion of the mould tool is subjected to vacuum during at least a portion of the infusing of the resin composition and at least a portion of the mould tool is subject to positive pressure during at least a portion of the infusing of the resin composition.
